(19) United States
(12) Patent Application Publication
(10) Pub. No.: US 2004/0111468 A1
(43) Pub. Date: Jun. 10, 2004

(54) Service effect improving system

(75) Inventor: Hajime Enomoto, Funabashi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/716,538

(22) Filed: Nov. 20, 2003

(30) Foreign Application Priority Data
Nov. 22, 2002 (JP) 2002-338721

(51) Int. Cl. G06F 15/16; G06F 17/00; G06F 7/00

(52) U.S. Cl. 709/203; 707/103 R

(57) ABSTRACT

Normally, in a service system in which a service executing process is performed among a plurality of parties aims at effectively satisfying, an intention of a client requesting a service. An object forming the system is hierarchically formed by a data model for determination of an attribute structure as a template, a higher-order object model, a further higher-order role model for representation of the contents of the process to be executed as a set of a plurality of object models, and a highest-order process model for definition of a dynamic process performed by a plurality of role models as a process. The system includes a model adaptation unit for performing adaptation for enhancement of a service effect independently for each model.

### BACKGROUND OF THE INVENTION

1. Field of the Invention

The present invention relates to a service system for offering a service between a plurality of parties through, for example, a network, and more specifically to a service effect improving system for use with a service system using an intention realization data processing device including a common platform as an interface function with a party and an object network for realizing an intention of a party.

2. Description of the Related Art

With an increasing use of a general network system such as the Internet, etc., a network service system of performing a service offering process between a plurality of parties using a network has been realized. For example, a system of performing interaction through a network between a plurality of parties by providing medium data with a bidirectional function is being realized.

In the above-mentioned system, it is important that a server functions as a party at a specific medium as the entire or a partial medium system corresponding to the intention of a party as a client, and interaction is performed to allow a specific medium to make a motion adaptive to the environment depending on the intention of the client and the party involved.

Thus, as a system for offering a service requested as, for example, a request from a client as a user, that is, a service requested as an intention of a client, there is a WELL system which uses a function language called WELL (Window-based elaboration language) for short. In the WELL system, services can be offered for various fields using an object network designed in a field description language corresponding to various service fields not limited to a specific service field.

An object network is represented as a model representing various data and operations for data. The WELL system has a common platform as an interface having various windows used by a user presenting the object network with an instruction and data, and displaying an execution result of a system, etc. The object network, common platform, and WELL system are disclosed by the following three pieces of literature previously filed by the Applicant.

Japanese Patent Application Laid-open No. 5-233690 “Language Processing System using an Object Network”

Japanese Patent Application Laid-open No. 7-295929 “Interactive Information Processing Device using Common Platform Function”

Japanese Patent Application Laid-open No. 9-297864 “Information Processing Device using Object Network”

Although the Applicant has also filed the intention realization data processing device for realizing using the above-mentioned WELL system an independent intention which can be independently realized by a single client, a cooperative intention which can be realized by an intention of one of a plurality of clients cooperatively operating with another client, or a conflicting intention indicating an intention of a client conflicting with an intention of another client, the device is described later in detail.

To improve the service effect in the above-mentioned service system, it is important to effectively satisfy the intention of a party. In the service system, a number of various parties are associated with each other, and a set of entire data of the operations performed by the parties configures the general external environment data of the system as described above, and it is necessary to integrally improve the service effect by reference to the data.

However, in the conventional service system, there has been the problem that the basic structure for improving the service effect has been uncertain, and clarifying the system structure is required to improve the service effect.

### SUMMARY OF THE INVENTION

The present invention has been developed to solve the above-mentioned problems, and aims at providing a service effect improving system capable of effectively satisfying the intention of a party to improve a service effect in a service system which offers a service among a plurality of parties.

The service effect improving system according to the present invention includes an object network as a language processing function and a common platform as an interface function with a client, and is intended to improve the service effect in the service system for offering a service depending on the intention of a client.

The system structure according to the present invention is a hierarchical structure. The object configuring the system is formed by a data model whose attribute structure is determined as a template, an object model arranged in a higher order than the data model, a role model which is arranged in a higher order than the object model, and represents the contents of the process to be performed in an environment as a set of a plurality of object models, and a process model which is arranged at the highest order and defines a dynamic process cooperatively performed by a plurality of role models as one process.

A model adaptation unit is provided for performing adaptation for improvement of a service effect independently for each model in the hierarchical structure of objects of a system structure.

In the present invention, a service system uses a network formed by a plurality of clients and a plurality of servers for offering a service, and the model adaptation unit can perform adaptation for attaining an intention of each client.

In this case, a service system can further include an external environment data management unit for centrally managing cooperative data which can be referred to in parallel when each party of a plurality of clients and servers requires it, and can be used in offering a service. When the intentions of a plurality of clients are cooperative intentions of cooperatively realizing mutual requests or conflicting intentions of mutually preventing the realization of the intentions of opposite parties, the model adaptation unit can dynamically perform adaptation for cooperative intentions or conflicting intentions of a group of clients using the contents of the management of the external environment data management unit.

As described above, according to the present invention, objects form the hierarchical structure as a system structure of a data model, an object model, a role model and a process model, and independently perform adaptation for improving the service effect for each model of the hierarchical structure.

### BRIEF DESCRIPTION OF THE DRAWINGS

FIG. 1 is a block diagram showing the principle of the present invention;

FIG. 2 is a block diagram showing the basic configuration of the information processing device using an object network;

FIG. 3 is an explanatory view of a common object network;

FIG. 4 is an explanatory view showing a practical example of an object network;

FIG. 5 is a block diagram showing the detailed configuration of a noun object management system;

FIG. 6 is an explanatory view showing the practical execution management of a function corresponding to a verb object;

FIG. 7 is a block diagram showing the basic configuration of an information processing device having a common platform as an interface with a user;

FIG. 8 is an explanatory view of a WELL system corresponding to the field of a color image generation and coloring process;

FIG. 9 is a flowchart (1) of the data processing using an object network;

FIG. 10 is a flowchart (2) of the data processing using an object network;

FIG. 11 shows the process system of a color image generation and coloring process;

FIG. 12 shows an example of a template;

FIG. 13 shows an example of a template corresponding to a line segment;

FIG. 14 is an explanatory view of a method of generating a specific object network from a common generic object network;

FIG. 15 is a block diagram showing the configuration of the information processing device having an agent;

FIG. 16 is a block diagram showing the configuration of the information processing device with the presence of an expert taken into account;

FIG. 17 is an explanatory view showing the definition of a role function;

FIG. 18 is an explanatory view showing the operation of the process in the WELL system for realization of an interaction function;

FIG. 19 is a flowchart showing the process of an interaction function;

FIG. 20 is an explanatory view showing the interaction function between a primary role function and a supporting role function;

FIG. 21 is an explanatory view showing a one-to-many broadcast from a primary role function to a subordinate role function;

FIG. 22 is an explanatory view showing the communications between role functions;

FIG. 23 is an explanatory view of a consistency predicting process corresponding to a cooperative intention;

FIG. 24 is an explanatory view of a consistency/inconsistency predicting process corresponding to a conflicting intention;

FIG. 25 is an explanatory view of motion conversion by the strategy and tactics relating to a cooperative intention and a conflicting intention;

FIG. 26 is a block diagram of the outline of the entire structure of an intention realization information processing device;

FIG. 27 is an explanatory view of the process performed by data driven for realization of an intention;

FIG. 28 is an explanatory view showing the hierarchical structure during the event driven in the cooperating process by the broadcast function;

FIG. 29 is an explanatory view showing the cooperating process by the function of partially recognizing environment data;

FIG. 30 is an explanatory view showing the user process on an object network;

FIG. 31 is an explanatory view showing the relationship between a party and the drive system relating to the consistent restrictions;

FIG. 32 is an explanatory view showing the contents of a cell of the template of an object;

FIG. 33 shows the contents of a template for dynamic control of a verb object;

FIG. 34 shows the definition structure of an intention;

FIG. 35 shows the entire configuration of the generic object network for the realization of an intention;

FIG. 36 is an explanatory view showing the connection structure between servers for realization of an intention;

FIG. 37 is an explanatory view showing the call function during the intention processing;

FIG. 38 is an explanatory view showing the general process of realizing the intention of a party;

FIG. 39 is an explanatory view showing the flow of the intention realizing process by event driven;

FIG. 40 is an explanatory view (1) showing the interaction function by communications;

FIG. 41 is an explanatory view (2) showing the interaction function by communications;

FIG. 42 is an explanatory view of the adaptation process by an integration process function;

FIG. 43 is an explanatory view of performing a process by the interaction of the role function;

FIG. 44 shows the configuration of the role definition network;

FIG. 45 is an explanatory view of a service using a reference model;

FIG. 46 is an explanatory view showing the system of realizing a reference model in the WELL system;

FIG. 47 is an explanatory view showing the descriptions of the restrictions by a graph representation and a syntax structure;

FIG. 48 is an explanatory view showing the method of representing a format model and a feature model in the template of an object;

FIG. 49 shows the flow of syntax structure software of a textured picture;

FIG. 50 is an explanatory view of sorting priorities of restriction data;

FIG. 51 shows an image drawing network;

FIG. 52 shows an example of drawing an image on a common platform;

FIG. 53 shows an example of a texture image;

FIG. 54 is an explanatory view of the flow of drawing an image;

FIG. 55 is an explanatory view of a tamperproof system for the service system against a malicious party;

FIG. 56 is an explanatory view of the system of managing the status of performing a process;

FIG. 57 is an explanatory view showing the function of controlling the flow of a service; and

FIG. 58 is an explanatory view of loading a program into a computer to realize the present invention.

### DESCRIPTION OF THE PREFERRED EMBODIMENTS

The embodiments of the present invention are described below by referring to the attached drawings.

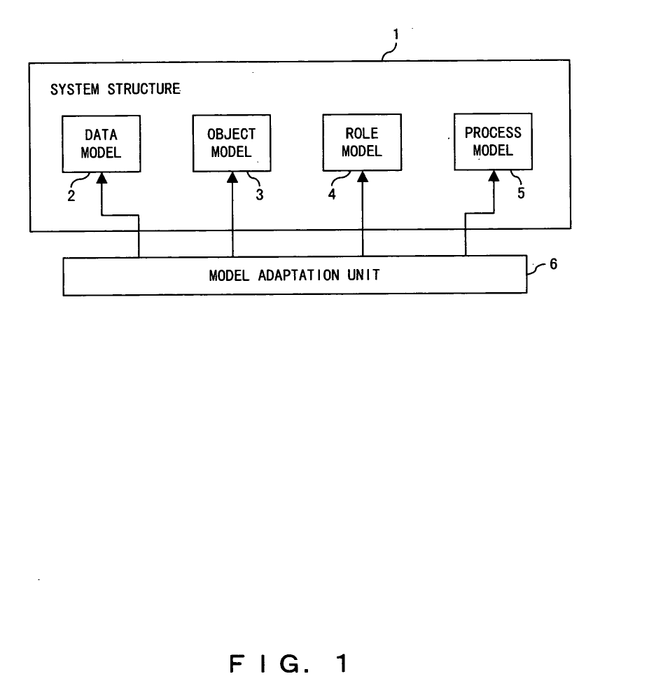

In FIG. 1, a system structure 1 is a hierarchical structure. An object configuring the system is formed by a data model 2 whose attribute structure is determined as a template, an object model 3 arranged in a higher order than the data model, a role model 4 which is arranged in a higher order than the object model 3, and represents the contents of the process to be performed in an environment as a set of a plurality of object models 3, and a process model 5 which is arranged at the highest order and defines a dynamic process cooperatively performed by a plurality of role models as one process.

In FIG. 1, a model adaptation unit 6 is provided for performing adaptation for independent improvement of a service effect for each model in a hierarchical structure of an object as the system structure 1.

According to the present invention, a service system uses a network formed by a plurality of clients and a plurality of servers for offering a service, and the model adaptation unit 6 can perform adaptation to attain the intention of each of the plurality of clients.

In this case, a service system can further include an external environment data management unit for centrally managing cooperative data for the service executing process which can be referred to in parallel when each party of a plurality of clients and servers requires it, and can be used in offering a service. When the intentions of a plurality of clients are cooperative intentions of cooperatively realizing mutual requests or conflicting intentions of mutually preventing the realization of the intentions of opposite parties, the model adaptation unit 6 can dynamically perform adaptation for cooperative intentions or conflicting intentions of a group of clients using the contents of the management of the external environment data management unit.

Additionally, a modification unit for applying generic determiner modifications to each model of an object at a specification level can be provided so that the model adaptation unit 6 can perform adaptation of a parameter for embodying the determiner modification. According to a further embodiment, consistent restriction items are set as attributes of an object for the object of each model so that the model adaptation unit 6 can perform adaptation to satisfy the consistent restrictions.

In this case, in the syntax structure of an object, the priority can be specified for the consistent restriction item data as an attribute of an object, and the status of the process of the system can be divided corresponding to consistent restrictions so that a module can be set corresponding to the syntax structure of an object.

Furthermore, a validity check unit can be provided depending on the consistent restriction item so that a validity check of a process performed by a model of an object of each hierarchical level can be performed by division corresponding to the level of each hierarchical level.

A support role unit can be further provided so that the adaptation by the model adaptation unit 6 can be supported for improvement of a service effect depending on the feature of a model of an object at each hierarchical level.

A reference model which is orthogonal to the hierarchical structure of the above-mentioned data model, object model, role model, and process model can also be provided to clarify the structure of a realization process during the system designing process from the specification to the realization for improvement of a service effect. The reference model realizes a basic service to be offered in the process of an object network.

In the present embodiment, a service effect improving system is explained using as an example of an extensible WELL system in which an object network as a language processing function and a common platform as an interface function as a key concept.

As described above, the WELL system is not limited to a specific field, but can offer services in various fields, and the important point of the present invention is to provide an integral architecture not limited to a specific field to improve a service effect in a service system with the WELL system set as a target. Before explaining the important point, the requisite technology such as an object network, a common platform, etc. and the intention realization data processing device, etc. for realizing an intention of a party of a system are described. The requisite technology is disclosed by the four preceding applications filed by the Applicant of the present invention.

Japanese Patent Application Laid-open No. 11-312087 “Intention Realization Information Processing Device”

Japanese Patent Application Laid-open No. 2002-055820 “Information Processing Device”

Japanese Patent Application Laid-open No. 2002-290708 “Safety Guarantee System in a Service Offering System”

Japanese Patent Application Laid-open No. 2002-115287 “Network Service System”

In the intention realization data processing device, an extensible WELL system in which an object network as a language processing function and a common platform as an interface function between a client and a server are used as key concepts is used.

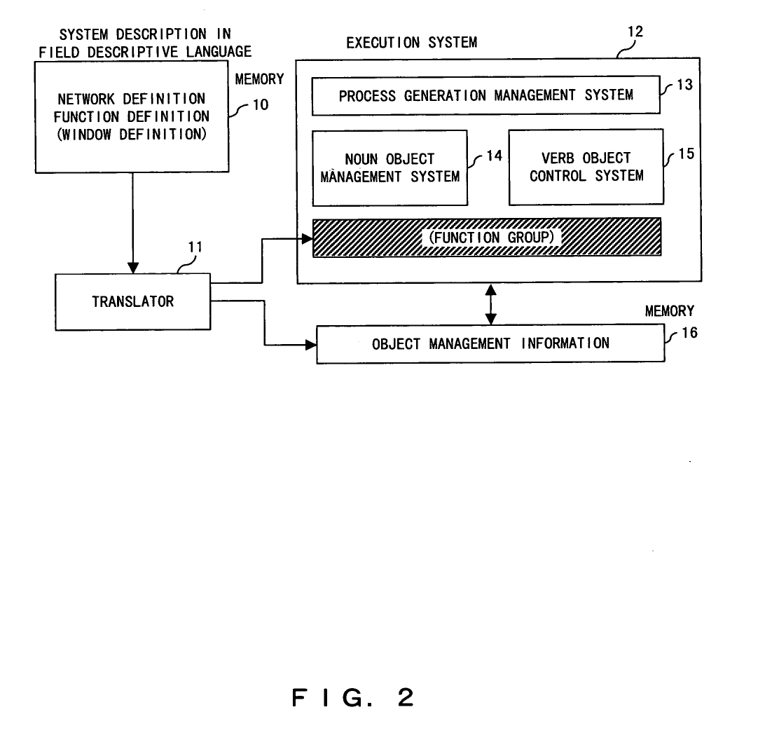

FIG. 2 is a block diagram showing the basic configuration of the information processing device using an object network. In FIG. 2, the information processing system comprises memory 10 storing a system description described in a field descriptive language, a translator 11 for receiving and analyzing the syntax of the system description and generating the data for an execution system 12, the execution system 12, and memory 16 storing the management information about an object network in the data generated by the translator 11. The memory 10 stores the definition of an object network, the definition of a necessary function, the definition of a window, etc. A window is described later as associated with a common platform.

The execution system 12 comprises a process generation management system 13 for performing control on a concurrent process, a noun object management system 14 for managing a noun object in the objects forming an object network, and a verb object control system 15 having the function of executing and controlling a verb object.

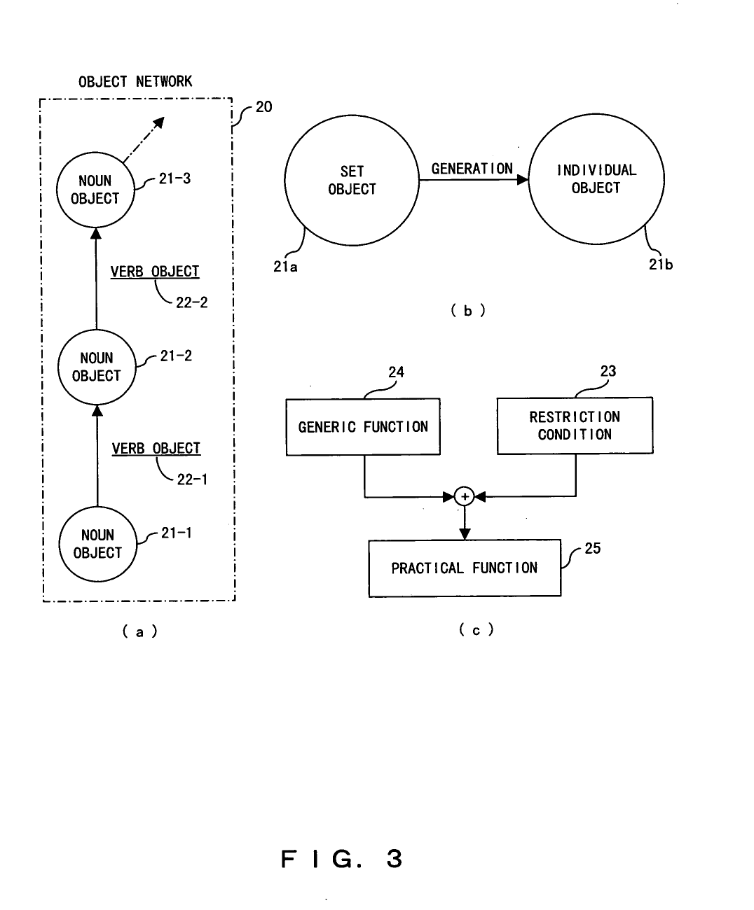

FIG. 3 is an explanatory view of a common object network. An object network manages data in an information processing device, and an operation unit for the data as objects, and the objects are generally classified into two groups, that is, noun objects and verb objects. As shown in FIG. 3(a), an object network 20 in which a noun object is represented as a node, and a verb object is represented as a branch is configured. A network is configured such that when the contents of a function corresponding to the verb object as a branch are operated on the noun object as a node in the object network, the noun object at the end of the branch corresponding to the verb object can be obtained as an object target.

As shown in FIG. 3(b), a noun object 21 can be a set object 21a corresponding to a common noun and an individual object 21b corresponding to a proper noun. The individual object 21b is generated by the set object 21a.

As shown in FIG. 3(c), a verb object can be a generic function 24 and a practical function 25. The practical function 25 can be used in practically performing an execution process on a noun object when a noun object as an object target is obtained. The practical function 25 can be obtained by adding a restriction condition 23 to the generic function 24. The conversion from the generic function 24 to the practical function 25 is controlled by the verb object control system 15.

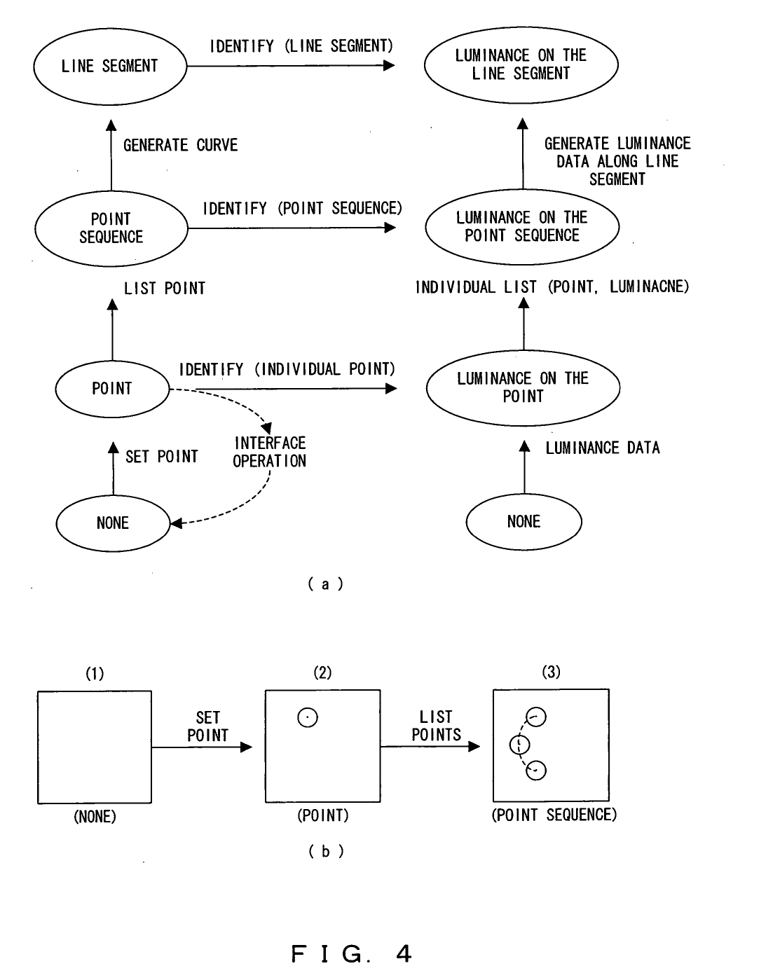

FIG. 4 shows a practical example of an object network. In this network, the field of the system description in the field descriptive language stored in the memory 10 shown in FIG. 2 relates to an image field, and the network is an object network for drawing an image. FIG. 4(a) shows an item network on the left, and an attribute network on the right. These two networks form an object network.

First, the item network shown on the left in FIG. 4(a) is described. As shown in FIG. 4(b), when an image is drawn, there is nothing drawn at first as shown in (1). When, for example, a user specifies a point on a display using a mouse, etc., an operation corresponding to a verb object “set point” is performed, and a noun object “point” is obtained. A plurality of points corresponding to the set point are drawn by, for example, an interface operation with the user, and an operation corresponding to a verb object “list point” is performed on the points, thereby obtaining a noun object “point sequence” shown by (3). Furthermore, a verb object “generate curve” is operated on the noun object so that a noun object “line segment”, for example, corresponding to a line can be obtained.

The attribute network on the right shown in FIG. 4(a) is used in coloring an image when an image is drawn corresponding to the item network on the left. Each noun object of the network is identified by a corresponding noun object on the item network. Also on the attribute network, a noun object “luminance on the point” for designation of the brightness of each point is obtained by the operation of the verb object of luminance data from the state in which nothing is drawn. Then, a list of the point “individual list, and an object designating the luminance for the point are operated on the noun object, and a noun object “luminance on the point sequence” is obtained. Furthermore, a verb object “generate luminance data along line segment” is operated so that a noun object “luminance on the line segment” can be obtained, thereupon finally obtaining a color image.

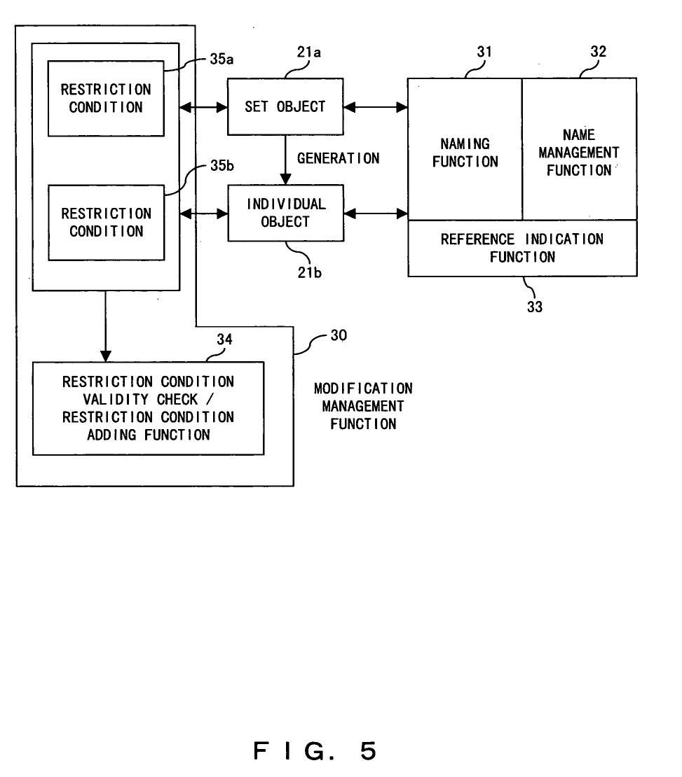

FIG. 5 is a block diagram of the detailed configuration of the noun object management system 14 shown in FIG. 2. In FIG. 5, the noun object management system comprises a modification management function 30, a naming function 31, a name management function 32, and a reference indication function 33, and manages the set object 21a and the individual object 21b.

The modification management function 30 includes the restriction conditions of the set object 21a and the individual object 21b, for example, restriction conditions 35a and 35b as adjectives modifying an noun object, and also includes a restriction condition validity check/restriction condition adding function 34 for determination of the validity of the restriction conditions.

The naming function 31 enables a user or a system to name, for example, the individual object 21b, and the name management function 32 manages the name. The reference indication function 33 discriminates a specific individual object 21b from another object for reference.

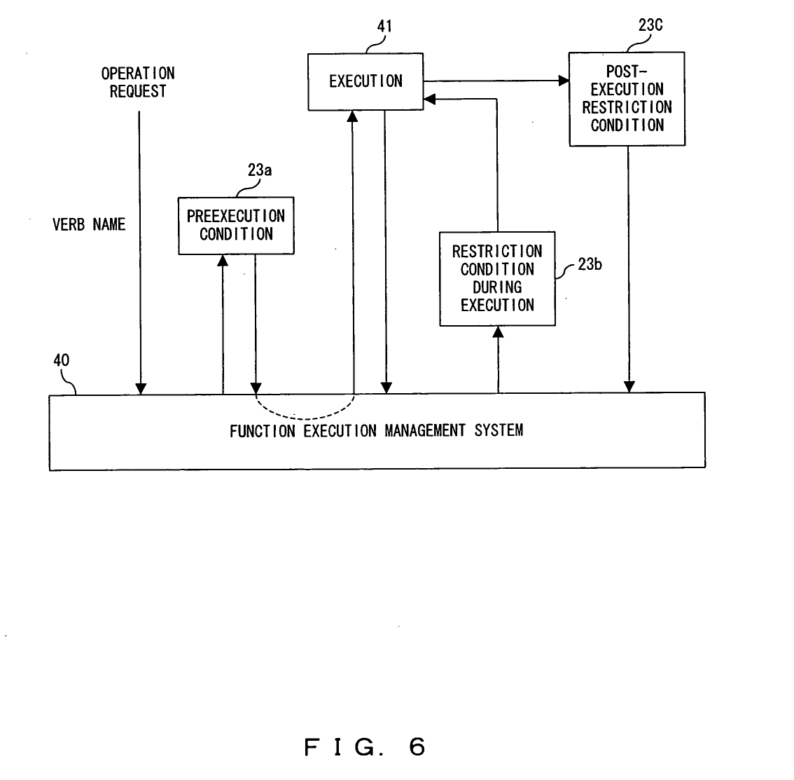

FIG. 6 is an explanatory view showing the practical execution management of a function corresponding to a verb object. In FIG. 6, the execution management of a function is executed by a function execution management system 40 not shown in FIG. 2.

The function execution management system 40 manages a practical function execution 41 based on the conditions of a preexecution condition 23a, a restriction condition during execution 23b, and a post-execution restriction condition 23c of a function when the function is practically processed corresponding to a specified verb object. That is, in response to a request to operate a function, the practical function execution 41 is performed after checking the preexecution condition 23a together with other restriction conditions, the execution time restriction condition 23b is checked during the execution of the function, and the post-execution restriction condition 23c is checked after the execution of the function.

For example, it is necessary to determine the coordinates of at least three points when an arc is drawn. If the coordinates of only two points are determined, the function of drawing the arc cannot be performed. However, a check by the preexecution condition 23a enables the function execution management system 40 to check the condition in advance, and a function of requesting a user to input the coordinates of the third point can be automatically activated.

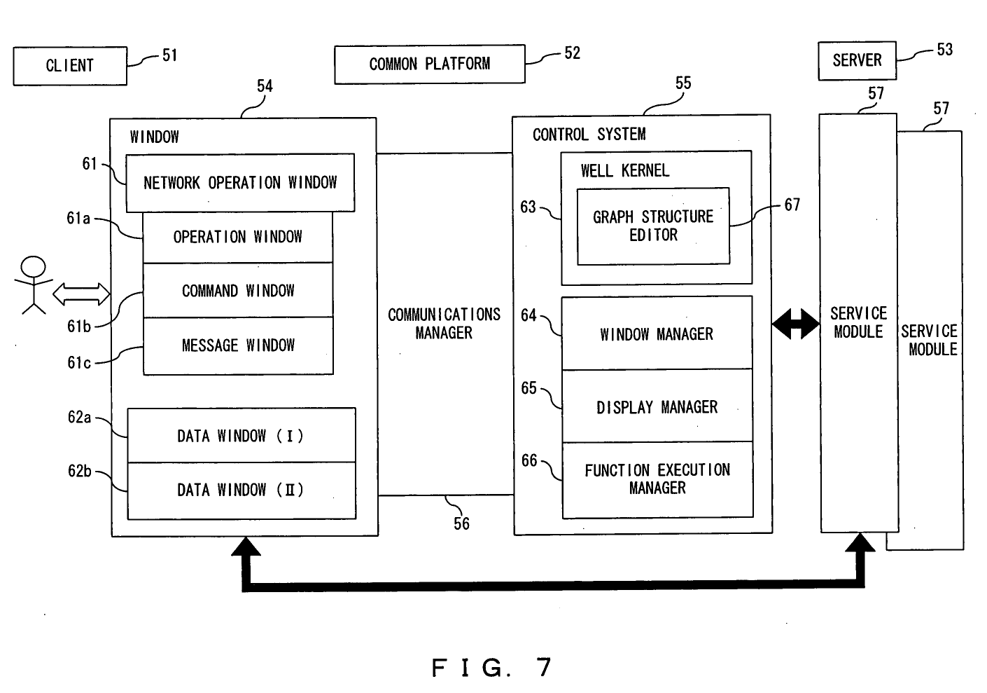

Described below is a common platform. FIG. 7 is a block diagram showing the basic configuration of the information processing device having a common platform 52 as an interface between a client 51 and, for example, a server 53 for performing a process specified by the client. In FIG. 7, the common platform 52 comprises a window 54 for communicating data with the client 51, a control system 55, and a communications manager 56 for consistency of a data representation format, etc. between the window 54 and the control system 55. The server 53 normally comprises a plurality of service modules 57.

The window 54 comprises a network operation window 61 and a data window 62. An operation window 61a in the network operation window 61 displays an image and a character for representation of an instruction about various operations from, for example, the client 51. A command window 61b displays an image and a character for representation of an instruction about various commands from a client. A message window 61c displays, for example, a message from a system to a client. The data window 62 also comprises a data window (I) 62a for display of a process result, and a data window (II) 62b for display of restriction data required for a process.

The communications manager 56 converts the display format of data between the client 51 and the server 53 through the window 54. The conversion of the display format is described later.

The control system 55 comprises a WELL kernel 63 for control of a process corresponding to a network, a window manager 64 for control of the selection of various windows in the window 54, a display manager 65 for control of data display, etc. in a window, and a function execution manager 66 for control of the execution of a function corresponding to a verb object in an object network. Furthermore, the WELL kernel 63 comprises a graph structure editor 67 for processing the graph structure of a network with an object network regarded as a type of data.

In FIG. 7, when an instruction to be processed is issued from the client 51, the server 53 calls an object network representing the area to be processed. The graph structure editor 67 stores the object network in the work area of the WELL kernel 63. Based on the storage result, the object network is displayed in the operation window 61a by the control of the window manager 64, etc. through the communications manager 56.

The client 51 specifies all or a part of the nodes on the object network displayed in the operation window 61a, and issues an instruction to the system. In response to the instruction, the communications manager 56 interprets the contents of the instruction, and instructs the server 53 to call the template corresponding to the specified noun object. The template is described later.

For example, restriction data corresponding to a noun object, etc. is displayed in the data window (II) 62b, and the client 51 selects the restriction data, the server 53 executes the process corresponding to the instruction of the client 51, and the execution result is displayed in the data window (I) 62a. The execution result is evaluated by the client 51, and the next instruction is issued.

In the information processing device in which the common platform shown in FIG. 7 is used, the optimum data display format for the user as the client 51 is used in the window 54, and the data is converted into the data format for processing in the data processing device on the common platform 52, thereby allowing the user to easily use the system.

For a person as the client 51, the format of data in graphics like a graph and characters is more comprehensible than a text format, and can be more easily processed when an instruction is issued. Especially, it is desired that a dot and a line are given directly in the data window 62 or using a mouse.

On the other hand, for a computer of the server 53, it is more efficient that a point is represented as coordinates of (x, y), and a line is represented in a format of a list of pixels from the starting point to the end point.

That is, between the common platform 52 and the client 51, it is desired that the data representing a dot and a line is represented as is to be indicated by reference, and it is desired for the server 53 that data can be specified in an index format, and data indicated by the client 51 can be collectively transferred or jointly processed.

The data representing graphics and images are displayed as is for the client 51 so that the client 51 can indicate the graphics and images. The display format of data indicated in the list structure or the raster structure is used for the server 53.

The data element is indicated by a name for the client 51, and a representation format for designation of a data element using a name header is used for the server 53.

In the embodiment of the present invention, the WELL system is used with a function language referred to as WELL (window based elaboration language) for processing information in an object network in which data and the process for the data are processed as objects and represented in a graph in the information processing device including the common platform 52 and the server 53 shown in FIG. 7.

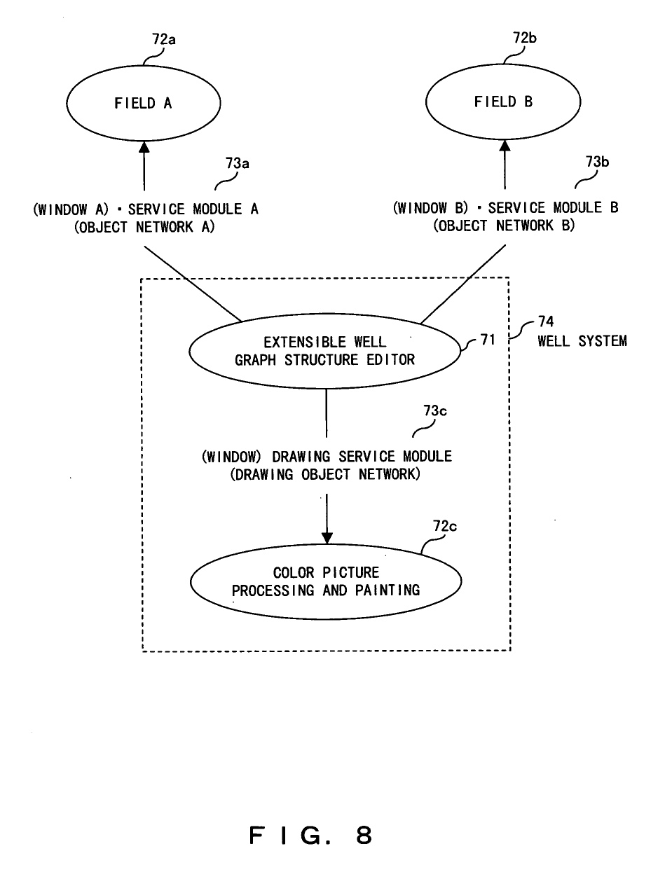

FIG. 8 is an explanatory view showing the relationship between the WELL system and an object network. In FIG. 8, 72a, 72b, and 72c are specific process fields. Especially, the 72c indicates a color picture processing and painting field. 73a, 73b, and 73c are object networks corresponding to the fields 72a, 72b, and 72c. Especially, the 73c indicates an object network for drawing an image in a combination with a drawing service module. A graph structure editor 71 is an editor in an extensible WELL system capable of processing various object networks.

When an object network corresponding to a specific field is provided for the function language which can be referred to as WELL for short, the process of the object network can be executed without a program. The language is a window-oriented language, and a client-server model can be realized by using a window as an interface with a client.

In FIG. 8, by combining the necessary window with a object network 73c corresponding to the service module performing a corresponding process corresponding to a color image generation and coloring process field 72c, the WELL system can be a WELL system 74 corresponding to the color image generation and coloring process field 72c. A system corresponding to the field 72a or 72b is generated by combining an object network 73a or 73b corresponding to another field.

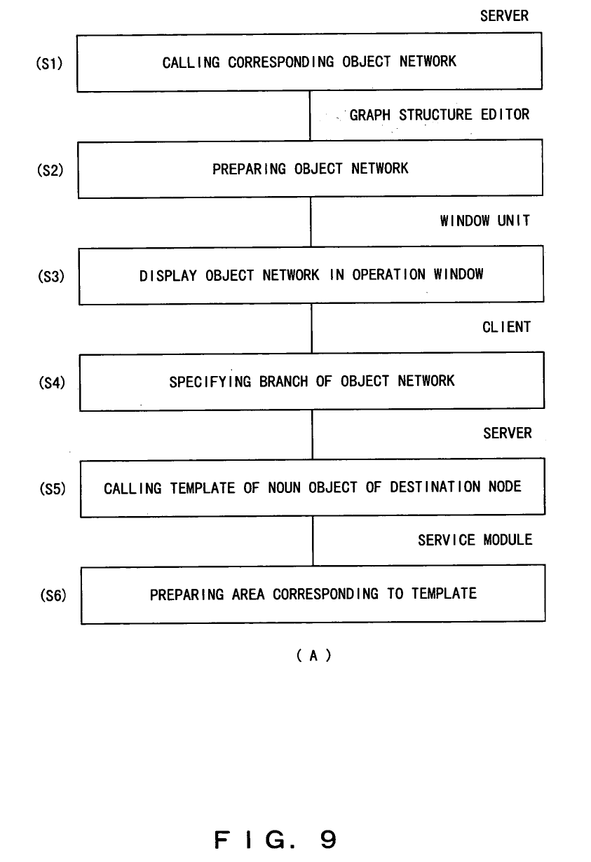

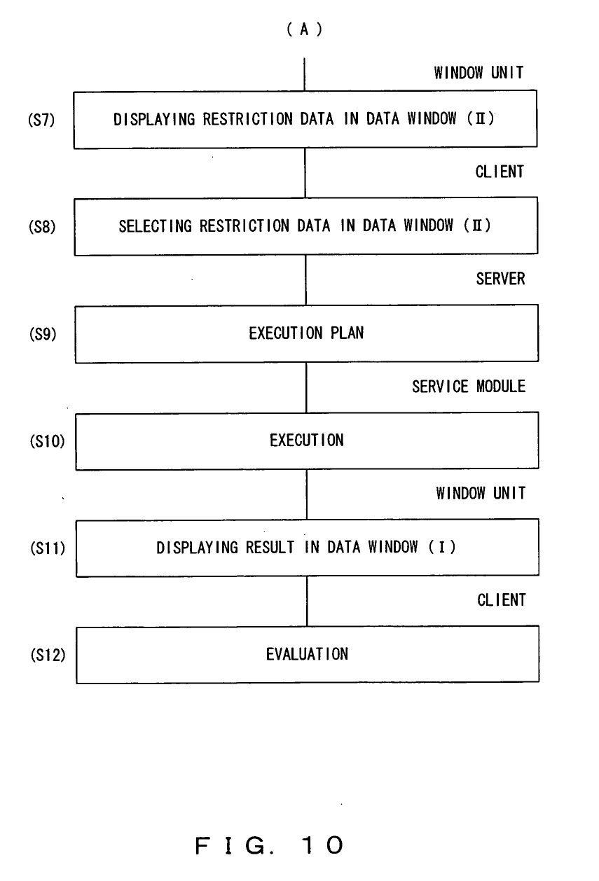

FIGS. 9 and 10 are flowcharts of the data processing using an object network. When the process starts as shown in FIG. 9, the corresponding object network is called by the server 53 in step S1. For example, when a process in the color image generation and coloring process field is performed, the object network shown in FIG. 4 is called. The called object network is stored in the work area of the WELL kernel 63 by the graph structure editor 67 in step S2. In step S3, the WELL kernel 63 activates the window manager 64 and the display manager 65, and an object network is displayed in the operation window 61a through the communications manager 56.

The client 51 issues an instruction to the system by specifying a part of the object network displayed in step S4, for example, a branch. The instruction is identified by the communications manager 56, the server 53 calls a destination node, that is a template for the noun object at the end of the branch in step S5, and the service module 57 prepares an area corresponding to a template in step S6.

Then, in step S7 shown in FIG. 10, the common platform 52 extracts restriction data corresponding to the template, and the data is displayed in the data window (II) 62b. The client 51 selects specific restriction data from the restriction data displayed in step S8. The selection result is identified by the communications manager 56, and transmitted to the server 53 through the WELL kernel 63. In step S9, an execution plan is generated.

According to the generated execution plan, the service module 57 performs the process specified by the user, for example, the line drawing or coloring process in step S10, the result is displayed in the data window (I) 62a in step S11, the client 51 evaluates the process result in step S12, and the next instruction is issued.

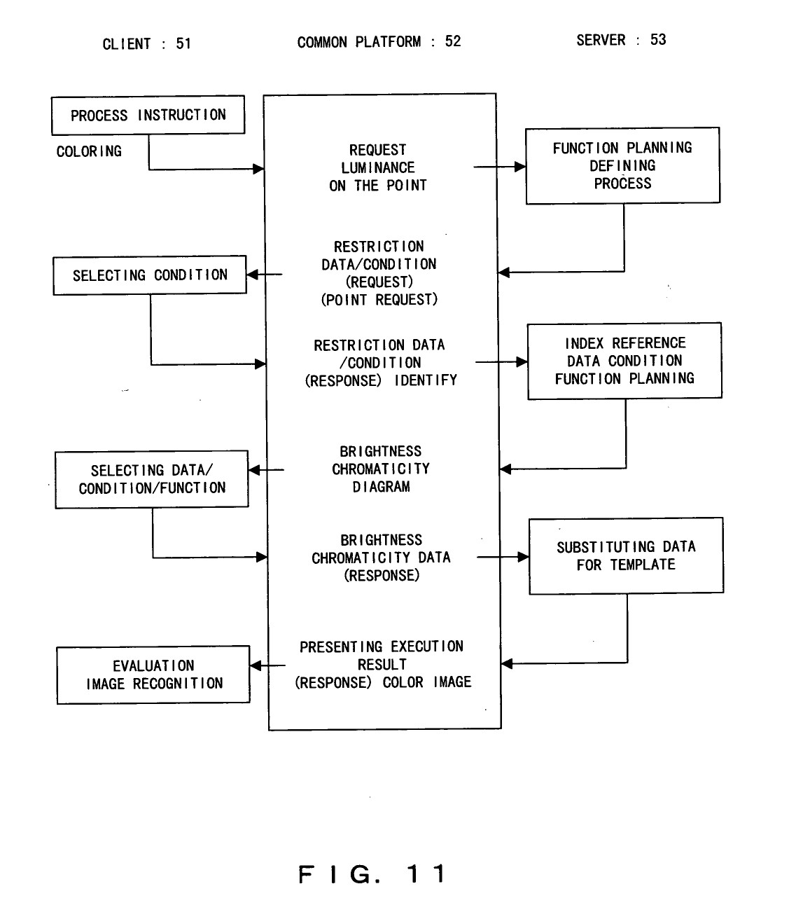

FIG. 11 shows the system of the process performed when the information processing device having a common platform performs the color image generation and coloring process. In this example, the process of generating a luminance on the point for assigning the brightness to a point in the attribute network on the right in the object networks described by referring to FIG. 4.

First, when the client 51 issues a request to generate a luminance on the point as a process instruction to the server 53 through the common platform 52, the server 53 transmits a request for the information as to which point is to be assigned the brightness as necessary restriction data/condition for the plan of an execution function, the client 51 identifies the point as the selection of a condition. When the point is specified, that is, identified, the server 53 recognizes the point by referring to the index of the template as described later through the common platform 52, and the selection of the brightness data to be added to the point as necessary data for the plan of executing a function is requested to the client.

The request is transmitted to the client 51 as a brightness and chromaticity diagram, the client 51 returns to the server 53 the brightness and chromaticity data to be added to the point on the brightness and chromaticity diagram as the data/condition/function selection, the server 53 substitutes the data for the template and performs the process, and presents the client 51 with the color image as an execution result through the common platform 52, and the client 51 evaluates the execution result by recognizing the image, thereby passing control to the instruction of the next process.

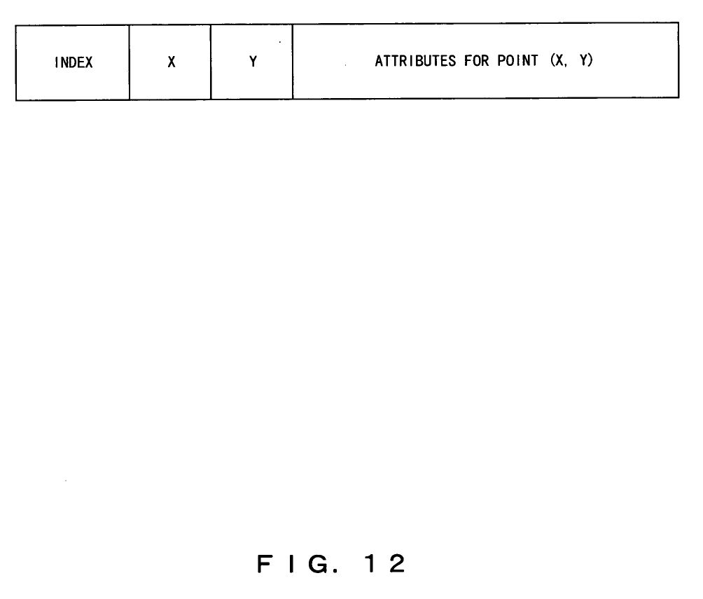

FIG. 12 shows an example of a template used in the process performed by the server 53. The template corresponds to, for example, the noun object of the point shown in FIG. 4, stores an index for designation of the point without using the coordinates X and Y on the display screen of the point, and the coordinates by the system, and the attribute data, for example, the brightness, the chromaticity, etc.

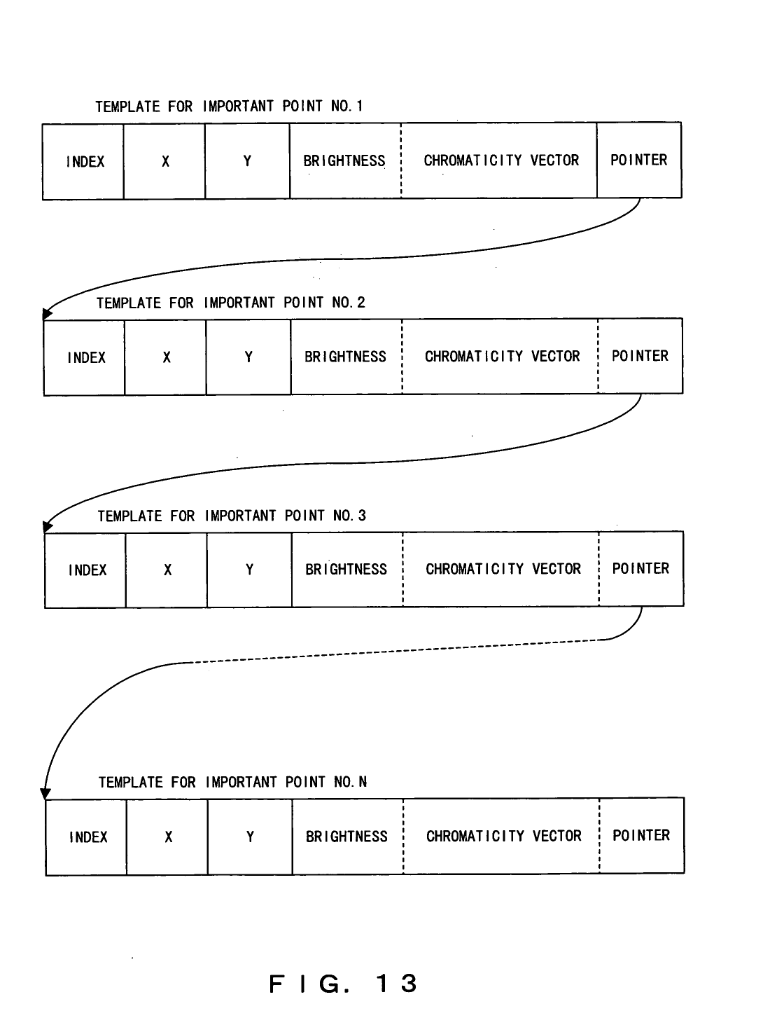

FIG. 13 shows an example of a template corresponding to the noun object “line segment” shown in FIG. 4. The template for a line segment stores a pointer indicating another point in addition to the brightness and the chromaticity vector of the point in the attribute data storage area on the template of each of the important points No. 1, 2, . . . , No. n forming the line segment, and the pointers define the template corresponding to one line segment.

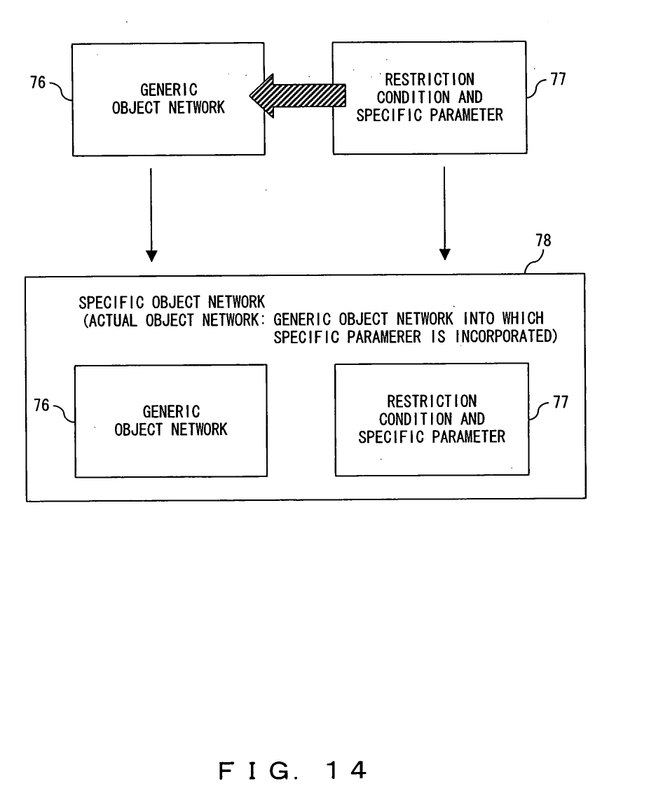

FIG. 14 is an explanatory view of a method of generating a specific object network as a practical object network for performing a specific process from a common generic object network. For example, a generic object network 76 in a common form of parameter and restriction condition is prepared as a formula obtained by representing a variable in a common form in mathematics. Then, a parameter and a restriction condition 77 for a specific process are incorporated into the generic object network 76 to generate a specific object network 78 for a specific process.

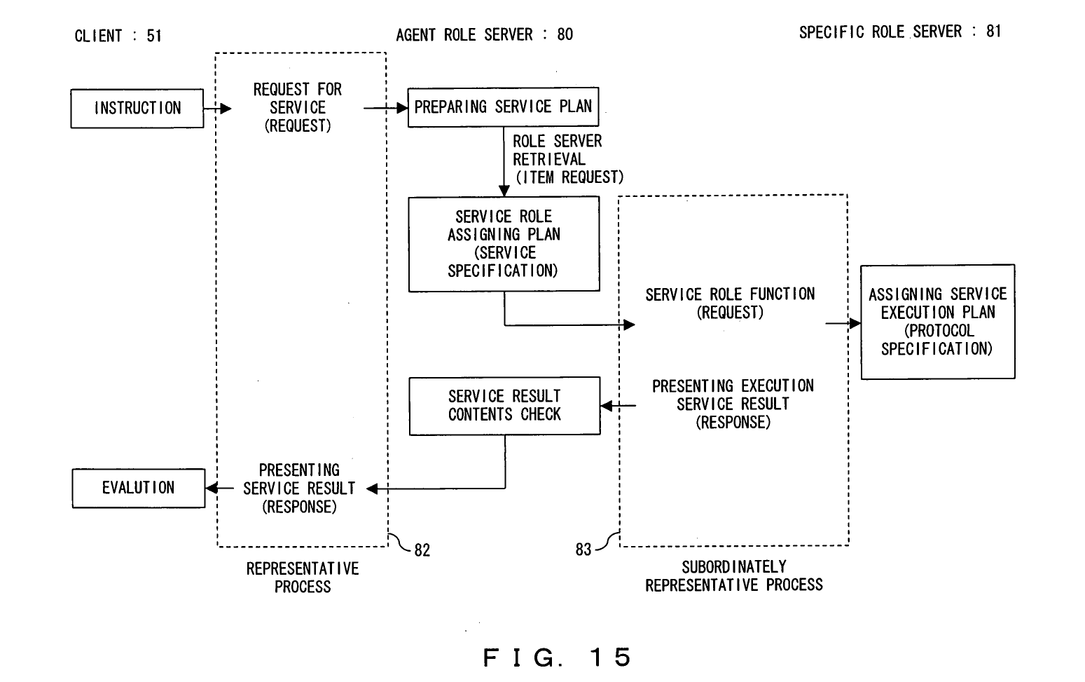

FIG. 15 is a block diagram showing the configuration of the information processing device having an agent. As compared with FIG. 7, the agent role server 80 is provided between the client 51 and a specific role server 81 corresponding to the server 53 shown in FIG. 7. In FIG. 7, the agent role server 80 for having a role of, for example, a travel agency is provided between the client 51 and the specific role server 81 for performing a practical process.

A representative process 82 and a subordinately representative process 83 are representative processes of displaying necessary data respectively between the client 51 and the agent role server 80 and between the agent role server 80 and the specific role server 81. Between the client 51 and the agent role server 80, a request for a service and a response to the request are processed using the representative process 82.

The agent role server 80 prepares a service plan according to the instruction of the client 51, retrieves the server for executing the role, that is, the specific role server 81, generates a service role assigning plan, and requests the specific role server 81 to execute the role function through the subordinately representative process 83.

The specific role server 81 performs a process for an assigned service executing plan, and presents the agent role server 80 with the process result through the subordinately representative process 83. The agent role server 80 presents the client 51 with the result through the representative process 82 after checking the contents of the service result.

The representative process 82 and the subordinately representative process 83 shown in FIG. 15 are realized by the format of the common platform explained by referring to FIG. 7. The agent role server 80 can be considered to be realized as one of the service module 57.

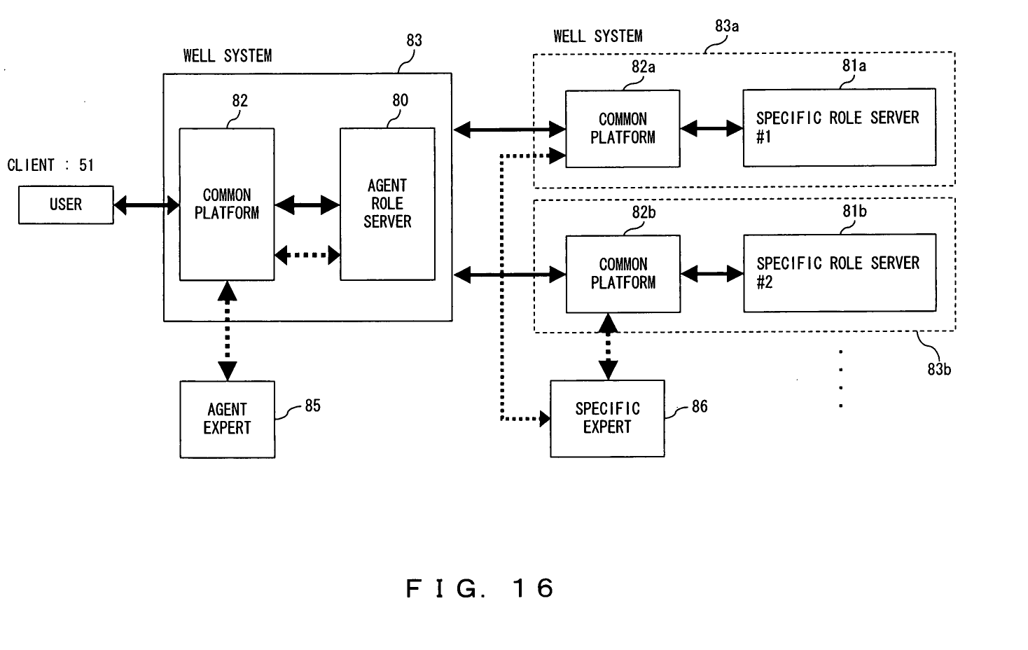

FIG. 16 is a block diagram showing the configuration of the information processing device with the presence of an expert taken into account. In FIG. 16, unlike the case shown in FIG. 15, a plurality of specific role servers 81a, 81b, . . . are provided as specific role servers. Each specific role server independently executes an assigned specific service, and the respective results are integrated by the agent role server 80, and performs the process according to the instruction of the client 51. The agent role server 80 configures the subordinately representative process 83 together with the representative process 82. For example, the specific role server 81a configures a WELL system 83a together with a common platform 82a.

In FIG. 16, an agent expert 85 supports the exchange of information between the client 51 and the agent role server 80. The specific expert 86 supports the exchange of information between the agent role server 80 and a plurality of specific role servers 81a, 81b, . . . .

The client 51 is a person as a user, but the agent expert 85 and the specific expert 86 are not limited to persons, but can be realized by a process units having an intelligent function.

In FIG. 16, the client 51 requests the agent role server 80 to solve a specific problem. Relating to the request, the agent expert 85 configures a generic object network for a process to be performed, and then generates a specific object network, or normally a plurality of specific object networks for realizing a practical object network into which specific parameters and restriction conditions are incorporated, thereby supporting the generation of a service plan by the agent role server 80.

Similarly, to support the service plan to be generated by the agent role server 80, the specific expert 86 designs an object network for realization of a service assigned to each specific role server, and a related template, thereby supporting the process by the specific role server.

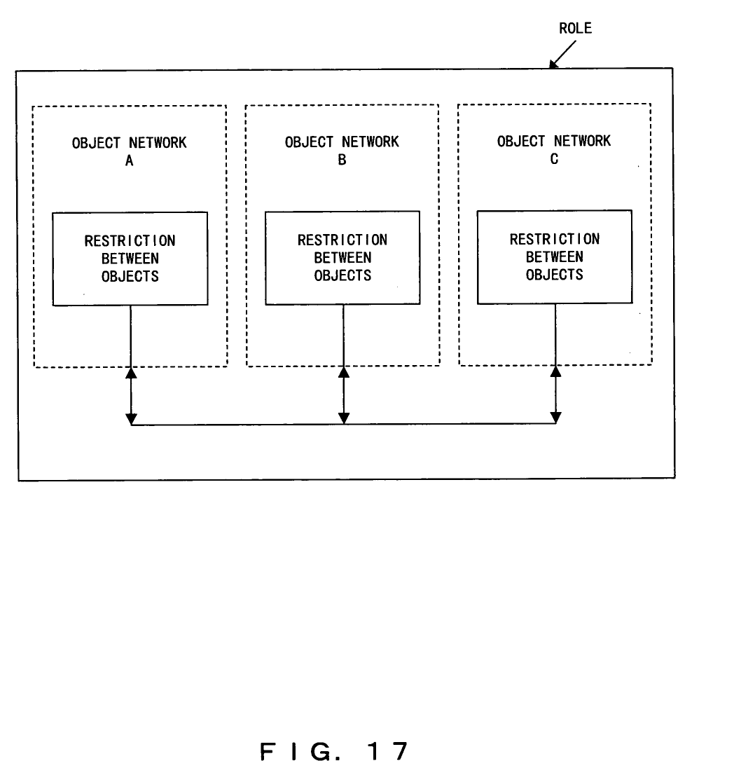

Described below is the role function and the interaction function in the information processing device using an object network and a common platform. FIG. 17 shows the definition of the role. As shown in FIG. 17, the role is defined as a structure of an object network, and functions as a unit of an executing process. A name is assigned to a role, and the name is used in referring to the role inside and outside the system.

The relationship between a plurality of object networks in a role is prescribed relational expression among attribute values of objects corresponding to the restrictions defined for objects forming each object network. The role can also be formed by one object network.

In the information processing device according to the present invention, for example, a cooperative operation among rules is generally required to satisfy an instruction from a user by a plurality of roles performing an executing process. Therefore, it is necessary to fully support the interaction function among the roles and provide free communications style. Furthermore, to satisfy the request from users, it is necessary to provide an efficient interaction function between the user (which can be considered to be one of the support roles) and the system for offering services. As described above, the interface function between the user and the system is realized by a common platform.

In the above-mentioned data processing device, event driven and data driven are used as two types of elements of efficient interaction functions between the user and the system and between a plurality of roles.

First, as the event driven, for example, a client requests the system to realize a noun object on a common platform. In the system, a server receives the request from the common platform, and returns an execution result as a response to the client.

As the data driven, when a value corresponding to an attribute is not defined in a template corresponding to a noun object currently processed in the system, the system requests the client to set the attribute value. When the request is issued, the information that an attribute value has not been defined is displayed in the data window, and the client is requested to define an attribute value which is necessary in the data window.

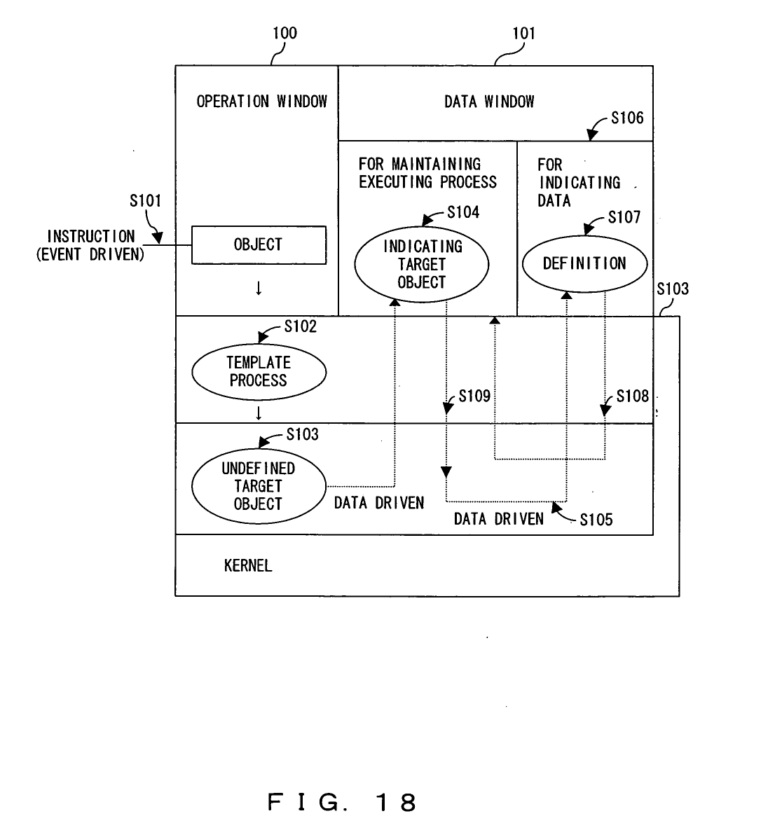

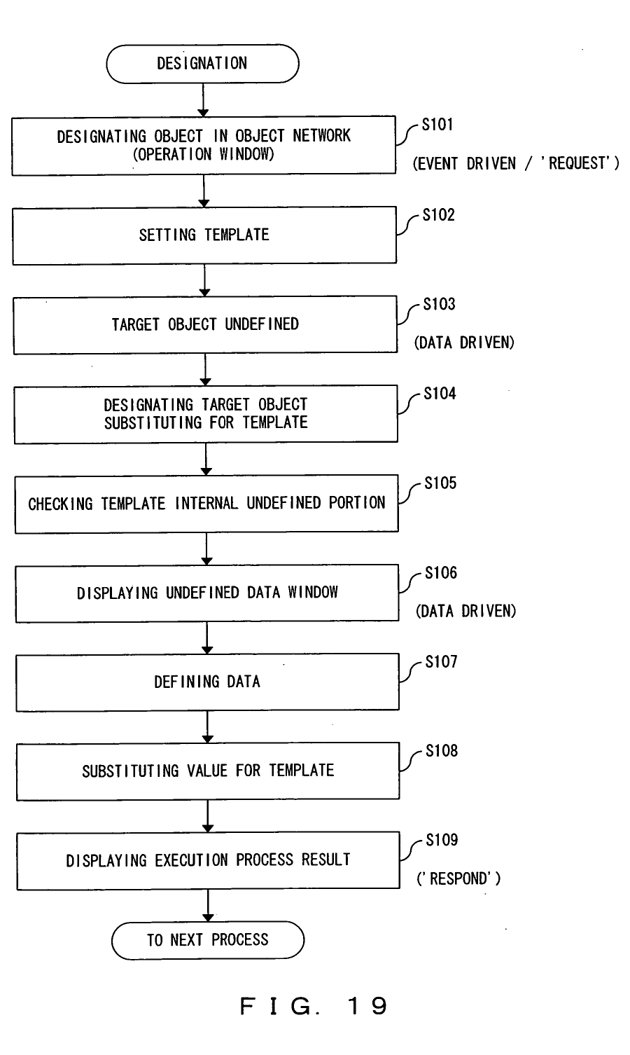

FIG. 18 is an explanatory view showing the operation of the process in the WELL system for explanation of an interaction function based on the event driven and the data driven. FIG. 19 is a flowchart showing the process of an interaction function based on the event driven and the data driven by referring to FIG. 18. By referring to FIGS. 18 and 19, the process based on the event driven and data driven is explained below.

First, in step S101 shown in FIG. 19, the client, for example, a user specifies an object in an object network displayed in an operation window 100 on the common platform shown in FIG. 18 as a request to the system. This corresponds to an event driven (request). In response to the user instruction, a template corresponding to the object is set in step S102.

When the practical name of a target object corresponding to the set template is undefined, it is determined by a kernel 103 of the WELL system, and the client is requested to indicate a target object as data driven in step S103. For example, as explained above by referring to FIG. 14, the case in which the name of the object in the specific object network corresponding to the object forming a generic object network is undefined corresponds to this.

The client indicates the target object in a data window 101, and the target object is substituted for the template in step S104. Furthermore, the kernel 103 checks in step S105 whether or not there is an attribute value undefined in the template. If there is an undefined attribute value, a display to request the client to input an undefined attribute value is made in the data window as data driven in step S106.

The client defines an undefined attribute value on the data window 101, and the data definition is received by the system in step S107, the attribute value is substituted in the template in step S108, and the WELL system performs the process using the contents of the template in which the attribute value is substituted, and the process result is displayed in the data window in step S109, thereby terminating the process in response to the instruction of the client.

Thus, a user-friendly and efficient interface can be realized between the user and the system by the interaction function based on the event driven and the data driven. Between a plurality of roles, for example, between an agent role server and a specific role server, etc., the communications function for support of the cooperative operation between role functions can be realized. By realizing the interaction function using a kernel of the WELL system, a software architecture of various systems, especially a personal computer system can be processed.

When a cooperative operation is performed between a plurality of roles, it is desired that a interaction function based on the common data is provided between the primary role for performing a role function as a subject and the supporting role for providing a service function for support of the primary role. The primary role performs an operation under the environment related to the primary role, and it is necessary to constantly monitor the environment data related to the environment. When the supporting role shares the environment data with the primary role, and a change occurs in the environment data, the characteristic of the change is announced to the primary role so that the primary role can operate corresponding to the change of the environment.

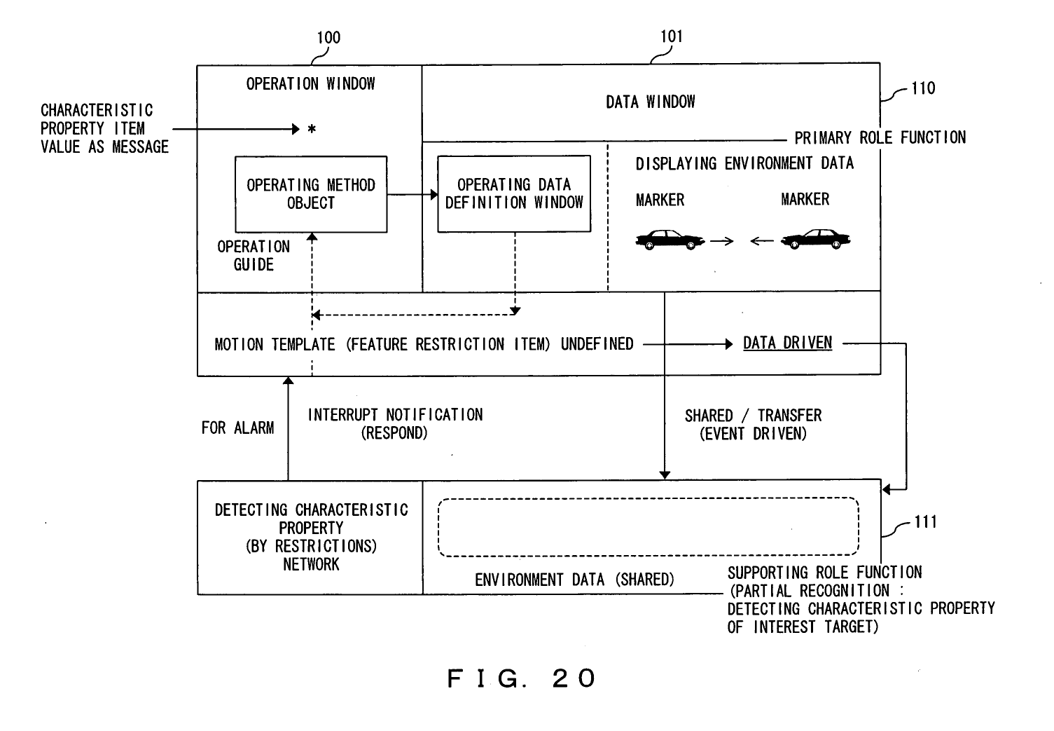

FIG. 20 is an explanatory view showing the interaction function between a primary role function and a supporting role function based on the environment data. In FIG. 20, semiautomatic driving of two cars is considered for example. Assume that each car is provided with the system and is driven on a possible collision course.

A primary role 110 mounted in one car is provided with an object in a semiautomatic driving method, and the object is displayed in the operation window 100 of the common platform. The environment data is displayed in the data window 101.

When the displayed environment data changes, it is transferred as event driven to a supporting role 111. The supporting role 111 detects the characteristic property of the environment data by the characteristic property detecting object network provided in the supporting role 111.

For example, when the characteristic property indicating the approach of the two cars on the collision course is detected, the supporting role 111 notifies the primary role 110 of the information as a response. In response to the interruption, the primary role 110 sets a motion template corresponding to the operation method object.

If the contents of the motion template cell includes an undefined portion, for example, if data of moving the car in which direction to which extent is not defined, then undefined data is requested to be set by the data driven. If no semiautomatic driving is used, the user, that is, the driver, is requested to set the undefined data. However, the semiautomatic driving is applied in this example, for example, the supporting role 111 is requested. The supporting role 111 detects a necessary characteristic property from the environment data, and provides the requested data based on the detection result. When the data is substituted in the motion template, the primary role 110 starts the interaction function with the user to allow the user to perform an actual operation using the operation method object as an operation guide.

Furthermore, to smoothly perform the cooperative operation between a plurality of role functions, it is necessary to perform a one-to-many broadcast from a primary role function of executing a role to a subordinate role function of executing related roles.

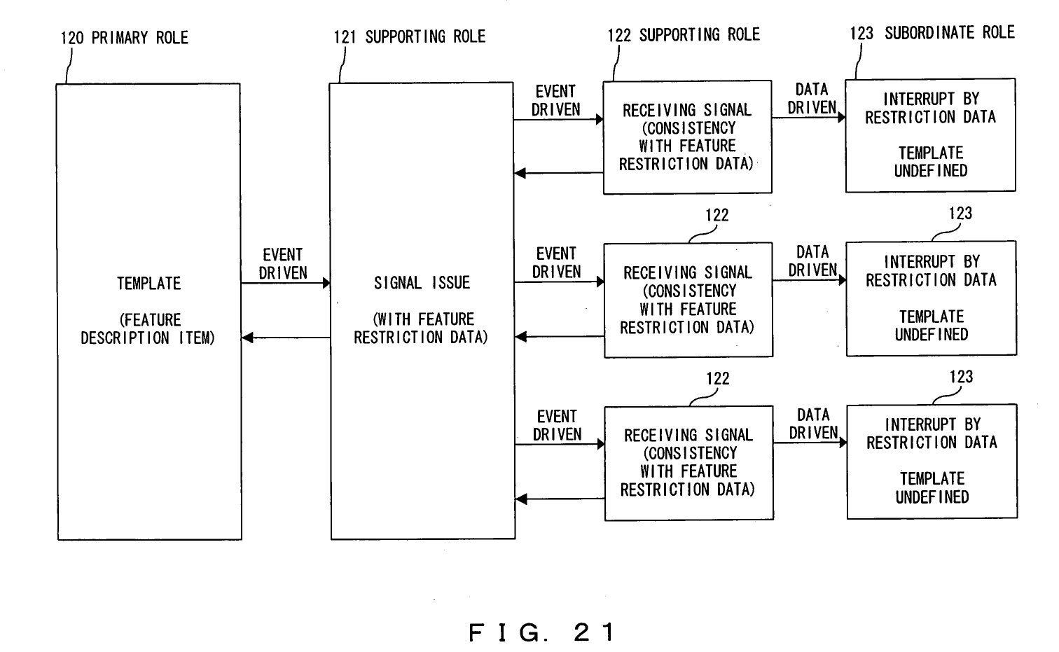

FIG. 21 is an explanatory view showing a one-to-many broadcast from a primary role function to a subordinate role function. In FIG. 21, it is assumed that a primary role 120 and a plurality of subordinate roles 123 are cooperatively functioning as the entire system. The primary role 120 controls the operation of the subordinate roles 123 by performing a one-to-many broadcast to the plurality of subordinate roles 123. Therefore, based on the event driven from the primary role 120, a supporting role 121 broadcasts a signal to which feature restriction data is added to a plurality of supporting roles 122. The supporting roles 122 receive the broadcast, and extracts the name of the role function of the broadcast source and the restriction data.

The subordinate role 123 has a template containing an undefined portion, receives the restriction data from the supporting role 122 by the interrupt based on the data driven, and performs a subordinate role function for the primary role 120 corresponding to the restriction data.

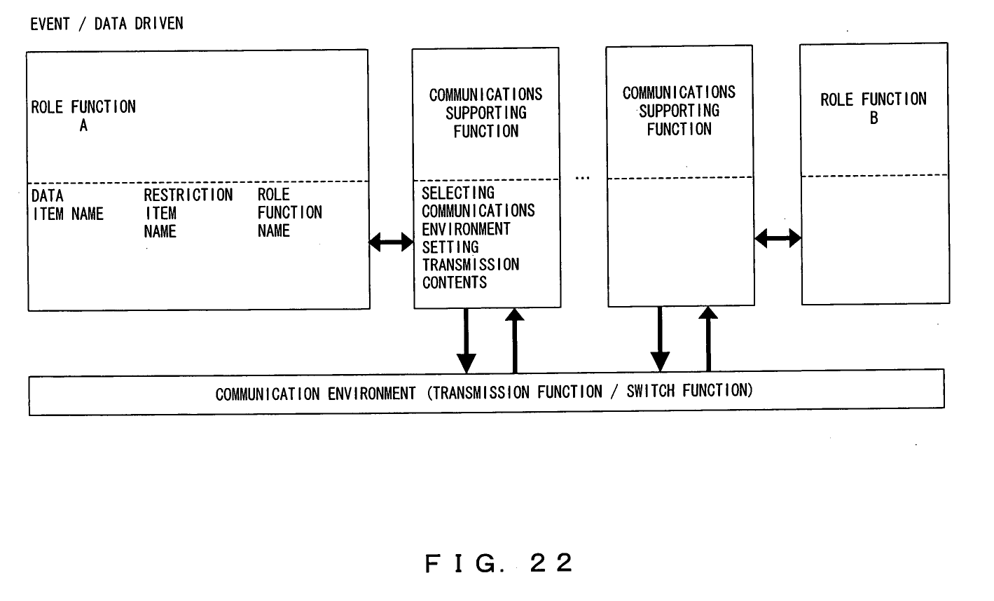

FIG. 22 is an explanatory view showing the communications between role functions. In FIG. 22, the role functions A and B, and a plurality of role functions not shown in FIG. 22 can communicate with each other through the communication environment. Among the role functions A and B, and the communication environment, a communications supporting function for supporting the communications is provided. The communications among them are performed by the interaction function based on the event driven and the data driven.

For example, B is specified as the name of a role function of a partner by the role function, and the contents such as a data item name, a restriction item name, etc. are transmitted to the role function B through the communications supporting function, thereby controlling the process of executing the role function B. The communications supporting function selects a communication environment, sets transmission contents, etc. Among a plurality of role functions, the role functions of a partner can be freely selected for communications.

Explained above are the object network and the common platform, and the information processing for realization of an intention is described below.

A target intention according to the present invention is not a partial or relatively small instruction such as adding a point or generating a point sequence on the screen as described above by referring to FIG. 4, but a relatively important intention such as the intention of a user, that is, a driver, for semiautomatically driving a car while avoiding a collision against another car as shown in FIG. 20.

There are three major types of intentions, that is, a cooperative intention, a conflicting intention, and an independent intention. The cooperative intentions are commonly shared by users of two systems, for example, two clients who are normally persons semiautomatically driving cars trying to avoid a collision.

The conflicting intentions are indicated by two parties having opposite intentions, for example, an intention of a bird flying in the sky, finding fish swimming in the sea, and trying to have it, and an opposite intention of the fish trying to swim away from the bird without being caught by it. For another example, in a case of a game between a gorilla and an owl, the gorilla plays tricks on the owl according to the movement of the owl without doing harm to the owl. Through the play, the gorilla learns something while the owl also learns how to smartly fly away according to the mutual movements between the gorilla and the owl based on the conflicting intention. The strategy of the gorilla is not to catch or kill the partner, but to attain it goal by stopping its movement and returning to the original state before it catches or kills the partner. This is attained by the supporting role function of the gorilla realizing that the reaction of the partner has reached the limit as characteristic restrictions.

Unlike the cooperative intentions or conflicting intentions, the independent intention is indicated by a person performing an operation with a specific purpose regardless of a user of another system, for example, the intention of another person to draw an image as described above, generate a moving picture by integrating multimedia information, etc.

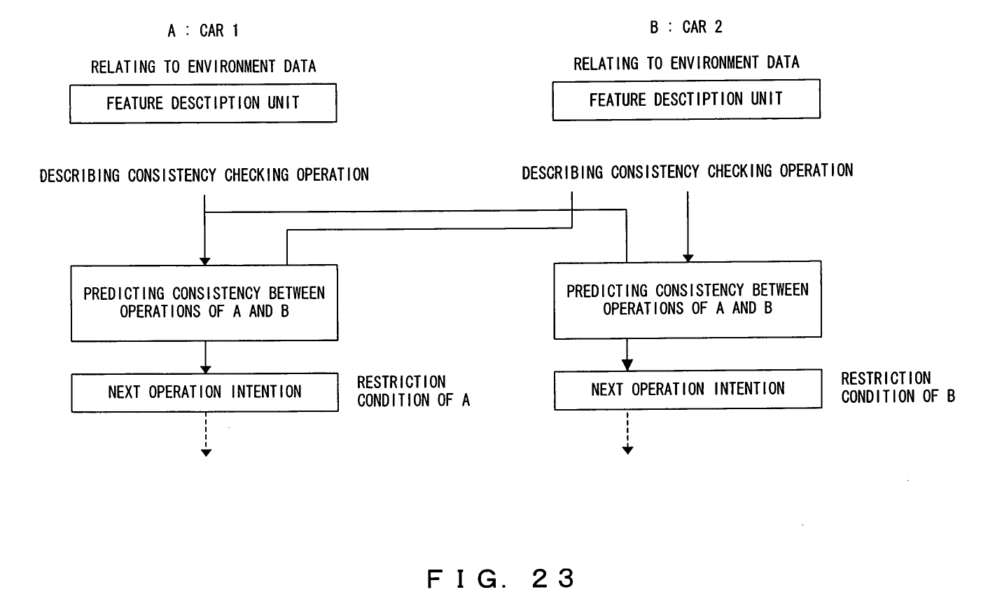

FIG. 23 is an explanatory view of a consistency predicting process corresponding to cooperative intentions of two users A and B semiautomatically driving their own cars while avoiding a collision against each other's car. In FIG. 23, the users A and B mutually predict the movement of each other's car based on the feature description result of each other's environment data, and perform as the next operation the consistent operation for avoidance of collision prescribed by the restriction conditions.

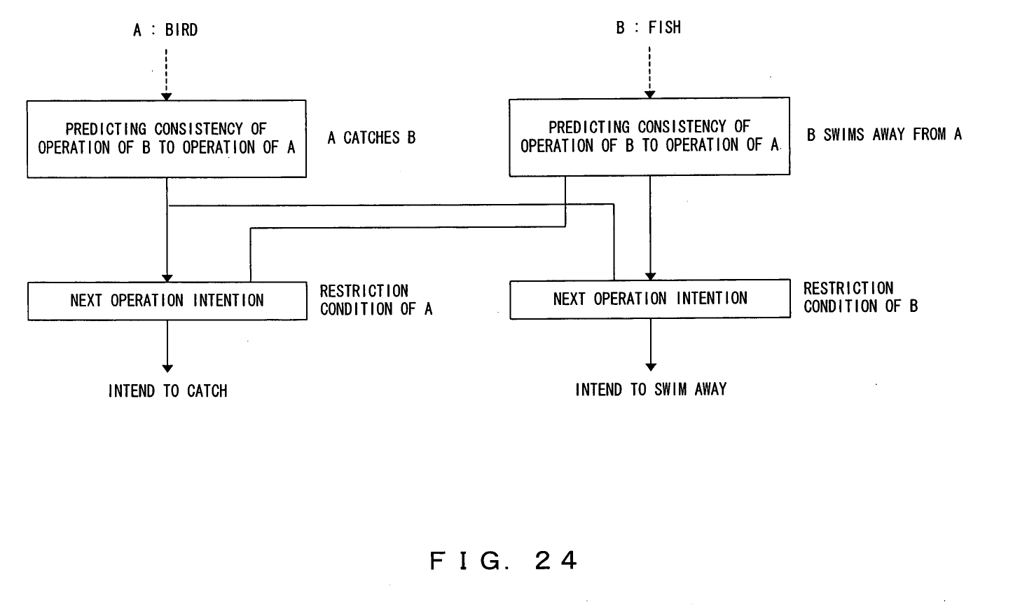

FIG. 24 is an explanatory view of a consistency/inconsistency prediction corresponding to the conflicting intentions between the above-mentioned bird and fish. In FIG. 24, the bird tries to catch the fish, and the fish tries to swim away from the bird. To attain their intentions, the bird predicts the swimming path of the fish while the fish predicts the approaching path of the bird so that they can betray each other's prediction. However, in this case, the next action of each other is taken under the restriction conditions of each other, and the next action is taken for the purpose of the bird catching the fish and the fish swimming away from the bird.

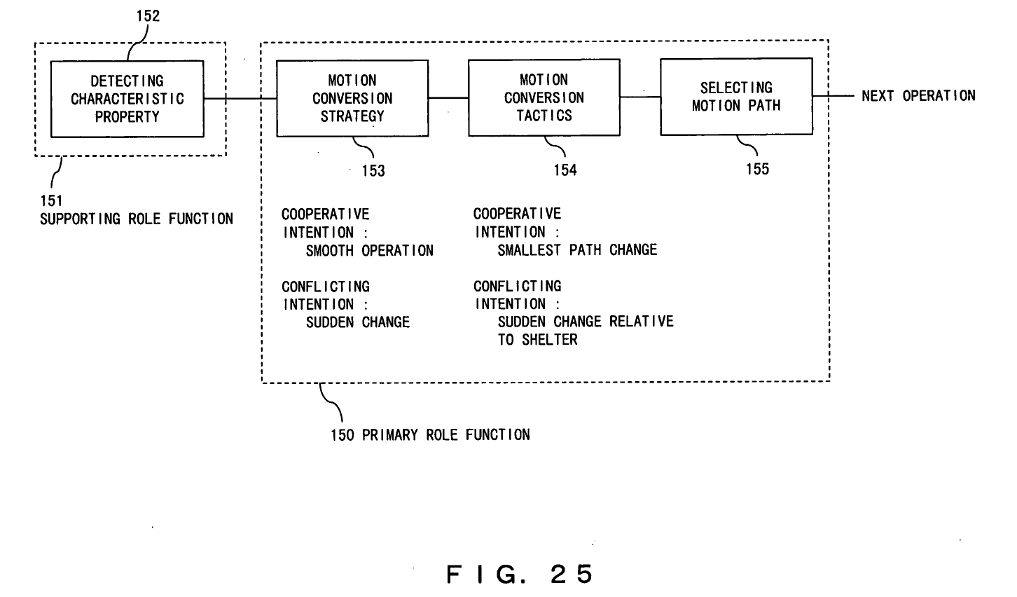

In the information processing for the realization of an intention, it is extremely important to determine the strategy and tactics as to the next action to be taken based on the detection result of the characteristic property such as the status of a road, etc., that is, under the restriction conditions, to avoid a collision between two cars for example. FIG. 25 is an explanatory view of motion conversion as the next action by the strategy and tactics relating to a cooperative intention between two cars for avoidance of a collision and a conflicting intention between a bird and fish.

In FIG. 25, the next action by the strategy and tactics is determined by a primary role function 150 functioning as a primary role, and a characteristic property such as environment data, etc. is detected by a supporting role function 151 functioning as a supporting role. First, the supporting role function 151 performs detection 152 of a characteristic property, for example, the status of a road, the speed of a target car, and the result is transmitted to the primary role function 150. The primary role function 150 first determines a motion conversion strategy 153. In the case of a cooperative intention in which two cars try to avoid a collision, operations are kept as smooth as possible in the motion conversion in the motion conversion strategy 153. When a bird tries to catch fish with conflicting intentions, a sudden motion conversion is adopted as a strategy to betray each other's prediction.

Then, the primary role 110 determines a motion conversion tactics 154. In the case of the cooperative intentions, the tactics is to minimize a path change to avoid, for example, a shock to passengers. In the case of the conflicting intentions, for example, when fish swims behind a shelter such as a rock, etc., a tactic to make a sudden motion conversion relative to the shelter is taken. According to the tactic, a selection 155 of a movement path is made and the next action is determined.

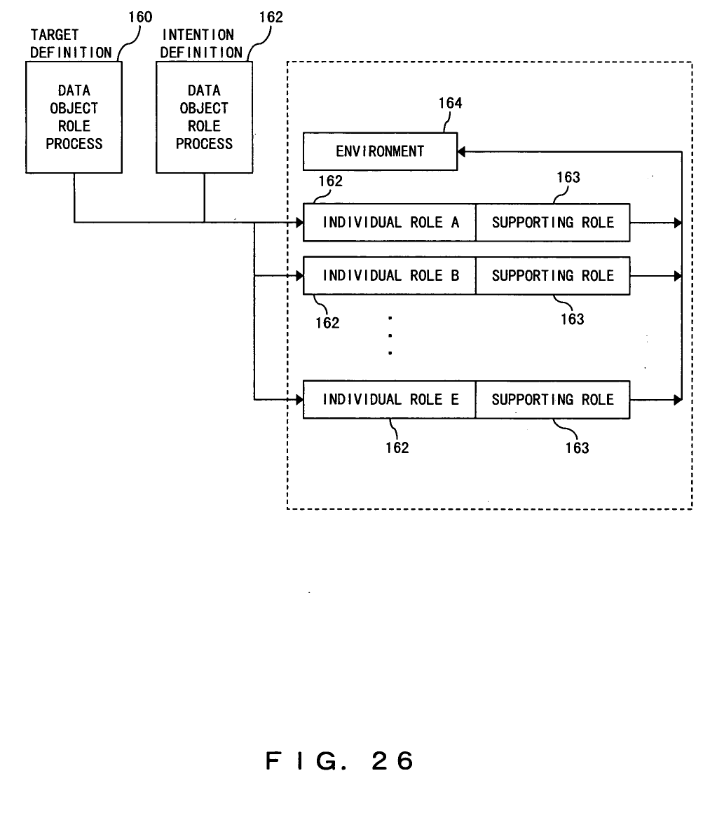

FIG. 26 is a block diagram of the outline of the entire structure of the information processing system for realization of an intention. In FIG. 26, a target definition 160 and an intention definition 161 are defined. The target definition 160 made on, for example, two cars driven on a two-way road, and the contents of the intention definition 161 are to perform semiautomatic driving while avoiding a collision against each other. The definition of each other is set using a data model given in the form of a template, etc. as described later, an object model given in the form of an noun object, a verb object, and an object network, a role model expressed as a set of a plurality of object networks as described above by referring to FIG. 17, and a process model indicating a number of integrated roles for a cooperating process.

Based on the contents of these target definition 160 and the intention definition 161, a plurality of individual roles 162 and supporting roles 163 for support of the respective individual roles perform the processes for the realization of intentions. However, each supporting role 163 detects, for example, characteristic properties by observing an environment 164, and provides them as restriction data for the individual role 162.

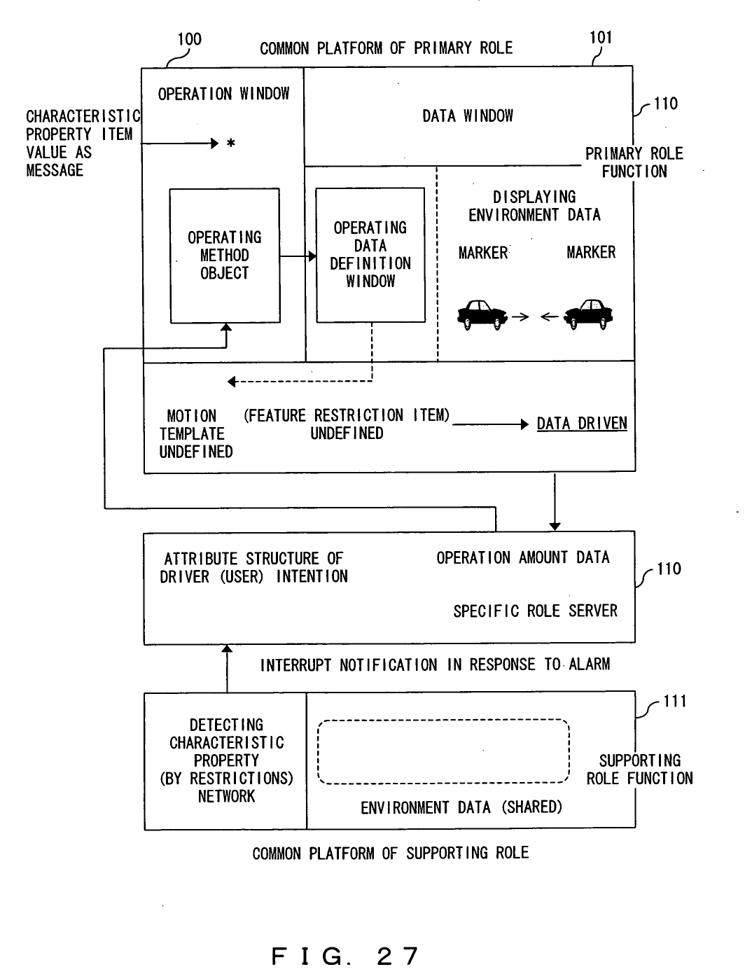

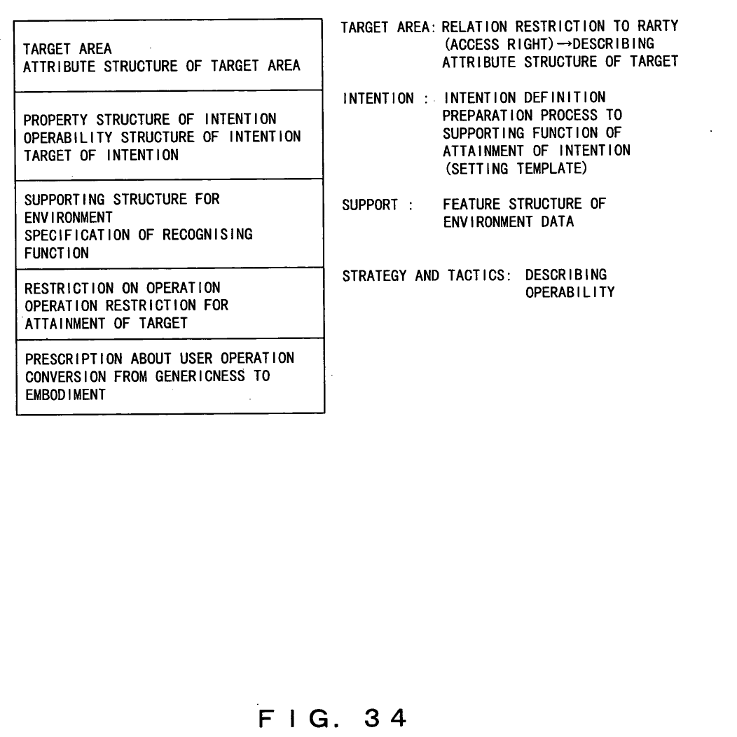

FIG. 27 is an explanatory view showing the process by data drive for realization of an intention. In FIG. 27, in addition to the primary role 110 and the supporting role 111 similar to those shown in FIG. 20, for example, a specific role server 180 for performing a user role is provided. With the configuration, the primary role 110 corresponding to the agent role server requests the specific role server 180 for operation amount data as data drive, that is, the operation amount data of a brake and a handle corresponding to the operable structure described later by referring to FIG. 34 so that a response to the primary role 110 of the operation amount data can be returned corresponding to the attribute structure of the intention of the driver.

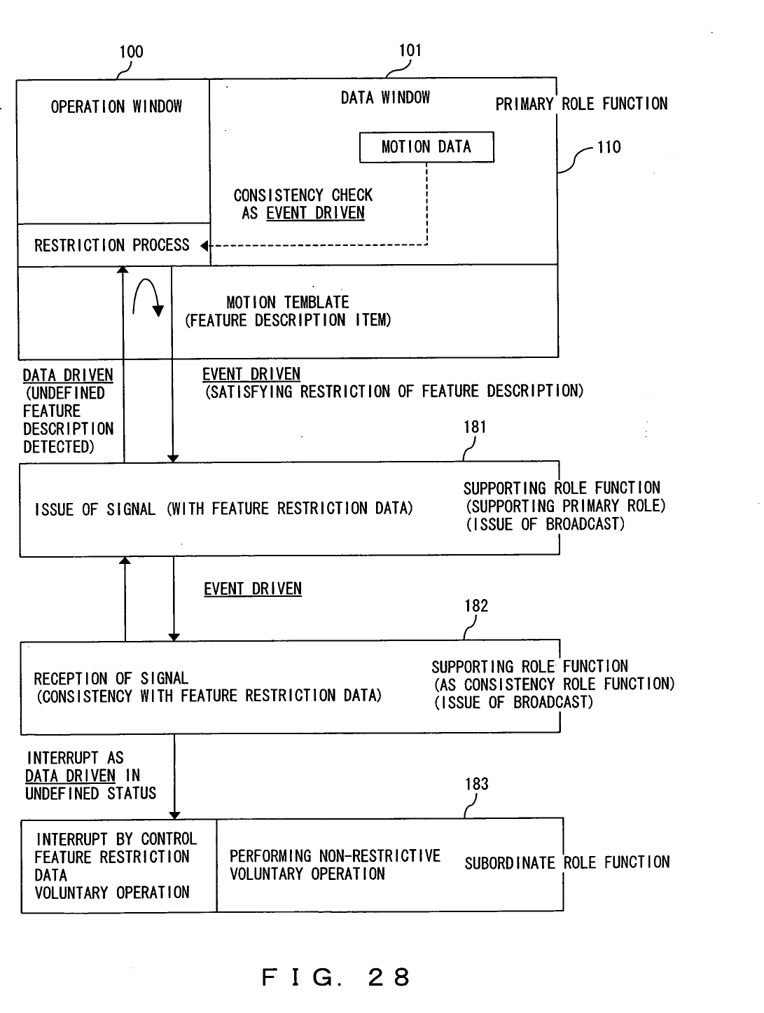

FIG. 28 is an explanatory view showing the hierarchical structure during the event driven in the cooperating process by the broadcast function. In FIG. 28, a supporting role function 181 originates a broadcast for support of the primary role 110, a supporting role function 182 receives the broadcast, and controls the function of a subordinate role function 183. The event driven from the primary role 110 to the supporting role function 181, and the event driven from the supporting role function 181 to the supporting role function 182 form a hierarchical structure.

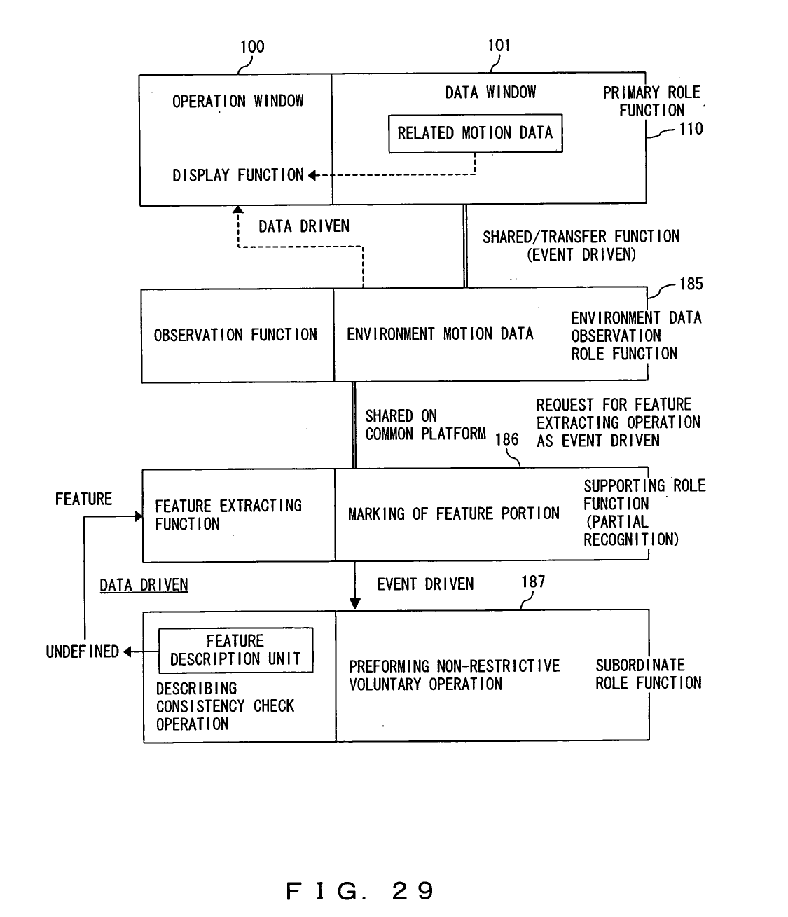

FIG. 29 is an explanatory view showing the cooperating process by the function of partially recognizing environment data. In FIG. 29, the entire environment data is observed by an environment data observation role function 185, and a supporting role function 186 for recognizing a partial movement, etc. is furthermore provided, thereby partially recognizing environment data. The supporting role function 186 performs event driven, etc. for a subordinate role function 187 as necessary.

Described below is the hierarchical structure of an object according to the present embodiment. In the present embodiment, the hierarchical structure of an object is formed by four models, that is, a data model, an object model, a role model, and a process model.

First, for the data model in the lowest level in the hierarchical structure, the attribute structure is planned as, for example, a template as shown in FIG. 12, and is input to the kernel in the WELL system. The input format is a list of data, and the kernel sets the process request in the work area for the execution of a service corresponding to the event drive in the executing progress of the process, and specifies the cell position requiring the data definition in the template by the data drive.

The next object model is classified into three models, that is, a format model, a feature model, and an object network model. First, the format model formally represents the patterns of a noun object and a verb object. For example, it is the “point” shown in FIG. 4.

As a noun model, a common noun, a proper noun, and a generic noun are integrated and represented as an abstract generic noun. Normally, in the object network, a common noun is used as a name, a list structure representation is performed by an expert for the template in the data model, and the result is stored in the WELL kernel. At this time, the common noun has an attribute of an indefinite article of “a”. For example, when a common noun is specified by the event drive from a user, the operation of preparing for data definition is performed, and when, for example, a data defining operation is performed by the user depending on the data drive from the system, it is considered that a conversion into a proper noun having the attribute of a definite article of “the” is performed.

The verb object as a format model is the format of a pair to a noun object, and takes the form of, for example, a subject and a predicate. A verb service executing preparation for an operation and a service executing operation are performed during the executing process of an object network.

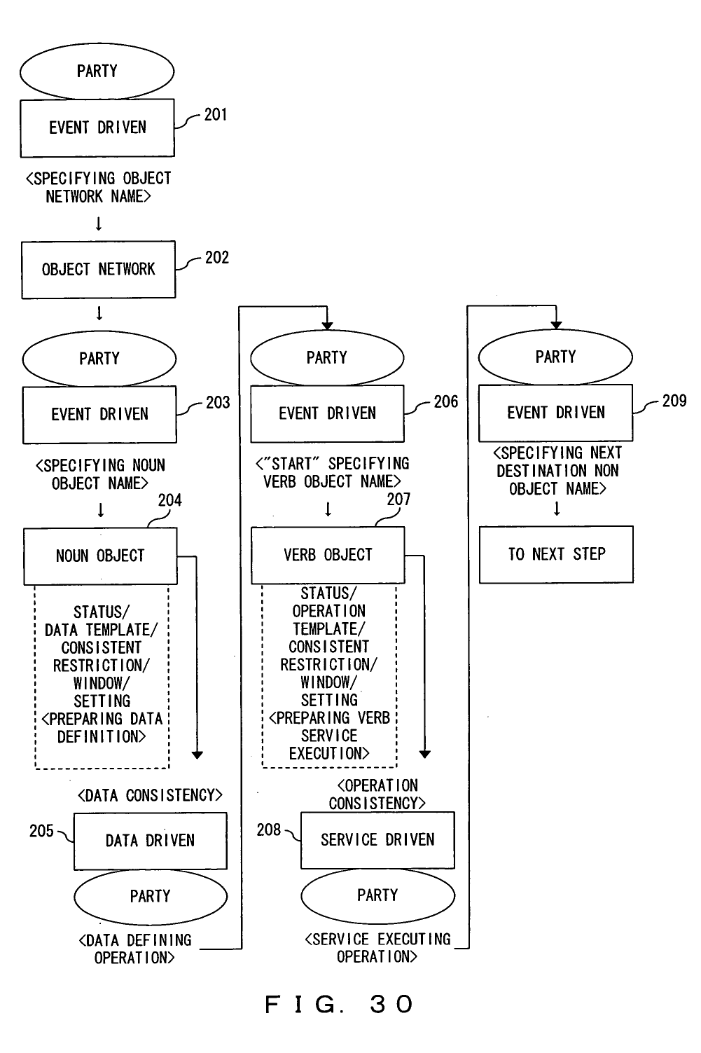

FIG. 30 is an explanatory view showing the user process on an object network. In FIG. 30, for example, a party as a user specifies the name of an object network 202 by an event driven 201, and the party then specifies the name of a noun object 204 in the object network 202 by event driven 203.

Corresponding to the specified noun object 204, the data consistency is checked by the system. For example, if there is undefined data, data driven 205 requests the party who is to define data to perform data defining operation.

When the party defines undefined data, and the party, for example, the user specifies the name of a verb object 207 through event drive 206, the object is pointed and a start instruction is issued to the system. In response to the instruction, the system checks the operation consistency, and performs service driven 208 for execution of a necessary service as event driven, thereby performing a service executing operation by the party.

Then, for example, the party as a user specifies by event driven 209 the name of a noun object to be the next destination, and the process at the next stage continues.

The feature model in the object models represents the feature based on the attribute value of a noun object such as a “colored point” forming the drawing object network, and is a model to which restriction conditions are added depending on an environment.

For example, when a WELL kernel requests using the event driven of another server, for example, a specific role server to perform a service relating to the position in which the contents of the consistent restrictions in the template structure of an object are prescribed, the server requests data prescribing the feature model by the data drive. The process corresponds to the communications among a plurality of servers, and one of the services of the WELL kernel.

Then, the object network is stored in a work area managed by the WELL kernel as a graph structure as a data model having the name of a noun object represented as a template and the name of a verb object as a branch, and is displayed on the common platform. To attain this, the expert has to represent in the format of specifications a noun object and a verb object represented in the form of a format model and a feature model, and prepare them as a graph structure for an executing process. Therefore, the graph structure editor is required as a tool for the description of the graph structure and display on the common platform.

When an object has an abstract name, the object network for embodying the abstract property and a set of data to be provided for it are required. To attain this, the process model described later and the related system are required. An object network model has the name of the network as a header, and can be referred to by the name. It is also referred to by providing the function of indexing a noun object and a verb object as the components.

The third model forming the hierarchical structure of objects is a role model. A role model corresponds to a role function described above by referring to FIGS. 20 through 22, and the party refers to the model in which the contents to be executed in an environment is represented as a set of a plurality of object networks.

Therefore, the role model has a name as a role, and can be referred to by the name. Furthermore, a consistent restriction (condition) item name can be added, and it can also be referred to by indexing the item name. The role itself has a hierarchical structure so that it can be sequentially referred to.

The concept of a role is that each party represents the contents of the fact to be executed, and relates to the environment surrounding the party. Therefore, the contents to be executed depends of the change in environment. That is, it is necessary to adaptively change the structure of the object network, etc. based on the environment.

To attain this, the consistent restriction (condition) items are used. The contents of the consistent restriction items are described as the contents of the cell of the template defined as a data model corresponding to the noun object and the verb object in the object network. As shown in FIG. 30, the contents are defined in the object network as the attribute items relating to the operations of data definition preparation for the noun object and the operations of verb service execution preparation for the verb object, and are processed by a party, for example, a user by the drive system corresponding to the operation name.

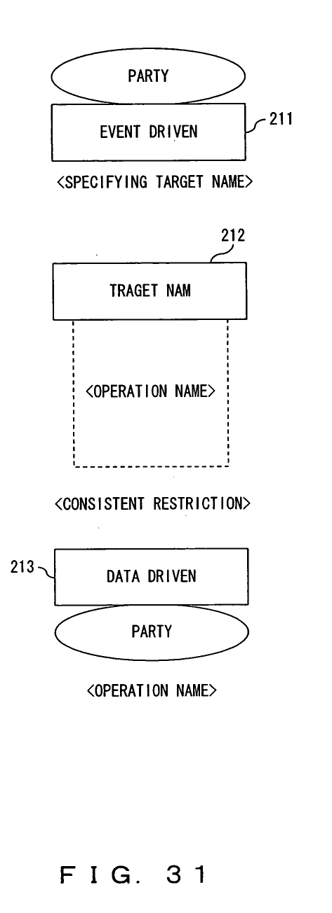

FIG. 31 is an explanatory view showing the relationship between a party relating to the consistent restrictions and the drive system. In FIG. 31, the party specifies, for example, the name of a noun object as a target name, and instructs the WELL system what is to be executed by event driven 211. The WELL kernel verifies the consistent restriction condition by processing the operation of the operation name relating to the item described in the template for the object of a specified target name 212. Depending on the result, the WELL system instructs the party to perform the operation of the operation name by data driven 213 through a common platform.

For example, the consistent restriction item defined by an expert and incorporated into an object is related to a consistent restriction item of another object as a process result of the supporting role function servicing a recognition effect on a restriction feature item as environment data by a service of the communications function explained by referring to FIG. 22, and is used in a cooperative operation with the object network for subsequently performing an executing process.

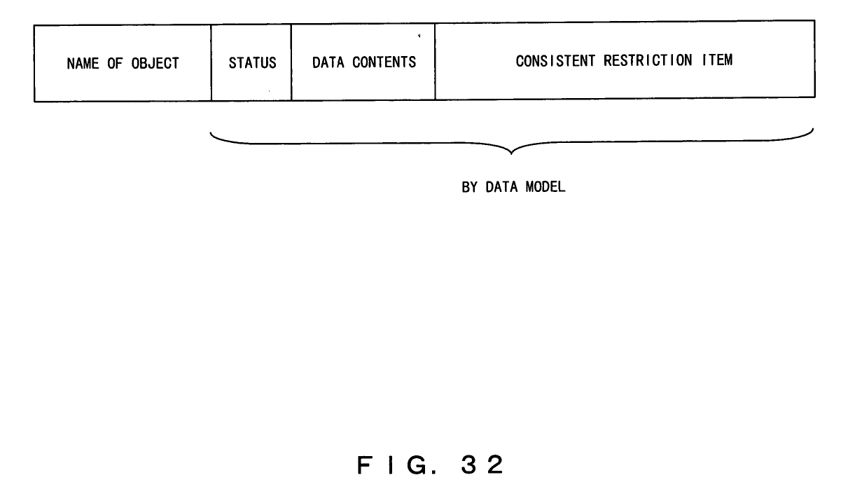

The object network is defined as described above by a graph structure formed by a noun object as a node and a verb object as a branch. FIG. 32 is an explanatory view showing the template of an object. As the contents of a cell of a template, a name, a state display, data contents, and a consistent restriction (condition) item are defined. For a generic object, a link of a hierarchical structure of an object is formed by providing a name of an object as a parameter for practical realization as data contents. A parameter can be represented hierarchically, sequentially, and practically using a consistent restriction item.

The basic data contents of a noun object can be a numerical value, a symbol, etc. as practical source data, an abstract name, for example, the name of an object as a parameter for the above-mentioned practical representation.

The most practical data contents of a verb object is a function name. Obviously, it is necessary that a function name can be referred to as an executable algorithm.

As to a function, there is a conversion process from abstract contents to practical contents as the contents of a noun object, and the structure is represented as data. The structure is implemented for conversion by a specific role server through an agent role server, or represented as data for execution request by event driven.

The fourth model in the hierarchical structure of an object is a process model. This model defines the process as a dynamic process performed by a plurality of role models. In planning and designing a process, a process performed by a plurality of role functions is planned corresponding to a consistent restriction item defined by a verb object in a plurality of role functions. As a control format at this time, control depending on time restrictions such as a continuing process, a synchronous process, a stopping process, a resuming process, etc. are performed.

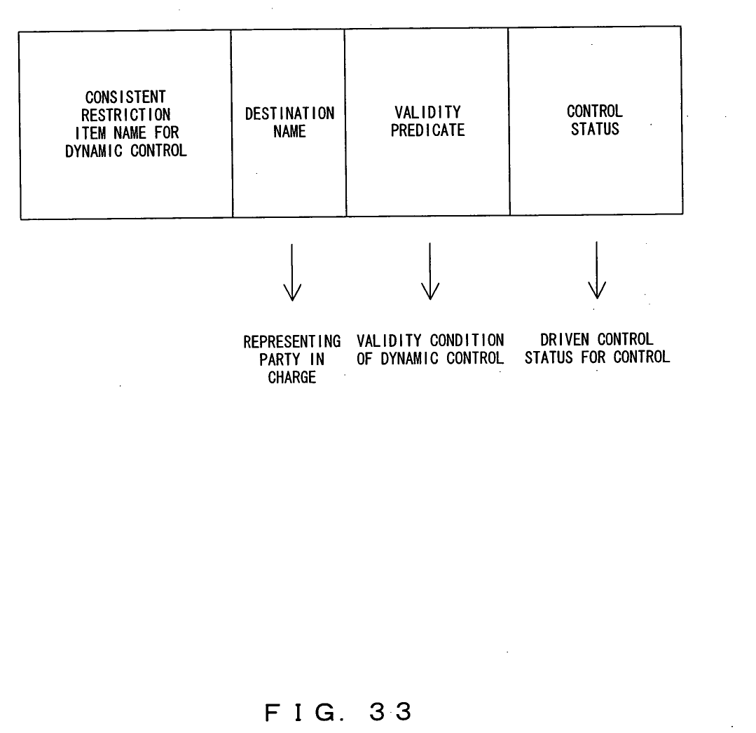

FIG. 33 shows the contents of a template for dynamic control of a verb object, and shows the details of the cell contents of a consistent restriction item shown in FIG. 32. In FIG. 33, the destination name refers to a party in charge. The validation predicate is a pair to a noun object, and indicates the validity condition of verb control in the dynamically selected verb object. The control state is represented corresponding to the current state of the party in response to a process request to the party so that the execution possibility of the service of the party can be controlled.

The process of representing an intention is described below furthermore in detail. FIG. 34 shows the definition structure of an intention. At the first stage, an attribute structure is defined for a target area name and a target area. In the examples of the above-mentioned two cars, the two-way road is a target area, and the attribute structure of the target area is a priority road, a 1-lane road, a 2-lane-road, etc.

At the first stage, a validity check is made whether or not the party is appropriate for the realization of an intention relating to the target area based on the interaction with the system about the attribute data about the target area of the party. For example, when a party attains an intention of driving a car on a road, one of the access rights on the road condition is that the party has the right to safely drive a car. This can be the access right in the social system in which a plurality of drivers can drive their own cars without accidents.

To establish Internet communications, a party has a communications path to a qualified terminal, and is allowed to practically access the system through the interaction with the system using data including a password for authentication for the qualification of an account, a password, etc.

That is, by the party planning the execution of an intention relating to a target area and performing a <target name instruction> by the event driven 211 as shown in FIG. 31, the system starts the process on the corresponding object network. Then, the verification on the <consistent restriction condition> added to the object to the <operation name> is performed.

In the structure of the definition of an intention of FIG. 34, after the definition of a target area, the conversion from a generic intention corresponding to the generic object network to a practical intention corresponding to a specific object network is sequentially performed. During the process, by determining the validity of the condition described in the consistent restriction item added to the generic or practical noun object, the system requests the party to perform the <data driven> operation, and necessary data or a necessary operation are obtained.

That is, as the second stage, relating to the intention, the intention property structure, that is, an independent intention, a cooperative intention, or a conflicting intention, the operable structure for an intention, for example, the level of the operation of a brake and a handle for avoidance of a collision, the collision avoidance means as the target (object function) of the intention are defined. At this stage, as an intention definition preparation process, a template for a possible operation structure is set.

Then, as the definition of a support structure for the attainment of an intention, the specifications of the partial recognition function, etc. is determined to extract the feature structure of the environment data as to whether or not there is target environment data, for example, the information that there is a curve on the road, etc.

Finally, a strategy and tactics are defined. A strategy is a generic restriction on the operation to attain an intention, and the restrictions of an environment and a physical operation, the operations for attainment of a target, etc. are defined.

Then, tactics is determined. Tactics is obtained by embodying the genericness of an operation as a strategy, and the genericness is converted into embodiment by receiving a command of a user through data driven.

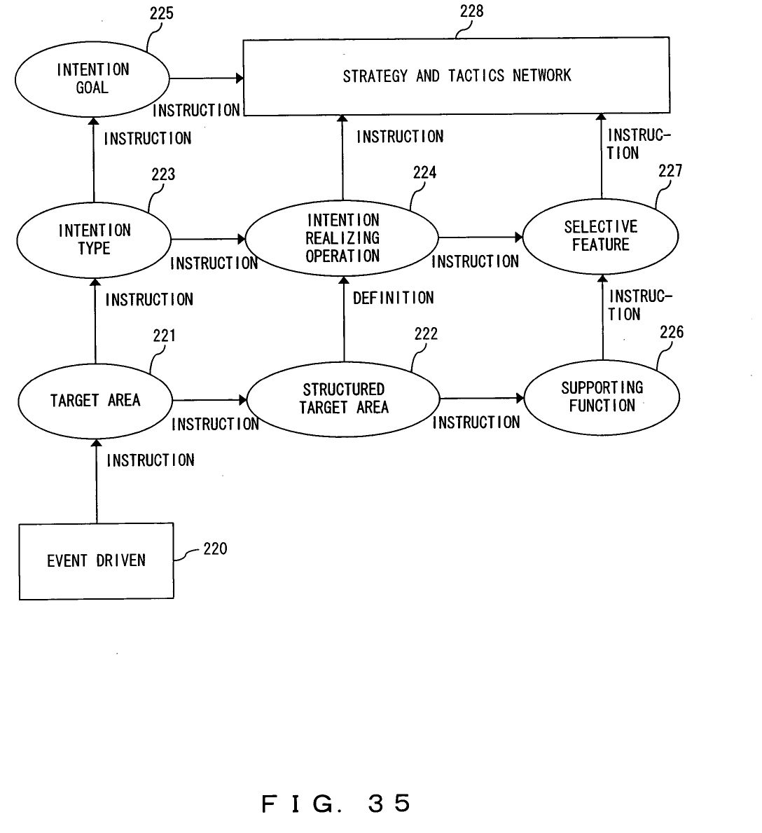

FIG. 35 shows the entire configuration of the generic object network for the realization of an intention for final determination of a strategy and tactics for realization of an intention. As described by referring to FIG. 34, the target area for realization of an intention is a generic noun object. In response to this, an indication of a target area applicable to an intention from a list displayed on the common platform by an <event drive> 220 is received from the client, and a target intention is attained according to FIG. 35. At this time, first, in the definition structure of an intention such as an attribute structure, etc. of a target area, the generic item is embodied as described above by referring to FIG. 34.

In FIG. 35, at first, the party, for example, a client as a user, starts from the state in which the client has no intention, and then indicates a target of an interest of the user, that is, a target area 221. Since no practical target area is defined, a list of target areas which can be provided from the system is displayed on the common platform in the data drive format, and an attribute structure for the target area 221 specified by the user, that is, a structured target area 222, is defined. If a two-way road is selected as the target area 221, then, for example, two cars are defined as an attribute of the structured target area 222.

Then, when the user specifies an intention type 223 as event driven in the operation window, the system inquires which is the intention as data driven, an independent intention, a cooperative intention, or a conflicting intention. In response to the inquiry, the user specifies any of the intentions. In this case, for example, a cooperative intention is selected.

From the intention type 223 and the structured target area 222, the user determines the possible operation structure for the intention in the format satisfying the data not defined in the template, that is, the above-mentioned operation levels of an accelerator, a brake, and a handle as the contents of an intention realizing operation 224. As an intention goal 225, an intention of cooperatively avoiding a collision is defined. As a practical target, the intention is represented as the crossing of cars with a space of the minimum allowance, and the contents are displayed on the message window as a message from the system.

For realization of an intention, data of an environment is also required as described above. That is, a feature amount is extracted from environment data, and a role supporting the operation of determining an operation amount is required. As a supporting role function, an appropriate function for a target area is selected by a user as a supporting function 226. For example, in the case of a two-way road, the road map using GPS of the area the car is headed for, and a driving prediction system of the opposite car as a camera system can be considered. For example, a supporting role function of representing in vector an enlarged road map and driving data of the opposite car is selected on the GPS screen, and the supporting structure for the attainment of an intention and the specifications of the recognizing function are defined. For the data drive by a selective feature 227, the data for the driving characteristic of two cars not defined in the template structure is substituted.

A controllable operation amount is defined by the intention realizing operation 224 on restriction conditions, and the amount of the control of the handle is added as one of the restrictions from the driving speed of the current car on the two-way road. Based on the data input from the intention goal 225, the intention realizing operation 224, and the selective feature 227, a strategy and tactics network 228 determines a strategy and tactics.

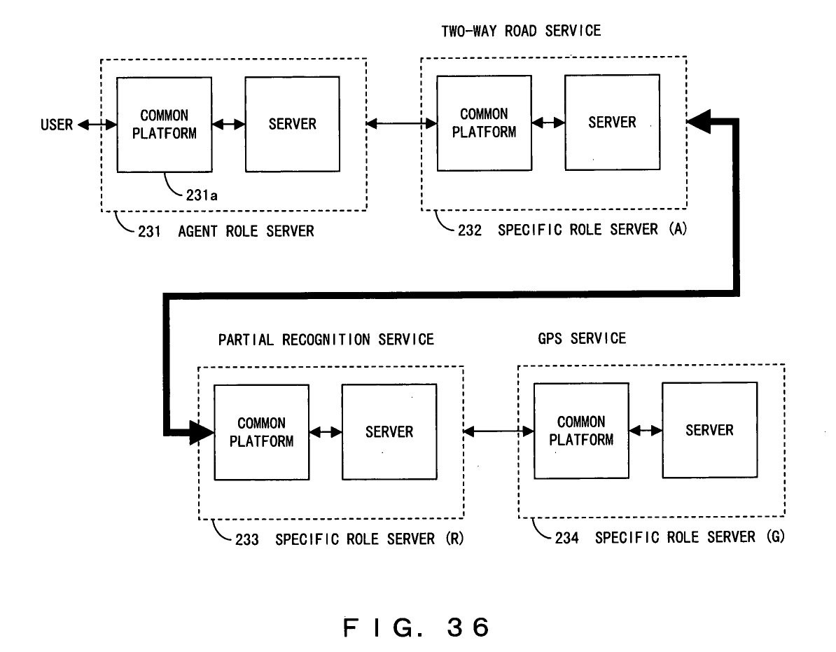

FIG. 36 is an explanatory view showing the connection structure between servers for representation of an intention. In FIG. 36, an agent role server 231, a specific role server (A) 232 for realization of a two-way road service, a specific role server (R) 233 for realizing a partial realization service, and a specific role server (G) 234 for performing a GPS service are connected.

On a common platform 231a of the agent role server 231, a generic object network defined by an agent expert is displayed. The network is represented as a graph using a generic noun object and a generic verb object. To convert it into a practical specific object network, it is necessary to embody the parameter of a changeable portion represented as a generic object, and the user is requested to specify the conversion from a generic name to a practical name as data driven. By the specification, for example, the two-way road of two cars is selected as a target area.

The agent role server 231 selects the specific role server (A) 232 which can realize a two-way road service from a database, and connects it to the agent role server 231. Then, the specific role server (A) 232 sets a template corresponding to the operation amount data in response to the operation instruction to the intention realizing operation 224.

Similarly, on the common platform 231a of the agent role server 231, when the supporting function 226 is specified, a selectable item list is displayed on the common platform 231a. When the user selects the GPS service, the function of the GPS, or a simulator is referred to, and the specific role server (R) 233 to which the specific role server (G) 234 for the GPS service for performing the function is connected to the specific role server (A) 232 for the two-way road service.

When the selective feature 227 is specified, the partially recognizing function for the specified feature restriction amount is realized by the specific role server (R) 233. That is, the specific role server (A) 232 specifies the necessity of the function of the specific role server (R) 233, and the specific role server (G) 234 is prescribed as the supporting role function for satisfying the necessity. As an appropriate visually recognizing function can be performed by, for example, an operator.

To embody the generic strategy and tactics for performing the intention realizing process as described above, an expert makes a determination or an empirical method using the learning function of the user is adopted. The method and structure for attaining an intention are determined in a top-down manner in the former, and in the bottom-up manner in the latter.

Described below in detail is the embodiment of the service effect improving system according to the present invention. As described above, in the service system aimed at by the present invention, a party as a client who requests a service and a party as a server who presents a partial service or presents integrated partial services for the client are provided with the intention realization data processing device having a WELL system as a kernel, and a total external environment data as common data for a service offering process is centrally managed such that each party can concurrently refer to the data as necessary.

The intention realization data processing device basically performs object-oriented data processing, and the object is hierarchically structured by four models, that is, a data model, an object model, a role model, and a process model. Each model operates independently and concurrently. Therefore, in the present embodiment, the adaptation for each model, that is, the adaptation for the improvement of a service effect is performed independently for each model. Thus, a wasteful relation can be removed with the service effect improved.

To evaluate the service effect in a service system, it is necessary to consider the interaction between an intention of a client using a service and an intention of a server providing a service.

A server who provides a service as a party has a role depending on the specialty for each service. That is, an agent role server is used for management, and a specific role server relating to a special service job is used in performing an individual service. A server who supports the execution of a server job can have the supporting function for improving the quality of the service network such as interactive communications, plan designing, an interface, safety management, etc.

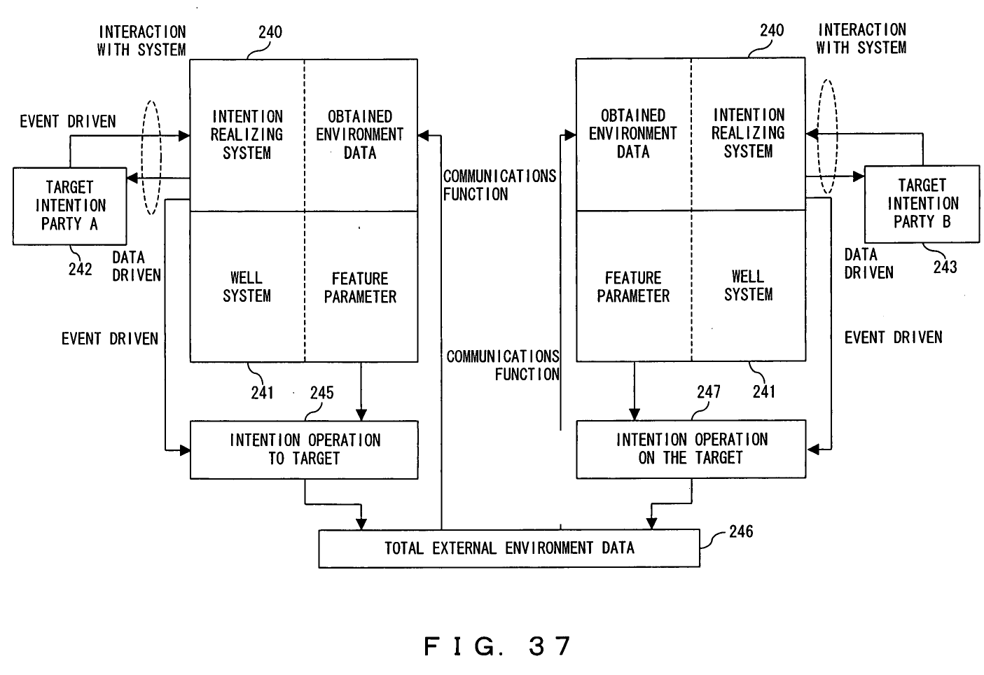

FIG. 37 is an explanatory view showing the call function during the intention processing in a service system. In FIG. 37, a bidirectional interaction function is realized using total external environment data among a plurality of parties A and B.

In FIG. 37, for example, an event driven relating to a target intention 242 is provided from the party A for an intention realizing system 240, that is, the intention realization data processing device. The intention realizing system 240 comprises a WELL system 241 as a kernel function.

In response to the intention of the party A, the intention realizing system 240 instructs the external operation device to perform an intention operation 245 on the target as event driven. Thus, the operation is reflected by total external environment data 246. As described later, the total external environment data 246 stores the result of operating an intention as a feature parameter for each party.

Similarly, a target intention 243 is provided for the intention realizing system 240 from the party B. As in the case of the party A, an intention operation 247 on the target stores a feature parameter in the total external environment data 246.

The intention realizing system 240 allows the external operation device to perform an intention operation 245 on a target as an event driven corresponding to the intention of the party A. Thus, the operation is reflected by total external environment data 246. As described later, the total external environment data 246 stores a result of the intention operation as a feature parameter of each party.

Similarly, the party B also transmits a target intention 243 to the intention realizing system 240, and an intention operation 247 on the target stores a feature parameter in the total external environment data 246 as in the case of the party A.

When the intention realizing system 240 allows the external operation device 245 to perform an intention operation on a target as an event driven corresponding to the intention of a party, it refers to the contents of the total external environment data 246 using the communications function, determines the consistency of data using the contents as the obtained environment data, thereby maintaining the consistency of the process as a system.

In FIG. 37, when the parties A and B have cooperative intentions, the cooperative operation is performed between parties so that the cooperative intention can be realized. Otherwise, when the parties have conflicting intentions, the WELL system is used by each party to realize the mutual operations, and the role function is used to extract necessary environment data through the supporting function from the data stored by each party and the data displayed on the common platform for display of the total external environment data as shown in FIGS. 27 and 29, thereby processing the cooperative or conflicting relation.

In FIG. 37, for example, medium information is processed in the WELL system, and the interaction between parties are performed by the bidirectional interaction function. In the interaction processing, the intention realizing system 240 having the generic object network for the realization of an intention explained by referring to FIG. 35 has the kernel function. As an interaction function, the basic interaction between two parties A and B is performed. However, when there is the relationship among the intentions of the parties in the interaction among a number of parties, each party consistently attains the cooperative intention or the conflicting intention with the intention goal 225 shown in FIG. 35.

When a plurality of parties are dynamically organized as a team and it is necessary to perform an integral process on the common, independent, and conflicting intentions among the parties in the team, the leader or the manager of the team has to confirm the consistency as an agent to maintain the consistency of the intentions of the parties in the team.

The total external environment data 246 shown in FIG. 37 includes the structure data of the parties A and B relating to the system, and the attribute structure of the target area relating to the intention. The data about the restriction condition items for each party is contained as the data recognized by the party depending on the action of the party, that is, the operation of the intention on the target.

The target intention of the party A or B shown in FIG. 37 is reflected by the contents of the operations such as the strategy and tactics for the action to be taken by the party on the target area of the intention whose definition structure is explained by referring to FIG. 34. When the operation of the intention is performed corresponding to the target intention, the total external environment data 246 is referred to so that the feature data of the environment data can be obtained using the supporting function, that is, the communications function, and the interaction operation is started as the interaction between the party and the system.

To perform the interaction operation, the party uses an appropriate terminal function. The function of the terminal in the WELL system provides an instruction by the event driven in the window explained by referring to FIG. 7, that is, in the window in which the strategy and tactics to attain an intention are displayed as a generic object network, sequentially embodies the generic object network, maintains the consistency with the total external environment data, and realizes the intention. At this time, when the total external environment data 246 changes in the intention attaining operation of the other party, it is necessary that the operation is performed depending on the change of the object network and the data on the display, and the adaptation to the environment is executed.

In the intention realizing process, the process of the interaction with the system is serially and hierarchically performed to attain the target of the intention of each party based on, for example, an independent intention. That is, the serial embodying process from a generic object network to a practical object network is performed as interaction processing corresponding to the hierarchical object structure of a data model, an object model, a role model, and a process model.

That is, using the bidirectional interaction function shown in FIG. 37, an adapting operation is performed to attain the intention of each party corresponding to an intention sequence generated by each party through the interaction with the system, that is, the time sequence of unit intentions as simple intentions. The adapting operation is performed by referring to a total external environment including the other party, that is, the total external environment data 246, and embodying the strategy and tactics in the generic object network of intentions. To change a dynamic process with the view of attaining the target of an intention, the consistent restrictions for dynamically controlling the verb object explained by referring to FIG. 33 are used.

As the simplest interaction system corresponding to FIG. 37 is a case in which a user as a client is one party, and a server who provides a service for the user is the other party with the WELL system implemented in the intention realization data processing devices of both parties. If medium information is provided as a service for the user, then the multimedia contents based on moving pictures are the targets of the intentions.

Relating to the intentions of the involved parties, the attribute structure of the intention explained by referring to FIG. 34 is defined, and the embodiment from the generic level to the practical level is performed. First, the name and the attribute structure of the target area of the intentions of the involved parties are specified. As described above, for example, when road traffic is a target area, it is necessary to define a target as a party moving on the road as an attribute structure in the target area. As a result, the structured target area 222 explained by referring to FIG. 35 is embodied. For example, for multimedia contents, a stage and characters on the stage are embodied.

As for the interaction in performing a service offering process, it is important that a specialty field is specified as an attribute of a party in charge of each item of a service, and a schedule is set such that the interaction can be an integral complement.

The attribute structure of the intention of a party is explained by referring to FIG. 34. The target area shown in FIG. 34 is specified as a target of the intention of the user using a service. At this time, it is necessary that the client determines that the value of the service is appropriate for the intention of the client.

For example, when the client has an intention of driving a car on the road, the use of the service is evaluated depending on the gain obtained by the environment structure for the attainment of the service provided by the server for the client as the property structure of the intention. That is, the speed level of the car is evaluated and the value of the use of the service is evaluated based on the relationship between the supporting structure as the feature structure of the service such as the signal equipment, the road condition, the condition of the two-way road, etc.

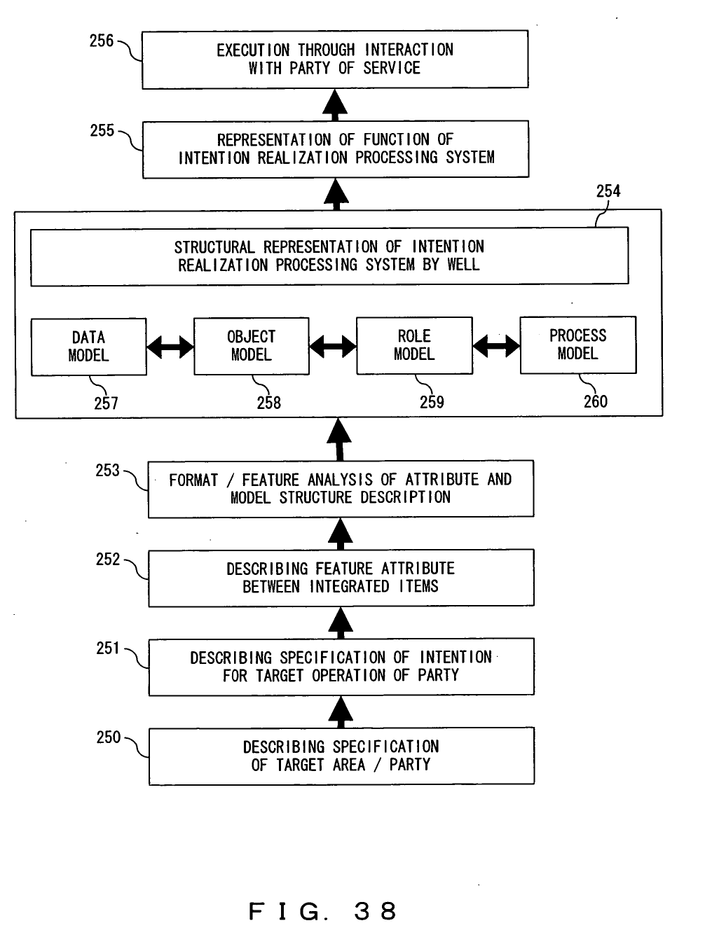

FIG. 38 is an explanatory view showing the general process of realizing the intention of a party in the case above. In FIG. 38, a specification description 250 about a target area and a party is made, a specification description 251 about an intention for the target operation of the party is made, a feature attribute description 252 among integrated items is then made, and a description 253 of the attribute format/feature analysis and the model structure is made.

Then, structural realization 254 of the WELL executing system and function representation 255 of the intention realizing system are performed, and offering a service 256 through interaction with a party of the service is performed based on the results of the operations above. In the structural representation 254 of the WELL executing system, the structure of a system is represented by a data model 257, an object model 258, a role model 259, and a process model 260 of an object having the hierarchical structure as described above.

The use value of the above-mentioned service depends on the contents of the strategy and tactics network for the realization of an intention, that is, the object network explained by referring to FIG. 35. As a client, when using the road system provided by the server, the techniques of driving a car by the client can be improved by adaptively increasing the data which is the selective feature of a service as the knowledge data of the strategy and tactics network by the supporting function of the client.

Similarly, when a number of cars use services, a server effectively uses a set of driving data to improve the function of the supporting parameter of the system, thereby obtaining a high evaluation from a number of clients. By the above-mentioned adaptation of interaction between the intentions of two parties, that is, the client and the server, a service effect as a desired result can be realized.

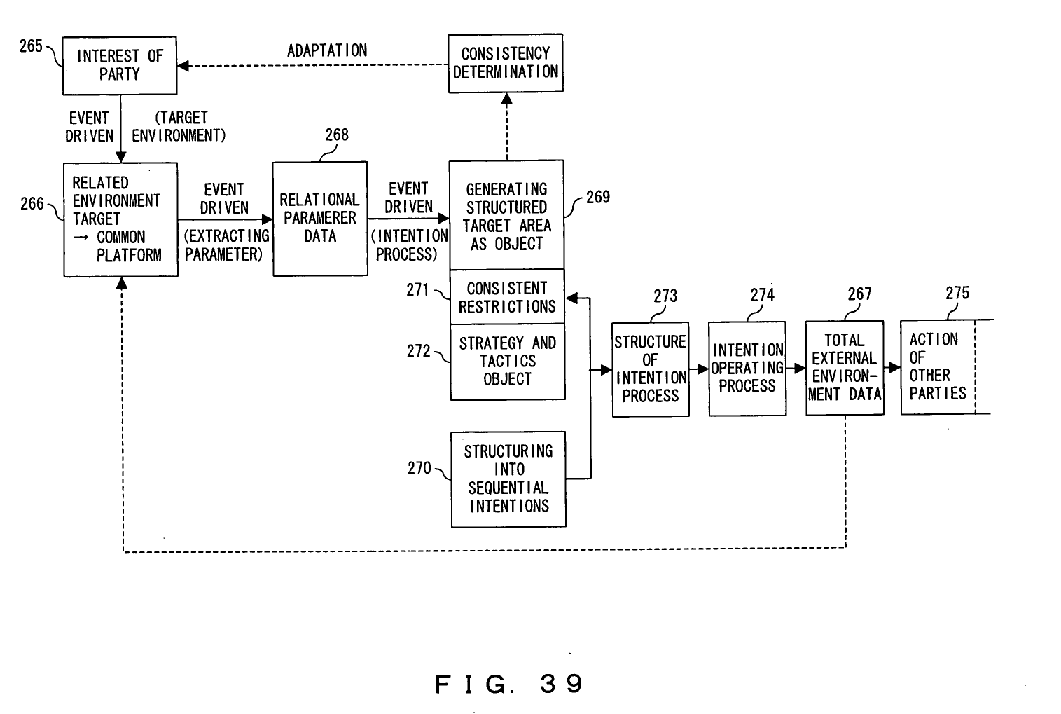

FIG. 39 is an explanatory view showing the flow of the intention realizing process of each party by event driven. In FIG. 39, when a target environment is specified by a WELL system as event driven in response to interest 265 of a party, the data corresponding to a related environment target 266 is extracted from total external environment data 267, and displayed on the common platform. Then, the party extracts an interesting parameter as event driven, and relational parameter 268 of a relational parameter is provided as event drive for an intention realizing system, that is, the WELL system.

In the WELL system, structure 269 as an object of a structured target area is realized in response to the event driven, and consistent restrictions 271 on structuring 270 a series of intentions, that is, a sequence of unit intentions, embody a strategy and tactics object 272, an intention process, that is, a series of intentions, for example, the process of a football game, etc. is structured 273, and an intention operating process 274 is performed. The result is reflected by total external environment data 267.

The result of the process of the consistent restrictions 271 by the intention realizing system causes the adaptation for the interest 265 of the party in the process of consistency determination 264. That is, in the progress of the intention realizing process, the adaptation of a unit intention as the interest of a party, that is, a change in interest can occur. Furthermore, action 275 of the other party indicates the left of the total external environment data 267. Similarly with the other party, the intention realizing process is performed by the event driven.

In the intention realizing process explained by referring to FIG. 39, using the consistent restriction condition items corresponding to the noun and verb objects explained above by referring to FIGS. 30 and 31, the realizing process is verified. In FIG. 30, the states of the noun object 204 and the verb object 207 indicate the status of the object which is the target of the process shown in FIG. 39, and relate to the data control of the consistent restriction condition.

It is necessary to adaptively manage the attribute structure of a target area as a component of a service providing system and the member organization of parties. Therefore, the items relating to the attributes of the features of a target area and a party are analyzed. For the analysis, the following two-item classification is necessary in the WELL system as a separation attribute for an instruction about the representation of the generation, processing, recognition, etc. of the information item about a service.

(1) status/operation, (2) priority/standby, (3) item/function, (4) preparation/operation

As the classification of mutuality of intentions of a service, the following information is described.

(1) cooperation/conflict, (2) generation/increase and decrease, (3) consistency/inconsistency (malice), (4) generic/practical

As the classification of the relationship between the environment item and the party, the following information is described.

(1) multiple/single, (2) recognition/forgetfulness, (3) serial/parallel

It is necessary to schedule and configure the intention of a party group to adapt the attribute classification with consistency.

A number of related parties have various influences on the service effects by a large number of clients requesting a service system to provide services and supporting a service environment. To check a service effect, it is necessary to recognize the relationship of the intentions of a number of related parties. Especially, it is essential to analyze the strategy and tactics network for attainment of a goal of the intention of each of the related parties.

There are client groups of (1) a common benevolent group and. (2) a malicious user group having individual intentions of clients of services. Considering the classification of the groups, it is necessary for a system to adapt the implementation of a feature model of a client so as to guarantee the security of the system with a malicious intention taken into account.

For example, in the case of road traffic, the goal of an intention of a benevolent client who uses a road service is to cooperatively use the road with a number of clients. On the other hand, reckless individuals violently show off their driving techniques, and intend to interfere with the driving of other benevolent clients. Therefore, the intentions of the reckless individuals and benevolent clients are conflicting intentions from the viewpoint of using the services.

In view of a social service of the distribution of bank notes, a majority of people display cooperative intentions of cooperatively distributing standard bank notes while the small number of people who intend to earn illegal profits by maliciously falsifying notes are considered to have conflicting intentions.

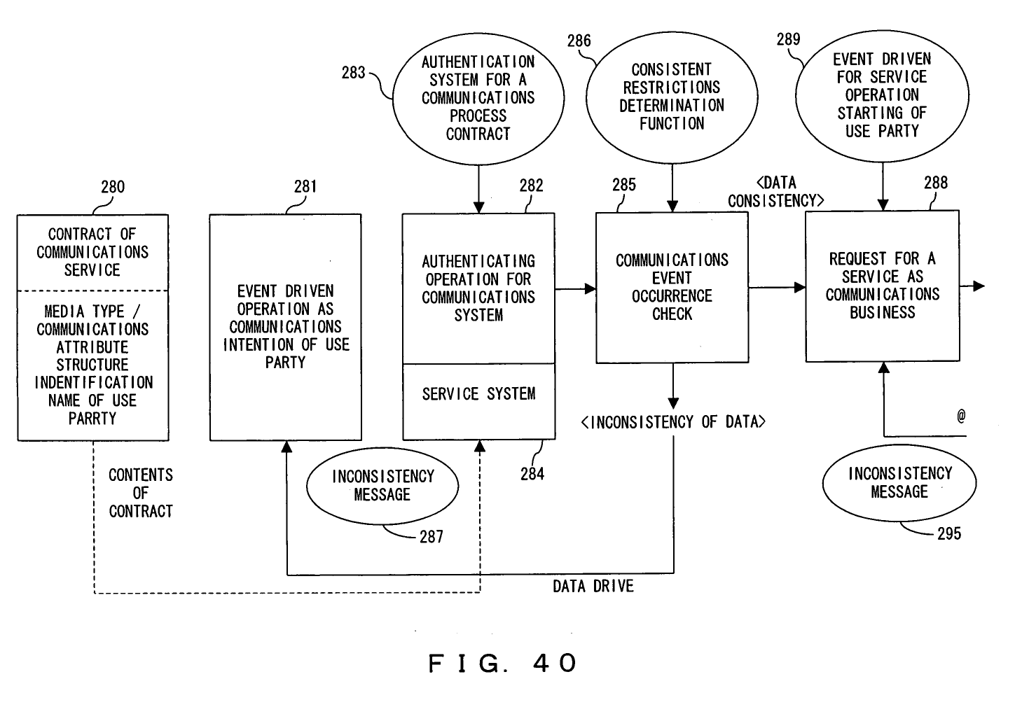

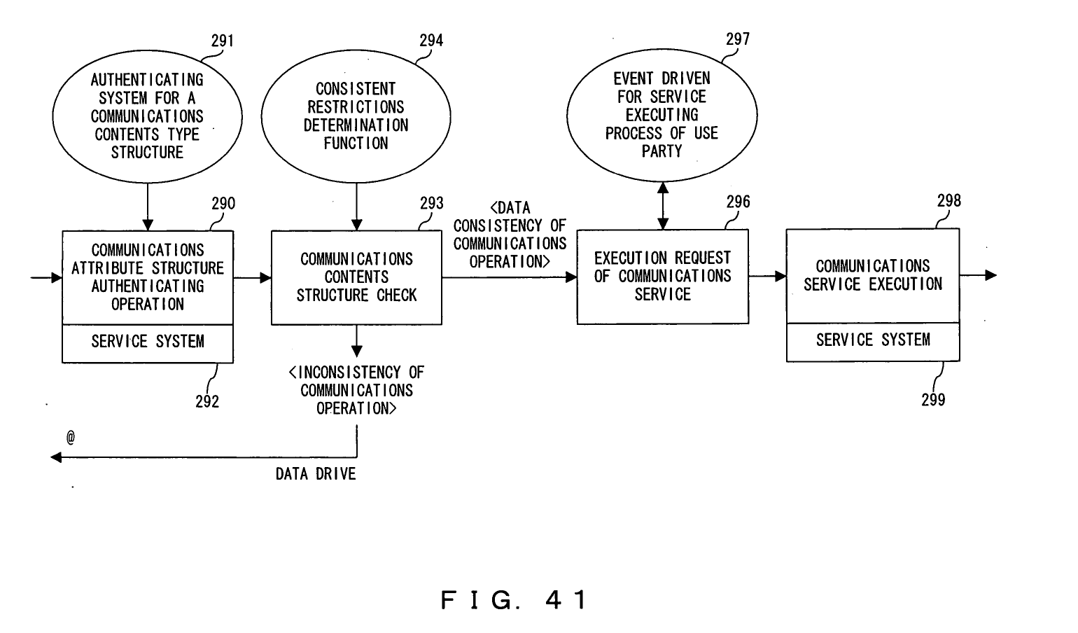

In performing a servicing operation, an efficient process can be performed using an interaction function of a system between a client and a server. This process is realized by the flow as shown in FIGS. 40 and 41 for the goal of the system security and cooperation as described below.

(a) Security of a system

The following items are guaranteed for the system in an interaction process.

(1) When the communications in the system is guaranteed, the validity of a connection is checked by the authentication of a communications connection. That is, the operation guidelines are observed.

(2) The privacy of data to be provided for a client is maintained, and the privacy of an attribute value of a client is protected. That is, a validity check is performed on the consistent restriction item of data.

(b) Cooperation Between Related Parties

When an execution process is performed with cooperation for a service among a number of parties, the parties have goals with cooperative intentions to attain the goals as a result of a party performing the execution process or by a plurality of parties performing a cooperative operation to cooperatively attain the goals, thereby requiring adaptation of strategy and tactics to realize the role function of each party.

FIGS. 40 and 41 are explanatory views showing the interaction function by communications to perform the above-mentioned cooperative operations.

In FIG. 40, in a communications service 280, if a contract is first made using the type of medium such as the type of telephone line, PHS, etc., a communications attribute structure, a user party identification name, etc., and an event driven operation 281 is performed as a communications intention of a user party, then a communications system authenticating operation 282 is performed. The authenticating operation is performed by an authentication system 283 for a communications process contract, but the contents of the communications service 280 is used by a service system 284 as necessary, thereby performing a support for an authenticating operation.

The data consistency is checked by a consistent restrictions determination function 286 for a communications event occurrence check 285, and if the <inconsistency of data> is detected, then an inconsistency message 287 is transmitted as a response to an event driven operation 281 as a communications intention of a user party. If the <consistency of data> is detected, a request 288 for a service as communications business is issued to a service operation starting event driven 289 of a user party.

FIG. 41 is an explanatory view showing a communications service executing process in response to the request 288 for a service as communications business shown in FIG. 40. In FIG. 41, in response to the request 288 for a service as communications business, a communications attribute structure authenticating operation 290 is performed. The authenticating operation is performed by a communications contents type structure authenticating system 291, and is also performed by the support of a service system 292 as necessary.

Then, a communications contents structure check 293 is made. This is a process of checking as to, for example, whether or not all communications contents are written using uppercase characters. The check is executed by a consistent restrictions determination function 294. If <inconsistency of communications operation> is detected, an inconsistency message 295 is transmitted as a response to the request 288 for a service as communications business shown in FIG. 40 by data driven. The inconsistency message indicates the structure of the contents of communications.

If the <consistency of communications operation> is confirmed in the communications contents structure check 293, then an execution request 296 for a communications service is issued. The execution request corresponds to event driven 297 as a service executing process of a user party, and communications service execution 298 is performed on the execution request 296. For the execution of the service, a support by a service system 299 is obtained.

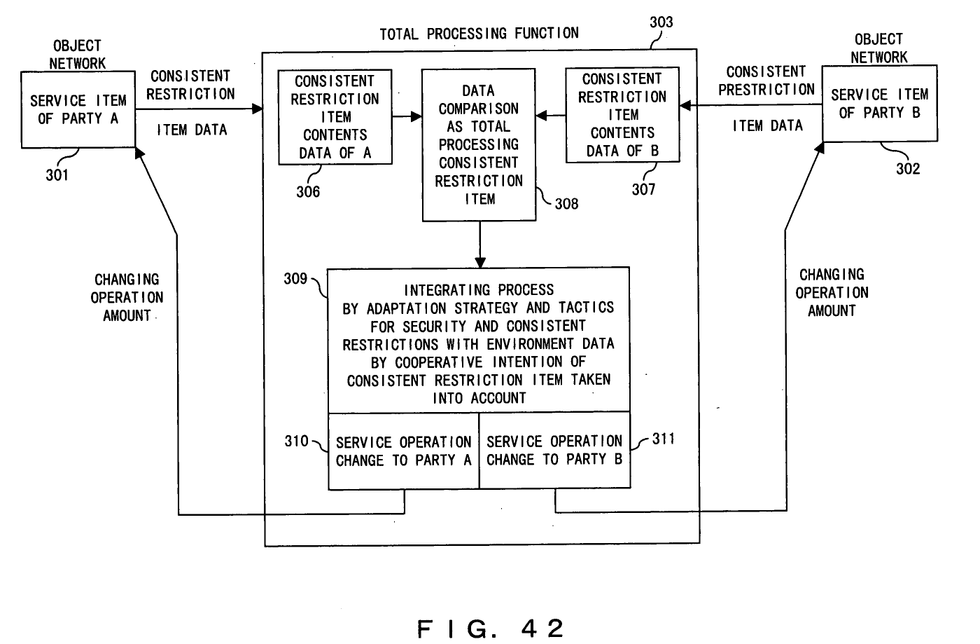

To maintain the relationship with the other party while maintaining the security through the above-mentioned interaction, it is necessary to realize the total processing function as shown in FIG. 42 as the adapting process. In this case, the adaptation can be performed by the server party making a comparison on the consistent restriction item data. The adaptation for maintaining the security is executed by improving the validity of the consistent restriction item through a change of an operation amount explained by referring to FIG. 42.

In FIG. 42, the parties A and B having the respective service items perform a service executing process by reserving the security of the consistent restriction items as the attribute structure of an object related to the corresponding service item. However, as a result of the parties A and B concurrently performing the respective executing processes, there can be the possibility of inconsistency when viewed from the interface between roles as a cooperative concurrent process. Therefore, it is necessary for a total processing function 303 to adjust the result of the executing process of the two parties A and B.

When the consistent restriction item data is transmitted to the total processing function 303 in response to the process result of the service item from each of the parties A and B as shown in FIG. 42, a data comparison 308 is made as a total process consistent restriction item using consistent restriction item contents data 306 and 307, the difference between contents data is extracted, an integrating process 309 is performed by the adaptation strategy and tactics for security and consistency restrictions with the environment data by the cooperative intentions of consistent restriction items taken into account, and change requests 310 and 311 of a service operation to the parties A and B are obtained in the process, thereby requesting each party to change an operation amount.

In the above-mentioned cooperative concurrent process, the security of a service function executing process can be guaranteed as a team. That is, the parties A and B cooperatively take measures for security for the users. First, the security measures can be designed for a cooperative concurrent process as a service for users. Second, it can be designed against the illegal action of users to the security of the cooperative concurrent process service function. These two security measures can be realized by issuing a request to change an operation amount to a party in any case shown in FIG. 42. To attain the purpose of the measures, it is necessary to allow the total processing function 303 to be able to adapt the strategy and tactics to the environment to maintain the capability of validating the object network of the parties A and B.

Between the parties having conflicting intentions, the goals of attaining the intentions conflict with each other. Therefore, when the intention of one party is attained as a goal, the intention of the other party cannot be attained because the strategy and tactics to attain the intention are inappropriate for each other. Between the conflicting parties, a change of a goal of an intention can immediately improve the adaptation in many cases. That is, it is necessary to analyze the relationship between the intentions of the parties.

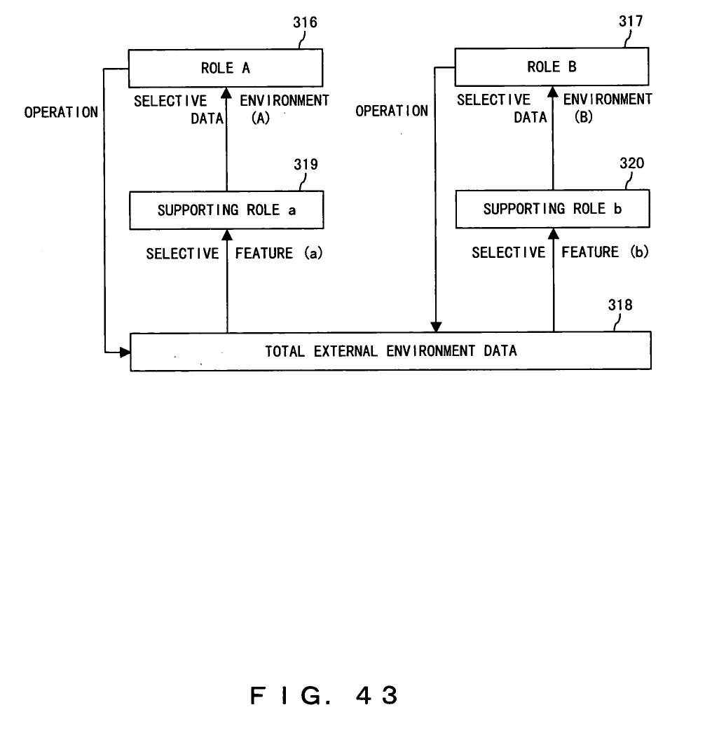

The hierarchy and restrictions of a model is described below in further detail. As described above, in the WELL system, an intention realizing system is structured on the software architecture hierarchically designed as a data model, an object model, a role model, and a process model. A number of related parties have the respective strategy and tactics as parties having generic attributes, and perform the mutual operations by the supporting role function of each party using the total external environment data as necessary data as shown in FIG. 43.

FIG. 43 is an explanatory view of performing a process by the interaction of the role function. For example, the role function of a role A 316 and a role B 317 respectively corresponding to the parties A and B perform the operations corresponding to total external environment data 318. Then, the selected features corresponding to the roles A and B are extracted by supporting roles 319 and 320, and the extracted data is transmitted to the respective role functions as selective environment data. In this data flow, the operation of the strategy and tactics object network operation is performed based on the mutual monitoring corresponding to the goal set to configure a cooperative intention or a conflicting intention, thereby progressing with the process.

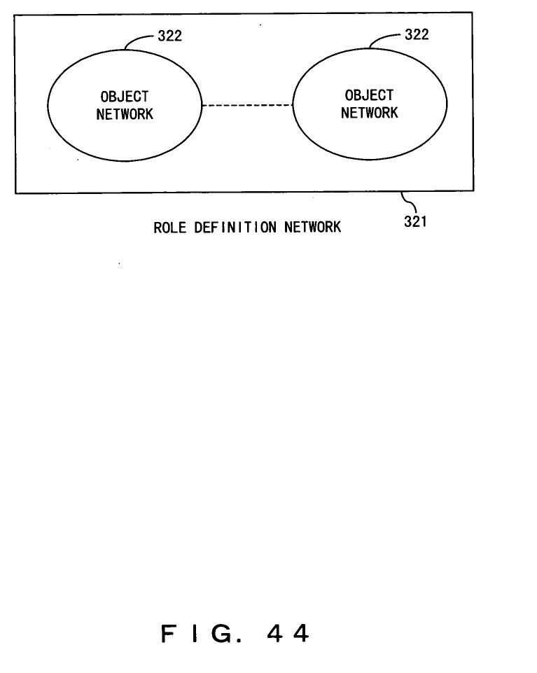

FIG. 44 shows the configuration of a role definition network 321 corresponding to each role, and the role definition network 321 corresponding to a role model is formed by a plurality of object networks 322.

Each object from the above-mentioned data model to process model can be a single object having a role, or an object network for a function. These objects have the following consistent restriction items so that a process can be controlled. A template is added to each object.

(a) Noun Object

The contents of the template relating to the noun object on which the executing process is currently performed are 1) service status, 2) a set of cells for definition of item names as data classes or the properties and features as attributes, and the operation on the contents are performed by data driven and event driven set by the definition preparation of the WELL system. As the execution status of a system, the value of 1) is recognized by the portion of the kernel of the system, and the cell of 2) stores the portion on which the consistent restriction item about the object is displayed.

(b) Verb Object

In the object network, a transition of a service status is represented as a function using a noun object. There are three types of classes of a function. They are 1) item object→item object, 2) item object→attribute object, 3) attribute object→attribute object. Objects are composed by 1), an attribute is set in 2), and an attribute is changed in 3). Depending on the restriction condition, the genericness and the practicality are converted. The operation of the instruction of a consistent restriction item is performed using a cell of 3) above. An item has a higher hierarchical level than an attribute, has a higher genericness level, and 2) indicates that item data is converted into attribute data.

(c) Consistent Restriction Object

It is a type of object, controls the execution process on each object in an object network, guarantees the security of an object, and changes the status of the object.

The restrictions for a service execution process by a system can be time restrictions and form restrictions. The time restrictions prescribe the mutual relationship in time between service objects for execution of a service, and can be AND restrictions and OR restrictions. The form restrictions prescribe the form structure of a service, and prescribe the priority of an object relating to a process by the hierarchical restrictions and priority restrictions.

In addition to the restrictions of the system, a user can prescribe the time restrictions and the form restrictions relating to an object for a service. For example, if there are a plurality of subjects, and a subject A is ahead of a subject B, then they can be represented as “A is before B.” in the form specification. In this case, “before” is defined by the system as a word indicating the representation description method relating to the form restrictions.

Next, the function of a process is described using a reference model for an efficient process according to the present embodiment. As described above, the base of the flow of the process is prescribed in the method of representing the operation of a system according to the intention of a user or a party based on the event drive and data drive, but a reference model is defined in association with the operation relating to the object network so that the method of designing a common system architecture can be closely related.

As described above, an event driven is performed when, for example, a user requests an execution process service in the user process of the object network. On the other hand, when a parameter in the template is undefined or inconsistent when a process is to be performed, the value of data is requested from the system to a user or an appropriate party. To perform the process, the function of data driven is used.

The operation in which the data contents requested for the data drive are substituted in the position of, for example, an undefined cell is performed as a data defining operation. As a function as a pair to the data driven to the noun object, a similar function is provided for a verb object, and the service executing operation on the party for executing the service, that is, the function process, is requested for execution.

Based on the event driven and the data driven, a reference driven is defined as a process form of a reference model. The reference driven requests the system to provide a service to be performed by a reference model through the event driven. Commonly, the object network name, the role function name, the process name, etc. are the structures in the format of the generic or practical object network. That is, a reference model defines a basic driving system for an optional structure.

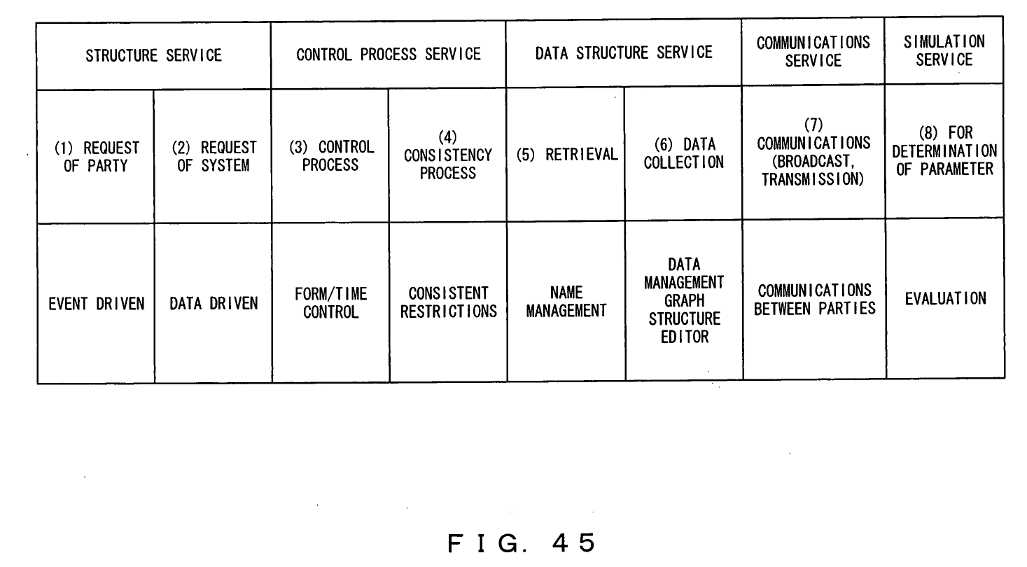

FIG. 45 is an explanatory view of a service using a reference model. The structure name is first specified by the reference driven. In response to this, in a reference model, a basic operation of sequentially converting a generic object into a practical object is realized as a basic service as shown in FIG. 45.

The first basic service item is a party request service, and a service of issuing to a system an execution request of a function relating to an object of the name specified by the party. This corresponds to event driven.

The second service item is a system request service. For example, when the contents of a template is undefined, a request to define the contents of the cell of undefined data is issued to an appropriate party from the system. This corresponds to data driven.

The third service item is a control processing service, and related to a process model. Relating to the execution of a process on an object network, the drive, stop, synchronization, etc. of the object network or other object networks are controlled.

The fourth service is a consistent process service. In this service, it is determined whether or not data provided by an object environment relating to the properties of an object defined as a consistent feature in the consistent restriction item can satisfy the properties, selects a valid control process depending on the determination result, and couples to the control of the process such that a control process which satisfies the sequential correspondence between input and output as an operation sequence to a process.

The fifth service is a retrieval service. For example, an object having the name specified by a party is retrieved.

The sixth service is a data intensive service. The service intensifies the selective feature amount in a role function corresponding to a plurality of parties, and a database is generated.

The seventh service is a communications service. In the broadcast format as shown in FIGS. 21 and 22, or communications performed for an individual destination, services of contents of a communications template are provided.

The eighth service item is a parameter determination evaluation service by a simulation service as an adaptation service.

For the above-mentioned service, an actual process step is described as a sequence.

A reference model is independent and orthogonal to the hierarchical structure of an object formed by the above-mentioned data model, object model, role model, and process model, and realizes a service as shown in FIG. 45 relating to a system in a format including data through common executing process model relating to event driven and data driven.

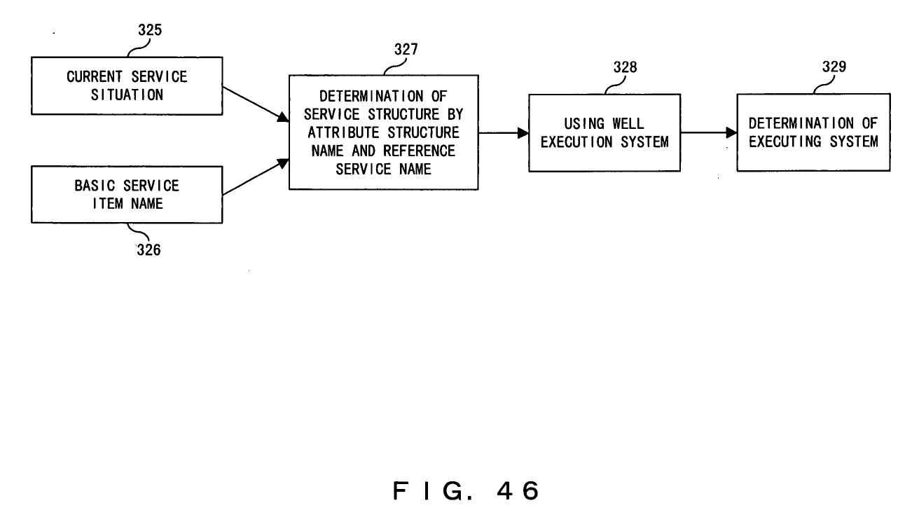

FIG. 46 is an explanatory view showing the system of realizing a reference model in the WELL system. In FIG. 46, a service structure is determined (327) from a current service situation 325 and a basic service item name 326 of a reference model using an attribute item name and a reference service name, and an executing system is determined (329) using an executing system of the WELL system (328), thereby realizing a reference model. Thus, the existing WELL system is utilized, and can be represented as software.

To realize the basic service item explained by referring to FIG. 45 as reference driven, an expert plans and designs an actual process system as appropriate, and realizes the structure of a generic/practical object network, and a user efficiently uses it.

To practically use a basic service item, it is necessary to provide a template having an attribute structure of a service item name, a service target name list, a template structure (a template depending on the contents of a service), a control parameter (representing activation, stop, and synchronization as parameters in a consistent restriction item), a selective feature name (recognition role and link of environment data), and a consistent restriction item name (data as a process).

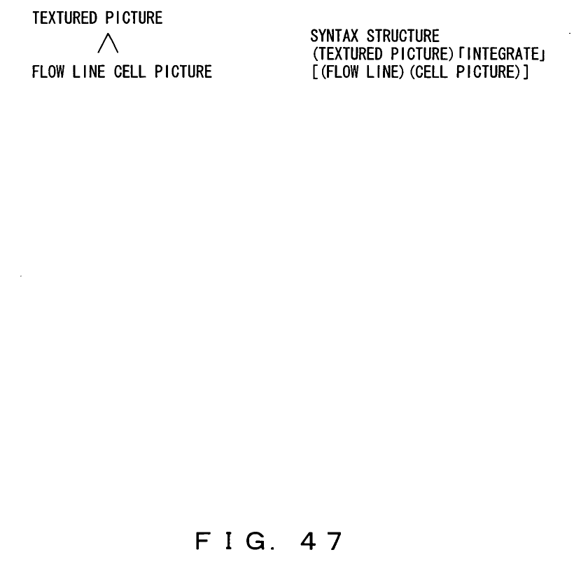

The hierarchical structure of an object and a consistent restriction item are described below by referring to a texture image as an example. FIG. 47 is an explanatory view showing the descriptions of the restrictions by a graph representation and a syntax structure of a texture image corresponding to the generation of a color image shown in FIG. 8.

In FIG. 47, “TEXTURED and “CELL” as adjectives are added to “PICTURE” as a noun object. The object network as an adjective phase has a generic property, and modifies a noun object network. That is, as a system, the attribute values as parameter values for “LINE” and “PICTURE” are allowed to have prioritized structure by the hierarchical restrictions as shown in FIG. 47.

A consistent restriction item is provided to control the transition of a current object of an object network by checking the validity of the consistent restrictions as the characteristic property of the object.

(a) Consistent Restriction Item of Noun Object

In the status as an attribute of a noun object, a validity check is carried out on the consistency with the time relation associated with the status value. If the attribute of a noun object is “form”, a validity check is carried out in association with the description of a feature model described later relating to a form. When an adjective phase modification is added to a noun, a total consistency is checked.

Described below is a feature model of a noun object. There are a format model and a feature model as object models for a noun object. The format model restricts the structure of a template, and the feature model prescribes the restriction condition depending on an environment as a predicate based in the attribute value (contents of the cell of the template) of the object.

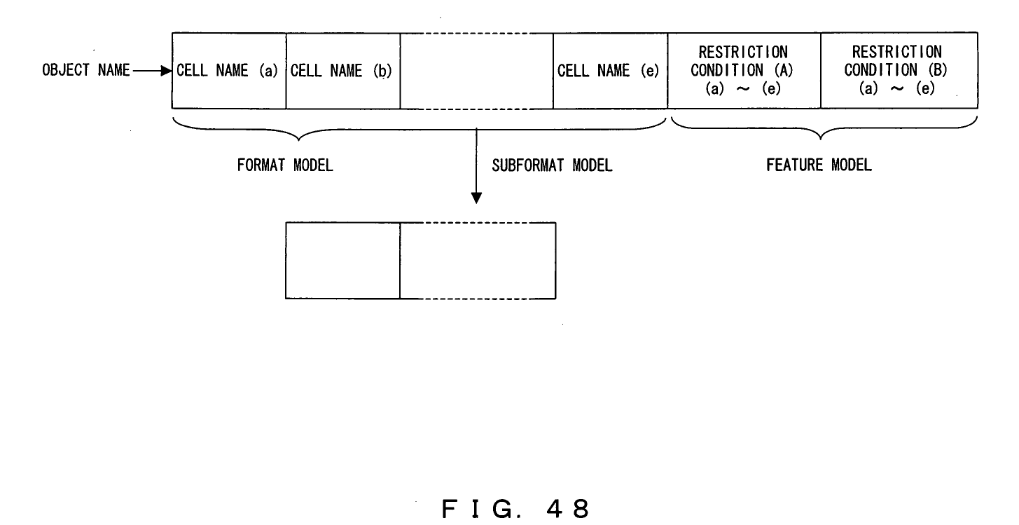

FIG. 48 shows a cell structure as a method of representing a format model and a feature model in the template of an object. In FIG. 48, cell names (a) through (e) correspond to the case in which data is represented as a list of cells, and it is assumed that a link is established in the order of (a) through (e). For example, with the brightness taken as an attribute at a point, a link is set from an object name to a coordinate, brightness data, the gradient of brightness, etc. A subformat model corresponds to a link to a subtree structure as a substructure of a format model when an attribute structure is a tree structure, and has a structure of a sequence of cell names. Furthermore, the restriction conditions (A) and (B) indicate consistent restriction items as the features of the environments A and B.

(b) Consistent Restriction Item of Verb Object

As described above, a verb object is indicated by an arrow starting from a noun object to a target noun object, or specified by the event driven from a client to perform an operation of a transitive object as a target. When the type of verb is a transitive, a complement for modification of an object is described. In this case, the validity has to be satisfied on the time and form restriction items for consistency of a word and a phrase added to a verb.

An adverb phrase modifying a verb is used to represent an operating state of a verb object, and it is necessary to define the time property of an operation as an attribute of a verb object. By defining the time property as an adverb phrase in a system, a validity check of the operation of a verb object is carried out.

(c) Consistent Restriction Item of Generic Object

A modifying phrase for a noun and a verb has a restrictive operation based on the value of its parameter, and has genericness. In the example of “TEXTURED PICTURE” as a generic target shown in FIG. 47, the generic noun object “PICTURE” is modified by a generic adjective object “TEXTURED”, and the generic noun object is processed as a common noun, and a definite individual object is defined as a proper noun by practical data.

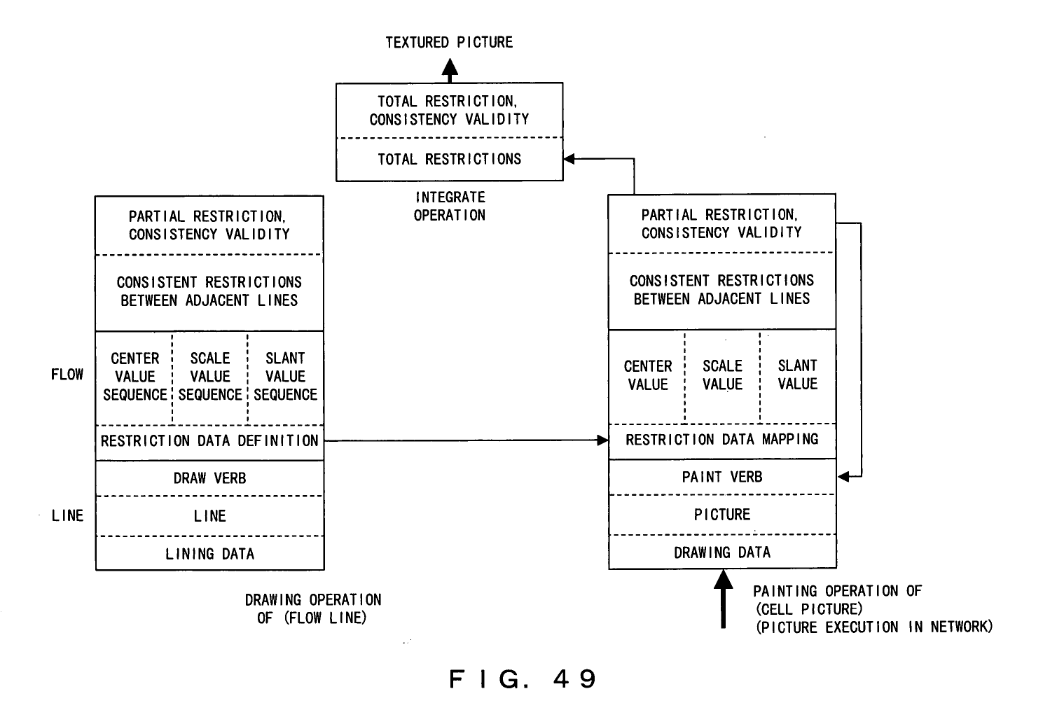

FIG. 49 shows a flow of the software of a syntax structure of “TEXTURED PICTURE”. In FIG. 49, the noun object of “LINE” is activated by its “Draw” operation, and the restriction data specifying the center position, the dimension, and the angle of the tilt of a cell image to be arranged on “Flow line” is defined by the values of “center”, “scale”, and “slant”.

The operation of “INTEGRATE” shown in FIG. 49 realizes the integral function between “FLOW LINE” and “CELL PICTURE”, integrates the consistent restrictions defined in “FLOW LINE” and “CELL PICTURE”, and checks the validity of the consistent restrictions. In the graph display shown in FIG. 47, the node portion represented as a tree structure virtually represents an editor which integrates them. The virtual function is important in facilitating the system configuration.

As explained by referring to the examples shown in FIGS. 47 and 49, consistent restriction items are defined for a generic/practical object, and the association of the consistent restriction items between objects is performed by the interaction function through the communications as a supporting function explained by referring to FIGS. 40 and 41. In the adaptation process in the realization of an intention explained by referring to FIG. 39, an adaptation change depending on the environment is made by determining the validity of the consistent restriction items.

The contents include the cell contents of a template, a feature parameter as data, and also a change in template format in a noun object. In a verb object, they includes a change in operation by a change of the format of a template, a change in strategy and tactics, a change in attribute parameter, etc.

In any case, the definition preparation for adaptation and a defining operation generate a change in system using an instructive role function. Furthermore, for adaptation, there is an increase in convenience, removal of the cause of interference with service, an increase/arrangement of service data, etc. as necessary items. To obtain these items, it is also necessary to adapt the structure of a service network itself.

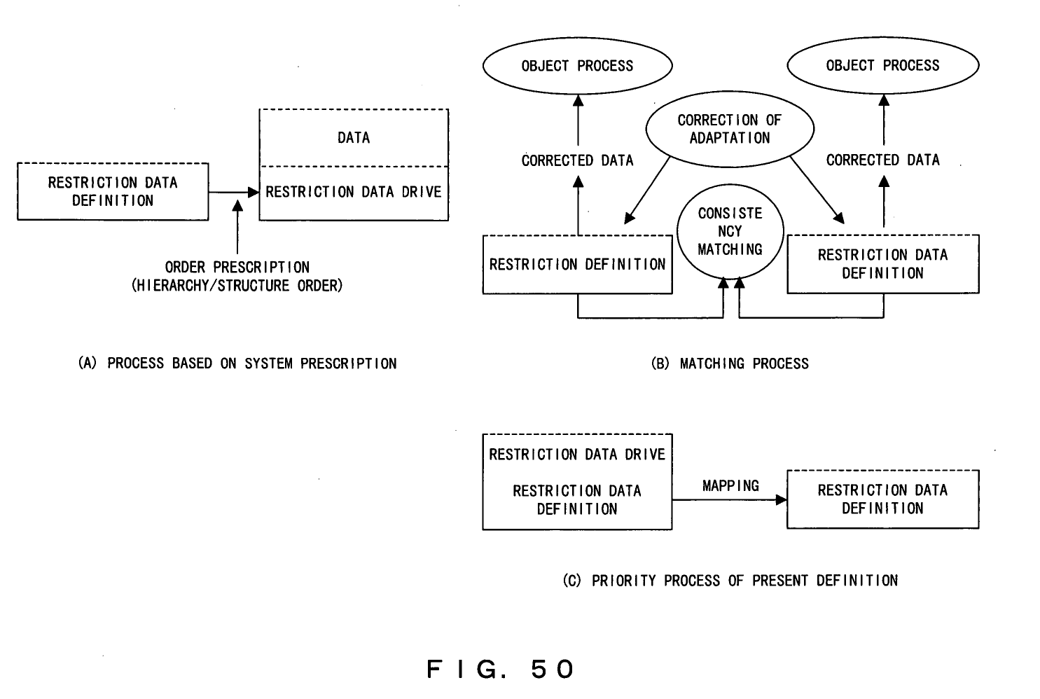

A priority is assigned to restriction data relating to a consistent restriction item. FIG. 50 is an explanatory view showing the classes of priorities. FIG. 50(A) shows a common case (no priority is assigned) in which a process is performed in accordance with the provisions of a system. According to the order definition based on the result of the normal syntax analysis, that is, the hierarchical/structural order, restriction data is defined.

FIG. 50(B) shows the case in which restriction data is defined independently for each object in a matching process. For example, in FIG. 49, when the restriction data of “FLOW LINE” and “CELL PICTURE” is independently defined, a matching process is performed between the restriction data, and the adaptation is corrected corresponding to the difference. For example, when the restriction data is averaged between them, and the data is used as a result of the adaptation correction between “FLOW LINE” and “CELL PICTURE” as a corrected data value.

FIG. 50(C) shows the process in which already defined restriction data is processed by priority. For example, if the restriction data of “CELL PICTURE” has been provided, and the restriction data of “FLOW LINE” has not been undefined, data driven is requested for the undefined restriction data, and the request is issued to the object of “CELL PICTURE”.

In adapting a service system, the transition between objects is defined as a processing step corresponding to the order prescribed by the consistent restrictions. Therefore, the adaptation of the flow of the service system is performed using the consistent restriction item added to each object.

For a noun object, the structure of a template is defined as a format model, and the relationship between attribute values is defined as a feature model. Therefore, in the feature model, the result of adapting a verb object is regarded as a consistent restriction, which is to satisfy the validity. In the management of the system, when a verb object is operated on a noun object, it is necessary to determine the validity of an operation of a verb object on a pre-operation condition (restriction condition before starting an operation), in-operation condition (restriction condition during an operation), and a post-operation condition (restriction condition after an operation) as shown in FIG. 6. Therefore, the feature model of a noun object can be considered to be a dynamic time consistent restriction item of a verb object.

The satisfaction level of the service structure viewed from a client relates to the entire target area, and the role function of each element in the target structure of a service is to be adapted. The adaptation is described below using a transmission network as an example.

It is common in the use form of the latest transmission network that each terminal uses various services developed in a network. For example, a peer-to-peer network receives much attention as a business model in which clients communicate information with each other without a server, and the clients themselves function as volunteer intermediates. In this system, the role of a client in the network has to be adapted in the daily organization.

As a role in transmission, there are 1) a private line and 2) a public network depending on the use of connection for a client in transmitting data between terminals. There are also 1) a circuit connection by cable, 2) a circuit connection by wireless, and 3) a connection to a LAN using a switch through a network. Furthermore, the transmission form can be 1) a circuit transmission, and 2) a packet transmission by accumulation. In reference to a transmission band, there is information communicated as 1) voice, 2) data, 3) broad band video, 4) compressed data video, etc.

To perform a transmission, the attribute value for designation of a service format is defined in a template, or a communications partner is specified by 1) an ID value and 2) meaning data, and 1) a use rate provision, 2) a volunteer service, etc. are required as a use rate system in a network. As a use rate in a network, 1) a connection service amount, 2) definition of a switch service rate, etc. are required. When a client uses a service, the attribute value is checked for authentication, and a subsequent service is requested.

To adapt the structure of a network by a volunteer, it is necessary that, although a volunteer is substituted by another volunteer, the connection conditions as consistent restriction items between adjacent hardware units in a network structure satisfy the restriction items meaning the consistent connection information about the network. The recognition of the satisfaction level of the conditions performs dynamic adaptation.

Described next are the description of the system using an object and its adaptation. The method of describing a system using an object can use 1) a seminatural language, 2) a graph structure, and 3) an inclusion logic. Among them, mutual switch can be performed. In a graph structure, the visibility of software using an object network is important, and an object network is displayed on a common platform.

A noun object, for example, “point” is a common noun, and the template of the coordinates of (x, y) is defined by the WELL system. In the designing step of an object, a template for definition preparation is provided, and an object name indicating “point is specified in the object network, and a necessary template is set for definition preparation in the work area.

That is, the kernel of the WELL system understands that the process using a common noun of “point” is to be performed, the coordinates relating to a noun object shown in FIG. 30 as event driven and corresponding to the data template are specified as the definition preparation of “point”, and the party as a client specifies the coordinates as a defining operation, thereby converting a common noun object having genericness into a proper noun object for embodiment of a “point”.

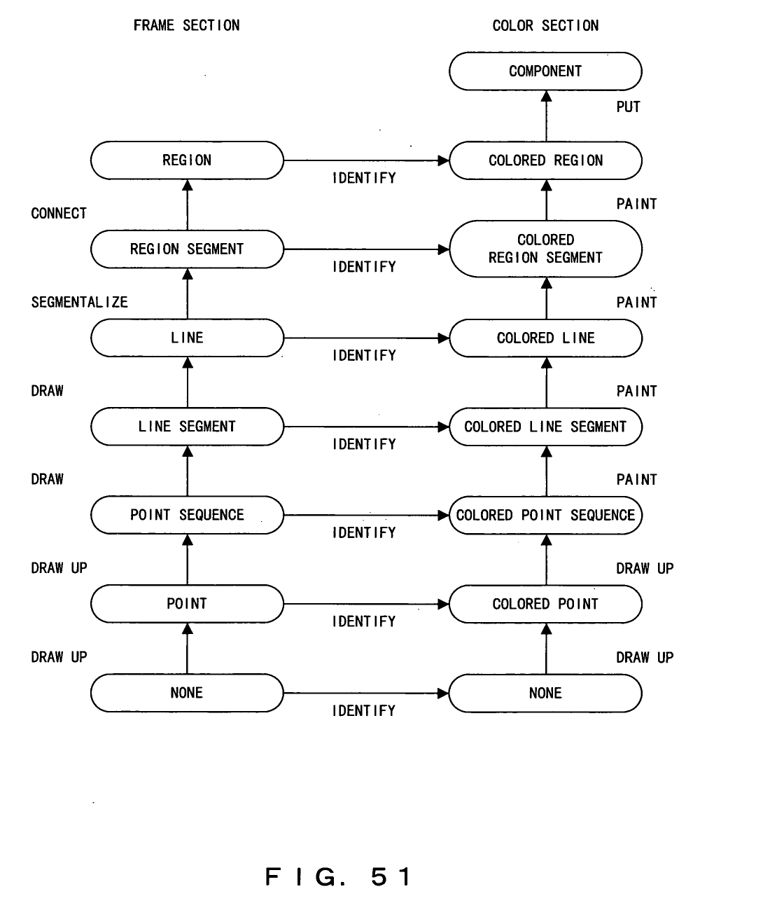

Relating to the description of the above-mentioned object, an embodiment of a drawing process is described below by referring to FIGS. 51 through 54. In performing a drawing process, a practical and positioned “point” is processed as a practical proper noun object of “the point”. The luminance diagram and the chrominance diagram for definition preparation of the brightness and the chromaticity of the point are displayed on the data window. Using the displayed data, a determiner is added to “the point”, and “the colored point” is defined.

Thus, it is necessary in the WELL system to prepare a template storing the values of a brightness vector and a chromaticity vector as determiners modifying the “point”. That is, in the system, the determiner as a term modifying the object of “point” is retrieved, and a template is set for setting the definition preparation. For example, “Textured” modifies and restricts “Picture”.

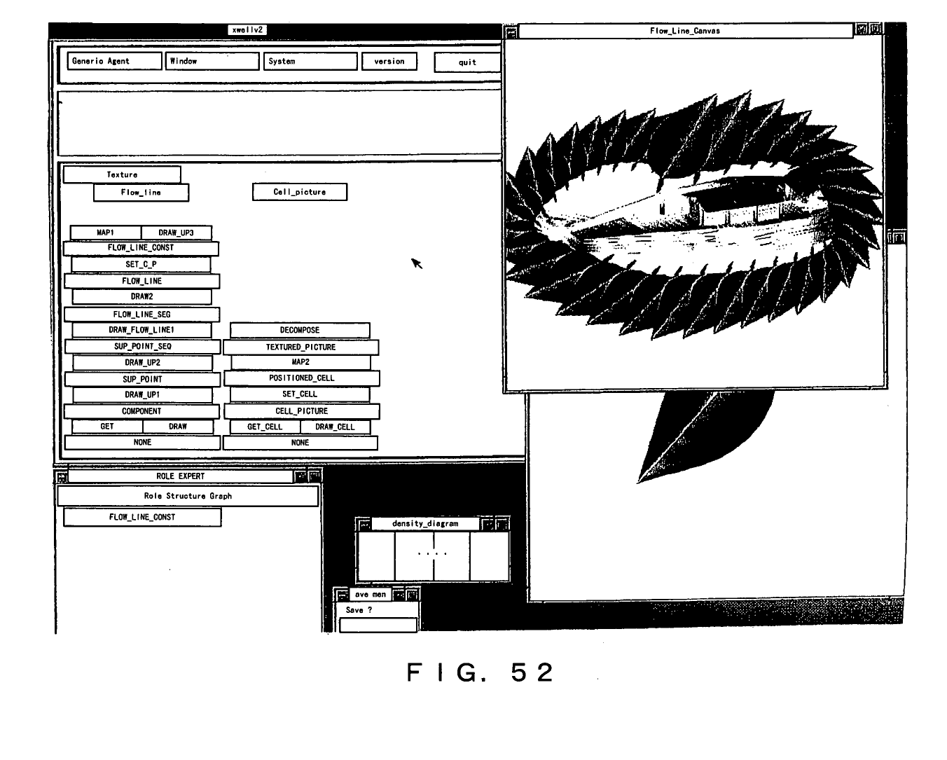

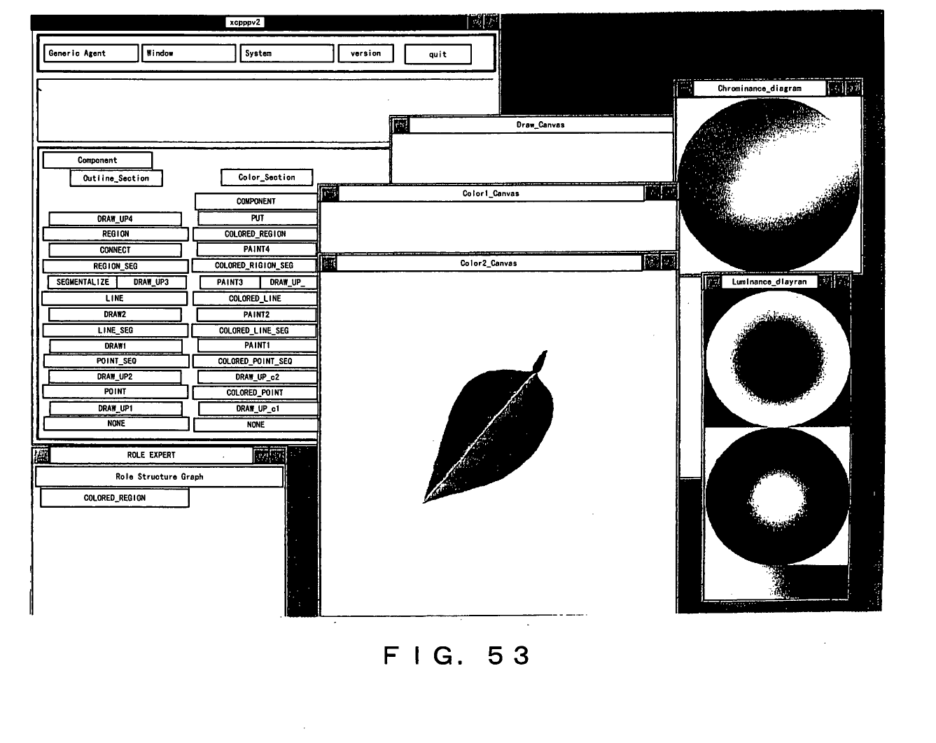

In the drawing process, a leaf shown in FIG. 52 is drawn using an object network shown in FIG. 51. Based on the drawn leaf, a texture image shown in FIG. 53 is obtained. FIG. 52 shows an image of a leaf as a cell. FIG. 53 shows an image of a number of cells connected as a flow line, that is, a number of leaves overlap and continue. The center and the scale are specified as restriction data as described above. The image in the flow line indicates a picture of a different cell.

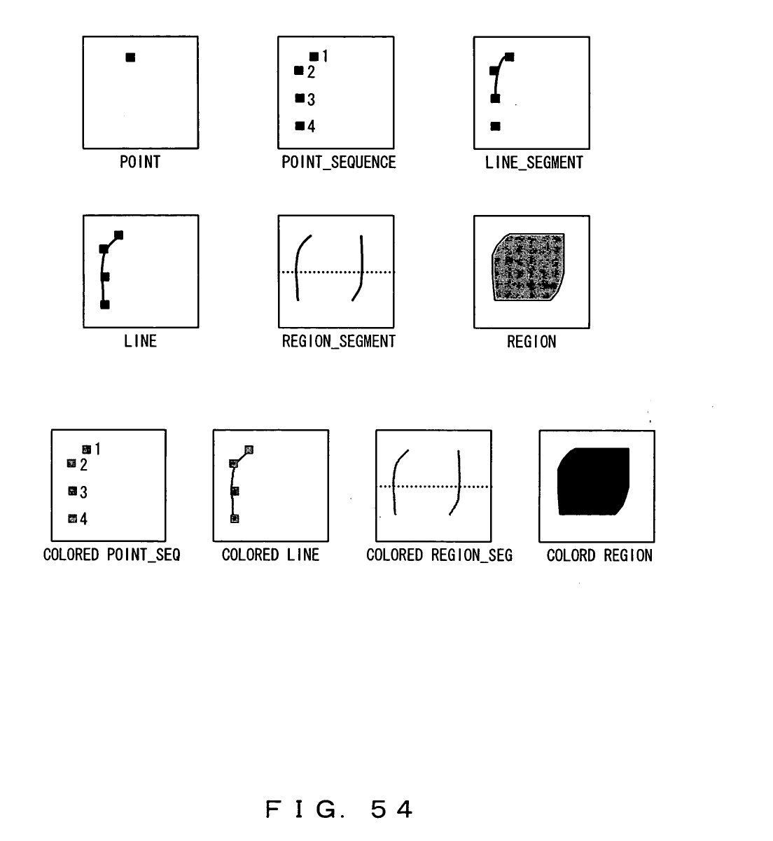

In FIG. 51, for example, to identify “Colored REGION SEGMENT” in the right “Color Section” from “REGION SEGMENT” in the left “Frame Section”, the execution process is performed as shown in FIG. 54 in the display status shown in FIG. 52. At this time, the feature data relating to FIG. 52 is given by the data of the “LINE” portion which refers to two edges prescribing “REGION” of the luminance and chrominance attributes of “Colored” of “Colored REGION SEGMENT”, and the continuity can be realized as coloring a picture on the attribute value adjacent “REGION” portion.

Thus, the consistent restriction condition is given by the “Helmholz' theorem” relating to the smoothing, and the adaptation for continuity within a predetermined condition is the condition during the execution of the verb object. This refers to the prescription of the smoothing function of the brightness and chromaticity data as an adaptation change of a verb object, which is an example of adaptation of a service structure.

Briefly described below is the description in an inclusion logic. In the WELL system, it is a feature to use a representation γ {α} using a parentheses as an inclusion logic. It shows that an object describing α has the characteristic of describing γ. Using the inclusion symbol [symbol] , [ [symbol] γ] (α) is held. The describing method is the base of the method of describing a model in the WELL system.

For example, a user name is recorded in the computer system, and a device available by a user is set by “my computer”, “configuration”, etc. Therefore,

user name: name, password, etc.

my computer: “mouse”, “disc”, etc.

are set by icon display.

my document: file, etc.

is required. Therefore, assuming that the user name is A, the representation in a seminatural language for a point is

A draw up a point,

and therefore, in the inclusion logic, A is a subject with an objective “a point” connected to a transitive “draw up”. After the representation, “a point” is set as a proper noun as “the point”.

The service effect and the adapting function are described below corresponding to the types of services. As described above, the satisfaction level for a service provided by a service system for a client is evaluated relating to the intention of the client for the service system.

There can be various service evaluation items such as 1) interaction function as interface, 2) extensible service, 3) simple intention structure, 4) valid service environment adaptation, 5) security of service in various environments, 6) hierarchical function of service, 7) dynamic change of intention structure, 8) adaptation of party user structure to dynamic change, 9) dynamic design of environment structure, 10) adaptive incorporation to hardware/software system, 11) field descriptive, adaptive to various service fields, 12) various adaptation to service interface, 13) dynamic adaptation of service execution speed, etc. It is necessary to consider adaptation in the structure of each model of an object as a method of improving the service effect in structure.

(a) Data Model

The template format in a data model is similar to each of the object, role, and process models. The management function of a service system by an agent role server as a role model is performed using a specific role server, and when cooperative execution is performed, the performance data of each executing process is allowed to correspond to the cell structure of a template.

The interface system corresponding to the entrance/exit of a service in the interaction function of 1) offers a service in response to a party request as a structure service, and the event driven and the data driven for the system based on the restriction status relating to the state of the data in the cell of a template.

Relating to the extensibility of 2), the simple intention structure of 3), the environment adaptation of 4), and the security of service of 5) require the cells of the consistent restriction items about the service contents and data formats for them. They obviously require the hierarchical function of service of 6), thereby providing a template cell about the consistent restriction items for a hierarchical structure, and the history data about the dynamic change of an intention structure of 7) is managed using the cell data.

Similarly required are the existence of a plurality of parties of 8), the change of the structure of an environment of 9), and the adaptation of the resources of hardware/software of 10), and a cell for history data required for the adaptation of 11), 12), and 13). Especially, as a service system, a cell required to manage traffic data of an input/output service amount corresponding to the dynamic change of a service amount is indispensable.

(b) Object Model

Relating to the object model, the form/time control for the processing of hierarchical control for a high-order role model and process model, and various consistent restrictions for a consistent process are also defined for the above-mentioned format and feature models and the network model using them.

The search function based on the name management which is the data structure service as a supporting service and the data intensive function about the data management and graph structure data are provided for the realization of services, and a communications service, a simulation service, etc. are used to describe in detail the contents of 1) through 13) above.

(c) Role Model

As an adaptation item for a role model, there are 3) and 7) relating to an intention structure, and 5), 6), 8) through 11), and 12) for environment related items corresponding to the services in all fields of the WELL system. Especially, an important point as the capability of providing a service is the traffic of services and the adaptation to an abnormal case.

First, relating to the capacity of the service executing process requested in each field, it is important to provide the basic management data for each role function for the sources of the agent role server satisfying all clients of the system, and the sources of the specific role server under the management of the agent role server. To attain this, the data of the process handling capability is required by the agent role server, and the management role such as the distribution of a load to the specific role server and addition of resources is important.

(d) Process Model

In the executing process function designed for each model of an object, 4) validity of executing process and 5) security are important as process models. When a plurality of parties are involved in the consistent restriction items as the operation (including communications services) accompanying the communications of service functions, the integral processing function for adjusting the contents of the consistent restriction item data is necessary between the parties A and B as described above by referring to FIG. 42.

When a malicious party interferes with the system, it is necessary to take measures against the malicious party using the consistent restrictions to prevent the damage to the system. This indicates the countermeasures against unnatural environment for the system as 8) and 9).

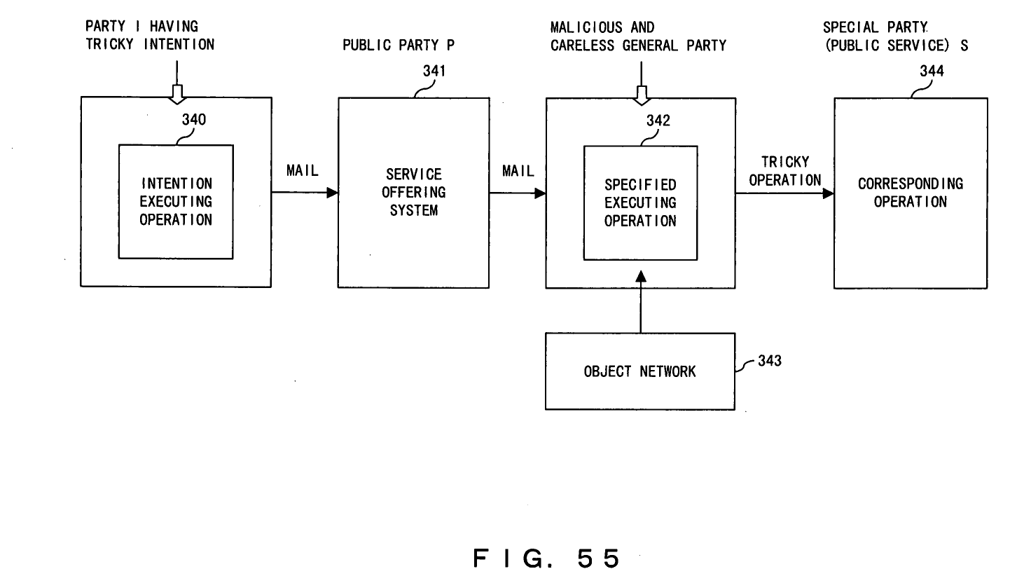

As a recent example arising a phenomenon having a conflicting effect on a special party configuring an environment, there is an example of a malicious action taken to the following special party receiving e-mail. FIG. 55 shows the example.

As shown in FIG. 55, when a party I having a malicious intention transmits mail to a service offering system 341 of a public party P as an intention executing operation 340, the service offering system 341 has a public property and transfers the mail as is without a malicious intention to a unwitting public party. The public party executes a directed executing operation 342 using an object network 343, thereby indicating the malicious operation to, for example, a party S offering a public service. By performing a corresponding operation 344, for example, a result of the damage by a virus occurs.

To protect data against such a malicious action, non-malicious or unwilling public parties cannot be requested for perfect cooperation. Furthermore, when a special party S is a party offering a public service, it is difficult to stop offering a service for determination as to whether or not each action is malicious to maintain the universality of public services in charge.

The service offering system 341 of the public organization P is also a public service, and it also necessary to offer a universal service. However, it is necessary that the service offering system 341 detects the mail as a system first receiving such mail for a maliciously realizing operation covered with a public profit using a consistent restriction item in the executing process function of an object network of the system.

Therefore, the check of the validity of the consistent restriction item about a pair of, for example, a specific word and a specific operation which can be the cause of a conflicting action in the mail is carried out as explained above by referring to FIGS. 32 and 33, a new determination role function is activated as necessary by an operation of data driven, and the determining operation is stepwise intensified depending on the execution result of the function.

As a sequence of specific words, for example, is “I love you”, and a specific operation can be “dialing 110”. In response to the mail data of “I love you”, a software module of dialing 110 is performed.

As a malicious action, there are illegal copies or falsification of a file relating to a party. To protect data against the above-mentioned malicious action, it is necessary to notify the system of the situation of the check function using the role function having the function of checking the validity whether or not the service request has the validity relating to the consistent restriction item as an attribute value as a role function relating to the service use of a file use.

To attain this, a destination name as a dynamic control consistent restriction item name explained by referring to FIG. 33 can be used. The contents of the cell having the destination name in the template is compared with the party issuing the service request to use the gate function having the effect of blocking the file operation of the data by a general party.

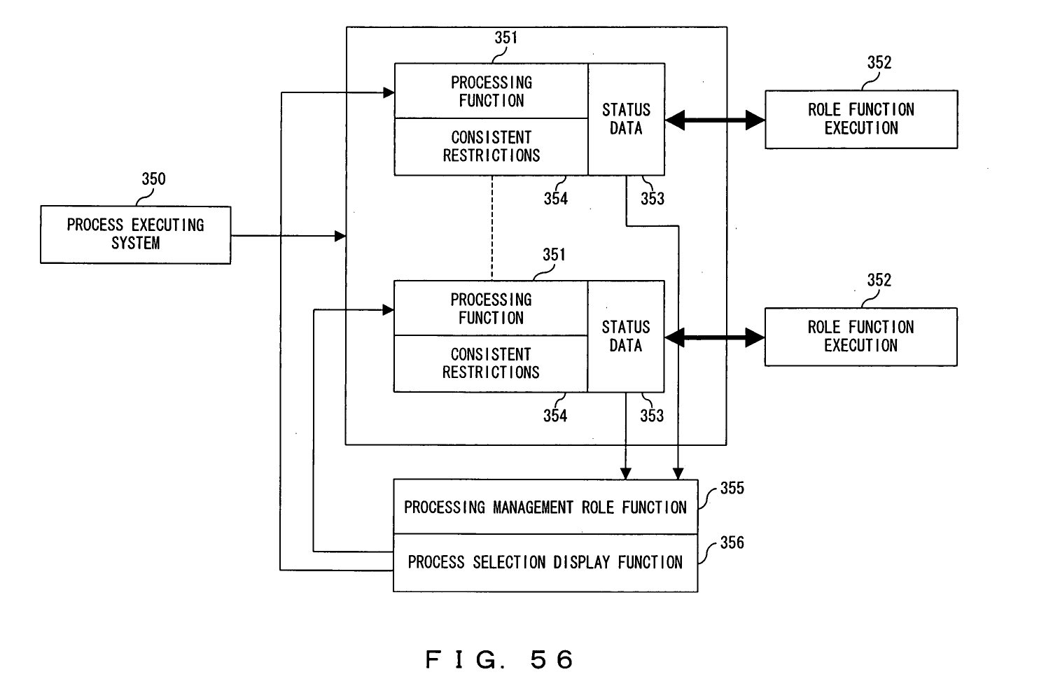

On the other hand, when a correct party operates a file, it is necessary to protect data against the fault when it occurs on a processing function by using an executing process module of a general purpose role function to smoothly continue a service. FIG. 56 shows the management system of the process executing process state to satisfy the above-mentioned necessity.

In FIG. 56, it is possible for a plurality of processing functions 351 to concurrently operate based on the management of a process executing system 350. For each processing function 351, each role function execution 352 is used, and for the role function execution 352, and consistent restrictions 354 are provided.

The status data 353 for each processing function 351 is collected in a processing role management function 355. The status of each processing function 351, for example, when an accident and a fault occur, a process selection display function 356 selects a processing function 351 not currently performing an operation, and an instruction for the execution of a process is issued.

That is, in FIG. 56, by the validity check function using a template, etc. shown in FIG. 32 for the status data 353 corresponding to each processing function 351, a control state is changed by data driven when it is assumed that an accident has occurred. That is, the resource management of the system is performed, and when an accident has occurred, the flow of the process is temporarily stopped, and the status is recovered by data driven as necessary.

When there arises a problem with a service due to the traffic congestion, a new processing function is added to the process executing system 350 to reduce the traffic. When it is detected by the validity check that an unauthorized party has issued a service request, the party is informed of the service stop based on the status data, and the data is further accumulated as status data, and the system requests to realize the service state based on the new status data by data driven.

When a goal of a group intention of a plurality of parties is to be attained for a target area, the process executing system 350 shown in FIG. 56 functions as a role of an agent role server for integrally managing the execution of a process by the processing function for the role function shared by each party under the management of the processing role management function 355 and the process selection display function 356. Under the management, the specific role server functions as a role sharing function.

For example, the management function of a manager of a football game is performed by the process executing system 350, and each role function, that is, a forward, a mid-fielder, a defender, a goal keeper, etc. performs a function individually using a ball. At this time, the cooperation among the operations of all players is controlled by the processing role management function 355. The adaptation for the improvement of a service effect is performed for the role of each model in the model structure, and the adaptation based on the consistent restriction data is performed by the process executing system 350 on the role of each party from the data model to the process model.

In the management system of the process executing process shown in FIG. 56, the function of performing a validity check on the status data corresponding to consistent restriction items is implemented to control the flow of services. For example, to improve the execution effect of the service execution system, the purpose of actually improving the resources of hardware/software corresponding to a process is pursued.

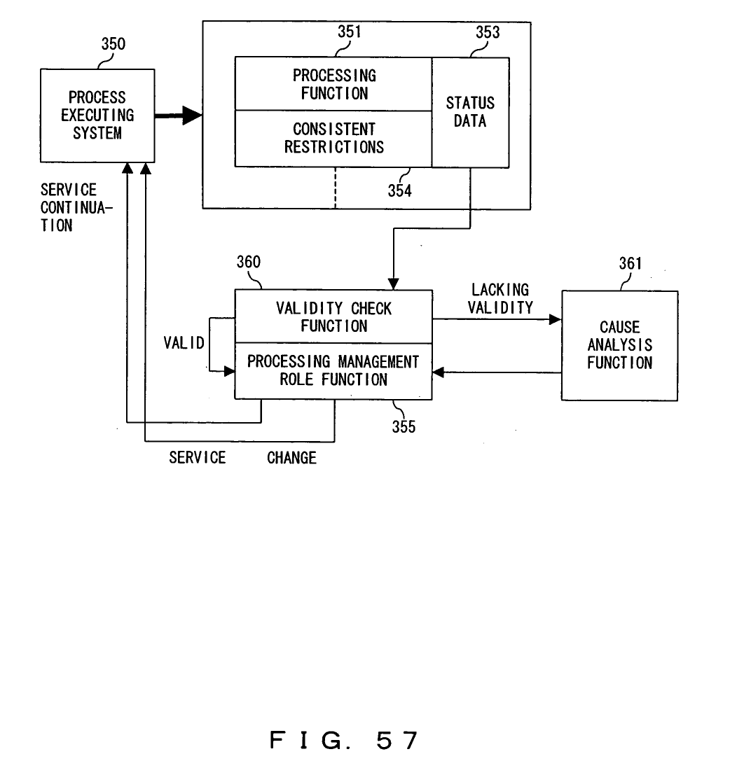

FIG. 57 is an explanatory view showing the function of controlling the flow of a service. The status data corresponding to each processing function 351 shown in FIG. 56 is checked by a validity check function 360. When the validity is not detected, a cause analysis function 361 analyzes the cause, and the result is provided for the processing role management function 355. When the check result is valid, the result is also provided for the processing process role management function. In return, the processing role management function 355 issues a service continue instruction or a service change instruction to the process executing system 350, and the process executing system 350 continues a service or changes a service.

As described above, the cooperative operations between, the general purpose validity checker for checking the validity on the corresponding feature data to the consistent restriction items provided in the structure of the software architecture of each model of an object and the service executing system are performed to improve the service effect. The structure of the module of checking the validity is passed to the entire system when an application is designed, and it is designed and set. Thus, the modules are generated, deleted, or corrected as necessary, thereby performing the adaptation as modules.

In addition to the adaptation of the entire module structure and the adaptation of the consistent restriction items in module units, the adaptation of the consistent restriction items themselves for the generation, annihilation, and correction is performed.

Described below are the definition and realization of the consistent restriction items for adaptation. As shown in FIG. 48, the consistent restriction item for a noun object includes a format model and a feature model. To perform the executing process on the object, the restriction items on the pre-execution, in-execution, and post-execution processes are defined. They also include the format models and feature models.

(a) Realization of Format Model

The data format of a format model is described as a template, and the person in charge of an application describes it in a list format. An ID is added to each cell of the list, and retrieval can be performed when the system is used.

(b) Realization of a Feature Model

A feature model describes as a predicate the relationship among the data relating to the name of a cell of the list as a format model. To satisfy the description of the feature of a noun object, for example, it is necessary that the operation of a verb object directed for a noun object in FIG. 3 is adaptive. As described above by referring to FIGS. 52 through 54 for an example of drawing, the adaptation algorithm such as the “Helmholz' theorem” is realized as an operation of a verb object. The precision of adaptation is defined as restriction item data after the execution. The effect of the adaptation is represented as a service effect.

(c) Adaptation in Intention Structure

As shown in FIG. 34, the target area of an intention and its attribute are first defined, and then, the operability structure available in realizing an intention, the supporting structure for recognition of environment data, and various restrictions are assigned. The environment data is provided by the supporting function including the situation data about the related parties as the entire external environment. To satisfy an intention, the strategy and tactics are defined including the priority explained by referring to FIG. 50.

For adaptation, the correlation of the operation amount as the prescription of the user operation shown in FIG. 34 is prescribed as restrictions. The prescription can be performed by the party itself. Relating to the strategy and tactics, the description of the operability is first prescribed as restrictions. Then, a simulation experiment for the target of an intention is carried out under the currently provided environment data, and the adaptation is sequentially realized.

However, a target may not be attained due to insufficient entire external environment data obtained by the supporting function. Therefore, to obtain appropriate environment data, it is important to adaptively improve supporting capabilities. First, the keyword for definition of environment data is arranged as a noun, a verb, and a qualifier, the syntax of a keyword sequence is clarified as shown in FIG. 49 based on the selection of necessary and sufficient terms. Furthermore, it is necessary to hierarchically arrange the genericness and practicality of the keywords.

As the adaptation about the role function corresponding to each party and its group in strategy, it is presumed that the advantageous and disadvantageous fields of each party are managed as attribute data. Then, the role function as a field is classified on the object database, and it is necessary to adapt the intention structure for each role group.

To attain this, the service by the reference model described above by referring to FIG. 45 is effective. Thus, the interaction in the system can be simple and comprehensible.

In a necessary society, it is important to efficiently develop the social architecture for generation of an evolutional intellectual society. In creating knowledge and intelligence, it is necessary for an environment to provide a mechanism of generating stimuli so that cooperation can be obtained in many fields.

To generate stimuli, it is necessary to find a novel article relating to an interesting target by a data structure service using academic terms relating to the keyword available inside a community generated with cooperative intentions.

The first step to the approach to the target of an intention is to generate a stimulus of an intention, and an operation item relating to an intention executing process and a feature item as an attribute used in structuring an intention are described by structuring a intention in a generic object network of an intention shown in FIG. 35.

Based on the above-mentioned target, operation item, and feature item, probable strategy and tactics for the realization of an intention are selected. In the selecting process, the strategy is detailed by dividing an intention into detailed items as an intention sequence. In the process, a hierarchical process is performed on the concept structure of a process model and a role model.

Finally, the object structure and the improvement of a service effect are explained. To improve the service effect, it is necessary for a client to improve the service effect in many fields by realize and provide a service of the client with precision and safety as described above.

To attain this, media data is to be bidirectional, the interaction is to be realized with an object network having the function of controlling the bidirectional media, and an evolutional social system is to be generated by improving the sequential service effect between a client group having various purposes and a service system.

To realize the above-mentioned purpose, it is important to independently perform adaptation on each model of each object, that is, data, an object, a role, and a process in each hierarchical level.

In the service executing process, it is necessary to realize a service request of a client quickly and in many fields. Considering this point as a software present invention, units and capsules of software modules are to be realized as a model structure to increase compatibility and diversification. Parts can be applied to parallel and hierarchical use as described below.

(a) Parallel Use

As for parallel use, when parts become faulty and the service speed is not fast enough for a number of clients, it is necessary to prepare necessary attribute values and adaptation such as replacement of the above-mentioned processes, permission of extension of equipment for parallel use of parts for the attribute values of consistent restriction items.

(b) Hierarchical Use

If any fault or an accident has been detected during management of an agent role server in the parts of a server in performing a process executing process required in offering a service by a specific role server, it is necessary to take action against the state, determine the fault for new parts by a determination device of validity, and incorporate into the system a role function capable of processing the fault.

(c) Generation of Object Module by Generation of Feature Divisional Composition

In a noun object which is a target of an operation of a verb object in performing an executing process for continuous conversion, a format data and a feature data can be structured and accumulated in the structure of a template based on a format model and a feature model. In dividing features, an operation cutting phase is included, and a dividing operation is performed by providing a parameter having a change in quality of feature data before and after the cutting operations. In the dividing operation, a change of value of data in a target area is minimized, and the change amount can be specified in an adjacent area. Furthermore, a determiner can prescribe the change of feature data.

To compose a plurality of objects as a single object, a target can be generated by providing a practical attribute value for a generic parameter in the process of generating each target by obtaining a parameter using an adjective determiner on a feature parameter common among a plurality of objects. For example, a texture image is generated.

A texture image is an example of a generic noun object. A change in form of an object is described by an adverb determiner for a verb object so that dividing and composing operations can be performed. For example, “young boy”, “old boy”, etc. can be used. That is, it relates to a time change in a grow-up process of a male person.

It has been very important to realize pursuit of convenience, interference with interrupt on universal service, and pursuit of security of a system, maintain and manage a backbone service in a social system by interrupt of unnecessary service in an emergency, and improve the service effect using hardware and software architecture to increase and amend service data for offering a service corresponding to the evolution of the service contents.

To attain the above-mentioned purposes, the system realization process in the WELL system for performing a defining operation from definition preparation is performed by providing an important adaptation process for enhancement of a system.

By sequentially improving a service effect, the satisfaction level of a client for a service can be adaptively enhanced corresponding to a new event. The methodology is described above. Especially, a practical method of satisfying a client, that is, the necessity of integrating various viewpoints for the enhancement of the system, is described above in detail.

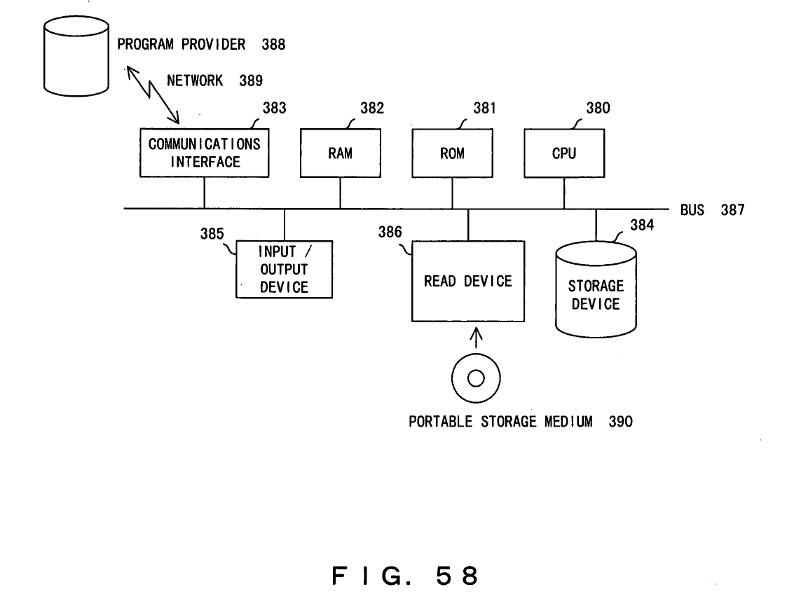

The method of improving a service effect according to the present invention is described above in detail, but the intention realization data processing device for use in the system can be configured as a common computer system. FIG. 58 is a block diagram of the configuration of the computer system, that is, the configuration of a hardware environment.

In FIG. 58, the computer system comprises a central processing unit (CPU) 380, read-only memory (ROM) 381, random access memory (RAM) 382, a communications interface 383, a storage device 384, an input/output device 385, a read device 386 for a portable storage medium, and a bus 387 for connection of the above-mentioned components.

The storage device 384 can be storage media in various forms such as a hard disk, a magnetic disk, etc. Any of these storage device 384 and ROM 381 stores a program shown as a flowchart shown in FIGS. 9, 10, and 19, a program for improvement of a service effect corresponding to the intention of a client, etc. By executing the programs by the CPU 380, a service corresponding to an intention of a client can be provided, and the service effect can be improved according to the present invention.

These programs can be stored in, for example, the storage device 384 from a program provider 388 through a network 389 and a communications interface 383, or can be stored in a marketed and distributed portable storage medium 390, set in the read device 386, and executed by the CPU 380. The portable storage medium 390 can be various storage media such as CD-ROM, a flexible disk, an optical disk, a magneto-optical disk, etc. By reading the program stored in the storage medium by the read device 386, the service adapted independently for each model of an object can be improved.

As described above, in detail, a service effect can be improved corresponding to an intention of a client in the service system based on the WELL system, and can be effectively used in constructing an evolutional social system.

That is, adaptation is performed to improve the service effect independently for each model of an object hierarchically formed by a data model, an object model, a role model, and a process model, thereby totally improving a service effect in a service system related to a number of parties in many fields.

What is claimed is:

1. A service effect improving system having an object network as a language processing function and a common platform as an interface function with a client for offering a service depending on an intention of a client, comprising: an object forming the system having a hierarchical structure comprising:
a data model whose attribute structure is determined as a template;
an object model arranged in a higher order than the data model;
a role model which is arranged in a higher order than the object model, and represents contents of a process to be performed in an environment as a set of a plurality of object models; and
a process model which is arranged at a highest order and defines a dynamic process cooperatively performed by a plurality of role models as one process; and
a model adaptation unit performing adaptation for improvement of a service effect independently for each model of an object in the hierarchical structure.

2. The system according to claim 1, wherein:
said service system uses a network formed by a plurality of clients and a plurality of servers for offering a service; and
said model adaptation unit performs adaptation for attaining an intention of each client.

3. The system according to claim 2, further comprising
an external environment data management unit centrally managing cooperative data for the service executing process which can be referred to in parallel when each party of a plurality of clients and servers requires it, wherein
when intentions of a plurality of clients are cooperative intentions of cooperatively realizing mutual requests or conflicting intentions of mutually preventing realization of intentions of opposite parties, said model adaptation unit dynamically performs adaptation for cooperative intentions or conflicting intentions of a group of clients using contents of management of said external environment data management unit.

4. The system according to claim 1, further comprising
a modification unit performing generic determiner modification at a specification level on each model of the object, wherein
said model adaptation unit adapts a parameter for embodiment of the determiner modification.

5. The system according to claim 1, wherein:
a consistent restriction item is set as an attribute of an object for an object of each model; and
said model adaptation unit performs adaptation such that the consistent restriction can be satisfied.

6. The system according to claim 5, further comprising
a validity check unit carrying out a validity check on a process performed by a model of an object of the hierarchical level corresponding to the consistent restriction item by dividing the check corresponding to each hierarchical level.

7. The system according to claim 5, wherein
a process situation of a system is divided corresponding to the consistent restriction item, and represented as modules corresponding to a syntax structure of an object.

8. The system according to claim 5, wherein
in the syntax structure of the object, a priority is assigned to data of a consistent restriction item as an attribute of the object.

9. The system according to claim 1, further comprising
a support role unit supporting adaptation by said model adaptation unit for improvement of a service effect corresponding to a feature of an object model at each hierarchical level.

10. The system according to claim 1, further comprising
a reference model which is normal to a hierarchical structure of the data model, object model, role model, and process model, and is used in realizing a basic service to be performed in a process of the object network.

11. A service effect improving system having an object network as a language processing function and a common platform as an interface function with a client for offering a service depending on an intention of a client, comprising: an object forming the system having a hierarchical structure comprising:
a data model whose attribute structure is determined as a template;
an object model arranged in a higher order than the data model;
a role model which is arranged in a higher order than the object model, and represents contents of a process to be performed in an environment as a set of a plurality of object models; and
a process model which is arranged at a highest order and defines a dynamic process cooperatively performed by a plurality of role models as one process; and
model adaptation means for performing adaptation for improvement of a service effect independently for each model of an object in the hierarchical structure.
